(19) United States
(12) Patent Application Publication
(10) Pub. No.: US 2006/0209884 A1
(43) Pub. Date: Sep. 21, 2006

(54) System, method and apparatus for automatic detection and automatic connection between a generalized content source and a generalized content sink

(76) Inventors: Samuel J. MacMullan, Carlisle, MA (US); Steven S. Fastert, Chelmsford, MA (US); Tandhoni S. Rao, Ashland, MA (US); Bhavin Patel, Jamaica Plain, MA (US)

Correspondence Address: STERNE, KESSLER, GOLDSTEIN & FOX PLLC, 1100 NEW YORK AVENUE, N.W., WASHINGTON, DC, 20005, US

(21) Appl. No.: 11/211,082

(22) Filed: Aug. 25, 2005

Related U.S. Application Data
(63) Continuation-in-part of application No. 11/190,878, filed on Jul. 28, 2005.
Application No. 11/190,878 is a continuation-in-part of application No. 11/117,467, filed on Apr. 29, 2005.
(60) Provisional application No. 60/661,481, filed on Mar. 15, 2005.

(51) Int. Cl. H04J 3/22; H04L 12/16; H04J 3/16; H04Q 11/00

(52) U.S. Cl. 370/465; 370/270; 370/469

(57) ABSTRACT

A system, method and apparatus for implementing a wireless point-to-point interface that securely and robustly delivers media content from a generalized content source to a generalized content sink. The system, method and apparatus performs in a manner that is sufficiently secure and robust to serve as a replacement for the delivery of HDMI content over cable. The system, method and apparatus is also applicable to the delivery of other types of content traditionally delivered over cable, including but not limited to Digital Video Interface (DVI) content, composite video (CVSB) content, S-video content, RGB video content, YUV video content, and/or various types of audio content. The system, method and apparatus performs an automatic detection and automatic connection process to foster connectivity between a generalized content source and a generalized content sink.

### CROSS-REFERENCE TO RELATED APPLICATIONS

This patent application is a continuation-in-part of U.S. patent application Ser. No. 11/190,878, filed Jul. 28, 2005, which is a continuation-in-part of U.S. patent application Ser. No. 11/117,467, filed Apr. 29, 2005, which claims priority to U.S. Provisional Patent Application No. 60/661,481, filed Mar. 15, 2005, all of which are incorporated herein by reference in their entirety.

### BACKGROUND OF THE INVENTION

1. Field of the Invention

The present invention is generally directed to wireless communication systems. In particular, the present invention is related to a system, method and apparatus for the wireless communication of analog and/or digital information from a generalized content source to a generalized content sink.

2. Background

Wireless interfaces offer a compelling value proposition for the transfer of photos, music, video, data and other forms of media content amongst networked consumer electronics, personal computers (PCs), and mobile devices throughout the home. The promise of simple and inexpensive installation coupled with the potential elimination of bulky and unsightly cables has created a buzz throughout the industry. Seeing this opportunity, technology vendors have rushed to develop and position Bluetooth™, 802.11 WiFi®, and 802.15.3a Ultra Wide Band (UWB) for emerging in-home content transfer applications as these wireless techniques offer adequate coverage area, throughput, and quality levels for generic content transfer.

Media content transfer is not the only in-home wireless application, however, and it may not even be the most appealing one for the consumer. Many industry analysts are projecting that high-performance digital cable replacement may, in fact, be the more lucrative in-home opportunity for wireless technology.

For example, most high-definition plasma/LCD displays, digital projectors, and DVD players being introduced in the market today include a high-definition media interface (HDMI) connector to facilitate the high-fidelity transfer of digital content from source devices (e.g. digital set top boxes, DVD players, etc.) to display devices via digital cable. The HDMI interface standard supports all common high-definition formats including 720p and 1080i high-definition television (HDTV) which require data rates of 1.5 Gbps at a bit error rate (BER) of 10⁻⁹. HDMI also incorporates the Motion Picture Association of America (MPAA)-approved High-bandwidth Digital Content Protection (HDCP) which ensures the security of the digital content as it is transferred between source and display. The comprehensively designed HDMI standard has garnered widespread industry support and sales of HDMI equipped units is projected to grow from 50 million in 2005 to over 200 million in 2008.

Technology vendors are attempting to position 802.11 and UWB as candidate solutions for digital cable replacement. Unfortunately, the coverage area, throughput, and quality levels for 802.11 and UWB are woefully inadequate to serve as a replacement for the demanding high-performance digital cable market, particularly that related to 720p and 1080i HDTV. For example, the wireless replacement of the HDMI cables requires 7-10× greater throughput and 1000× better quality than what 802.11 and UWB were designed to provide.

By way of illustration, generic content transfer techniques share the following characteristics: shared multiple access communication, a 1% BER, latency acceptance, transfer of compressed data, use of retransmissions, and support for data rates up to 200 Mbps. In contrast, data transfer over high-performance digital cable is characterized by: dedicated point-to-point communication, 10⁻⁹ BER, low latency, transfer of uncompressed data, best effort communication (i.e., no retransmissions), and support for data rates in excess of 1 Gbps. Thus, existing wireless technologies such as 802.11 and Bluetooth along with proposed UWB solutions fail to provide the throughput and quality needed for in-home high-performance digital cable replacement.

Currently, 802.15.3a UWB is being touted as a solution to both generic content transfer and wireless HDMI cable replacement. Unfortunately, because of the emphasis on generic content transfer applications, 802.15.3a UWB performance falls dramatically short of what is required for wireless HDMI cable replacement. For instance, the maximum 802.15.3a data rate will be restricted to roughly 200 Mbps with potentially large data transfer latencies. 802.15.3a contains a general purpose media access control (MAC) that cannot exploit the inherent data rate asymmetries associated with HDMI where the display to source backchannel data rate requirement is negligible relative to the source to display forward channel—a result overall throughput suffers. Even more troubling is the 802.15.3a acceptance of a 1% BER (8% packet error rate (PER)) which has potentially disastrous quality implications that could impact consumer acceptance of wireless cable replacement products.

So while 802.15.3a certainly addresses the needs of generic content transfer applications, it falls far short of the data rates and error performance required for wireless HDMI cable replacement. Many have focused on compressing digital content using MPEG-2 to overcome the data rate limitations of 802.15.3a, but the cost associated with adding MPEG-2 encoders to source devices makes this impractical. Even if cost constraints could be overcome, transmission of MPEG-2 encoded video is one of the most demanding applications in terms of quality of service (QoS). MPEG-2 can not tolerate large variations on delays such as those introduced by the 802.15.3a MAC layer and MPEG-2 quality is severely degraded when BER approaches 10⁻⁵, far below the 1% BER target of 802.15.3a.

What is needed then, is a system, method and apparatus for the wireless delivery of content from a generalized content source to a general content sink. The proposed solution should perform in a manner that is sufficiently secure and robust to serve as a replacement for the delivery of HDMI content over cable. The solution should also be applicable to the delivery of other types of content traditionally delivered over cable, including but not limited to Digital Video Interface (DVI) content, composite video (CVSB) content, S-video content, RGB video content, YUV video content, and/or various types of audio content.

### BRIEF SUMMARY OF THE INVENTION

The present invention is directed to a system, method and apparatus for implementing a wireless point-to-point interface that securely and robustly delivers content from a generalized content source to a generalized content sink. A wireless interface in accordance with an embodiment of the present invention performs in a manner that is sufficiently secure and robust to serve as a replacement for the delivery of HDMI content over cable. The solution is also applicable to the delivery of other types of content traditionally delivered over cable, including but not limited to DVI, CVSB, S-video, RGB video, YUV video, and/or various types of audio content such as RCA audio, XLR audio, and 5.1, 6.1, 7.1 and 10.1 surround sound audio.

Further features and advantages of the invention, as well as the structure and operation of various embodiments of the invention, are described in detail below with reference to the accompanying drawings. It is noted that the invention is not limited to the specific embodiments described herein. Such embodiments are presented herein for illustrative purposes only. Additional embodiments will be apparent to persons skilled in the relevant art(s) based on the teachings contained herein.

### BRIEF DESCRIPTION OF THE DRAWINGS/FIGURES

The accompanying drawings, which are incorporated herein and form part of the specification, illustrate the present invention and, together with the description, further serve to explain the principles of the invention and to enable a person skilled in the relevant art(s) to make and use the invention.

FIG. 1 depicts a generalized system for the wireless delivery of content from a content source to a content sink in accordance with an embodiment of the present invention.

FIG. 2 depicts a system in which a wireless interface is used to replace HDMI cables between a content source and a content sink in accordance with an embodiment of the present invention.

FIG. 3 depicts a prior art system in which HDMI signals are conveyed between a content source and a content sink using expensive and bulky HDMI cable.

FIG. 4 illustrates a system in accordance with an embodiment of the present invention that provides for the wireless transmission of HDMI signals between a content source and a content sink.

FIG. 5 depicts a prior art system in which DVI signals and analog audio signals are conveyed between a content source and a content sink using a DVI cable and a plurality of audio cables, respectively.

FIG. 6 illustrates a system in accordance with an embodiment of the present invention that provides for the wireless transmission of DVI and analog audio signals from a content source to a content sink.

FIG. 7 illustrates a prior art system in which lossy compressed high-definition content is transferred wirelessly from a content source to a content sink.

FIG. 8 depicts a system that employs lossless compression combined with a sophisticated wireless interface for the transfer of high-definition content from a content source to a content sink in accordance with an embodiment of the present invention.

FIG. 9 depicts a system that employs no compression and a sophisticated wireless interface for the transfer of high-definition content from a content source to a content sink in accordance with an embodiment of the present invention.

FIG. 10 illustrates a conventional system in which HDCP protocol is performed on data transmitted over standard HDMI cable from a content source to a content sink.

FIG. 11 depicts a system that performs HDCP protocol over a wireless link between a content source and a content sink in accordance with an embodiment of the present invention.

FIG. 12 illustrates an embodiment of the present invention in which two source/sink pairs each utilize a first wireless channel for the transmission of high-definition content and a second wireless channel for MAC and multimedia signaling.

FIG. 13 illustrates in more detail a system in accordance with an embodiment of the present invention that utilizes a first wireless channel for passing high-definition content and a second wireless channel for MAC and multimedia signaling.

FIG. 14 is a graphical depiction of the bandwidth allocation for first and second wireless channels used for communicating between a content source and a content sink in accordance with an embodiment of the present invention.

FIG. 15 depicts a plurality of content sources and a plurality of content sinks in contention for shared wireless resources in accordance with an embodiment of the present invention.

FIG. 16 is a diagram that illustrates a conventional process for initiating high-definition content transfer between a media source and a media sink over a wired connection.

FIG. 17A is a diagram that illustrates a first portion of an auto-detect and auto-connect process of the present invention.

FIG. 17B is a diagram that illustrates a second portion of an auto-detect and auto-connect process of the present invention.

FIG. 18 illustrates a system that supports frequency hopping by multiple users over a set of frequencies not simultaneously occupied by other users in accordance with an embodiment of the present invention.

FIG. 19 depicts an example embodiment of the present invention in which transmit and receive diversity is used for RF communication between a content source and a content sink.

FIG. 20 is a diagram that shows the performance of Transition Minimized Differential Signaling (TMDS) decoding and encoding operations in a wireless HDMI interface between a content source and content sink.

FIG. 21 is a diagram that shows processes by which a prior art system implements a DDC and CEC channel between a media source and a media sink connected via a cable.

FIG. 22 is a diagram that shows a process by which a DDC channel is implemented between a content source and a content sink connected via a wireless HDMI interface in accordance with an embodiment of the present invention.

FIG. 23 is a diagram that shows a process by which a CEC channel is implemented between a content source and a content sink connected via a wireless HDMI interface in accordance with an embodiment of the present invention.

FIG. 24A shows a transmit (TX) wireless media adapter that wirelessly transmits clock information in accordance with an embodiment of the present invention.

FIG. 24B shows a receive (RX) wireless media adapter that wirelessly receives clock information in accordance with an embodiment of the present invention.

FIG. 25 is a graph illustrating the performance difference between a forward error correction (FEC) technique based on a convolutional code and an FEC technique based on a low-density parity check (LDPC) code.

FIG. 26 is a graph comparing BER as a function of the number of interferers for a prior art 802.15.3a ultra wide band (UWB) system versus a wireless HDMI system in accordance with an embodiment of the present invention.

FIG. 27 is a block diagram of a wireless HDMI transmitter in accordance with an embodiment of the present invention.

FIG. 28 is a block diagram of a wireless HDMI receiver in accordance with an embodiment of the present invention.

FIG. 29 illustrates the location of video, data island, and control periods within a portion of an HDMI frame in accordance with a conventional system.

FIG. 30 illustrates the placement of training sequences within a portion of a reformatted HDMI frame in accordance with the present invention.

FIG. 31 illustrates a system in which a transmit (or receive) wireless media adapter of the present invention is implemented as a dongle for the wireless delivery of S-Video content.

FIG. 32 illustrates a system in which a transmit (or receive) wireless media adapter of the present invention is implemented as a dongle for the wireless delivery of DVI content.

FIG. 33 illustrates a system in which a transmit (or receive) wireless media adapter of the present invention is implemented as a dongle for the wireless delivery of HDMI content.

The features and advantages of the present invention will become more apparent from the detailed description set forth below when taken in conjunction with the drawings, in which like reference characters identify corresponding elements throughout. In the drawings, like reference numbers generally indicate identical, functionally similar, and/or structurally similar elements. The drawing in which an element first appears is indicated by the leftmost digit(s) in the corresponding reference number.

### DETAILED DESCRIPTION OF THE INVENTION

Rather than utilizing a general purpose solution based on 802.15.3a that fails to meet the needs of the high-quality and bandwidth-intensive applications, an embodiment of the present invention represents an effort to tailor the wireless solution to the application. As will be described in more detail herein, an example point-to-point interface designed in accordance with an embodiment of the present invention tailors the wireless physical (PHY) layer and media access control (MAC) layer to the throughput and quality requirements for HDMI cable replacement. In particular, an embodiment of the present invention facilitates the replacement of HDMI cables that are specified with a BER of 10⁻⁹. Such an interface requires up to a 1.5 Gbps link to the display but a backchannel of only a few kbps.

As will be discussed herein, a wireless interface in accordance with an embodiment of the present invention can also be used as a replacement for the delivery of other types of content over cable, including but not limited to DVI, CVSB, S-video, RGB video, YUV video, and/or various types of audio content such as RCA audio, XLR audio, and 5.1, 6.1, 7.1 and 10.1 surround sound audio.

A. Overview of System for Wireless Transmission of Content in Accordance with an Embodiment of the Present Invention

The present invention is directed to a system, method and apparatus for implementing a wireless interface that securely and robustly delivers digital and/or analog content from a generalized content source to a generalized content sink. As will be described in more detail herein, an embodiment of the present invention accepts signals encoded for transmission over one or more wired connections at a content source and converts the signals into wireless signals modulated for transmission over the air. At a content sink, the resulting wireless signals are received and converted into signals encoded with a format expected given transmission over a wired connection.

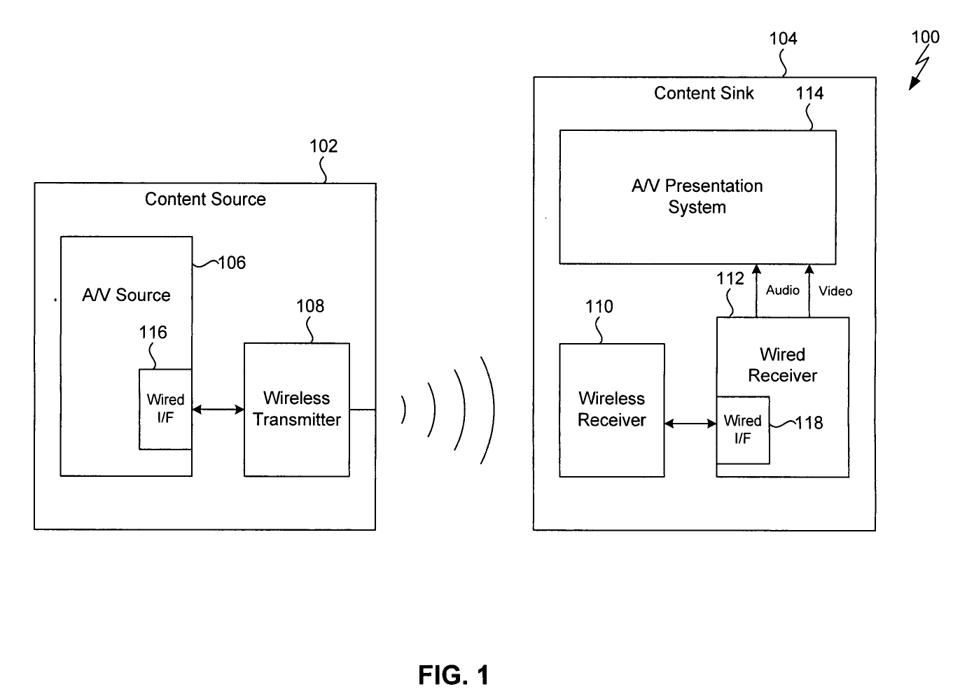

A generalized system 100 in accordance with an embodiment of the present invention is illustrated in FIG. 1. As shown in FIG. 1, system 100 includes a content source 102 and a content sink 104. Content source 102 may comprise any device or system that generates audio and/or visual content for delivery to a content sink. For example, content source 102 may comprise a set top box, a digital versatile disc (DVD) player, a data VHS (DVS) player, or an audio/video (A/V) receiver, although these examples are not intended to be limiting. Content sink 104 may comprise any device or system that receives audio and/or visual content from a content source and operates to present it to a user. For example, content sink 104 may comprise a digital television (DTV), a plasma display device, a liquid-crystal display television (LCD TV), or a projector, although these examples are not intended to be limiting.

As further illustrated in FIG. 1, content source 102 includes an A/V source 106 and a wireless transmitter 108, while content sink 104 includes a wireless receiver 110, a wired receiver 112, and an A/V presentation system 114. Within content source 102, A/V source 106 generates A/V signals and outputs them in a format encoded for transmission over one or more wired connections via a wired interface 116. Wireless transmitter 108 receives the signals output via wired interface 116 and converts them into wireless signals modulated for transmission over the air. Within content sink 104, wireless receiver 110 receives the wireless signals and converts them into signals encoded with a format expected given transmission over a wired connection. The converted signals are received by wired receiver 112 via a wired interface 118. Wired receiver 112 processes the received signals and outputs them in a suitable format to A/V presentation system 114 for presentation to a user.

As noted above, signals output by wired interface 116 and input by wired interface 118 are encoded in a format for transmission over a wired medium. In example embodiments of the present invention, these interfaces may conform to one or more of the following standards for wired data transmission: High-Definition Media Interface (HDMI), Digital Video Interface (DVI), composite video (CVSB) interface, S-video interface, RGB video interface, YUV video interface, and/or a variety of audio formats including but not limited to RCA audio, XLR audio, and 5.1, 6.1, 7.1 and 10.1 surround sound audio formats. In an embodiment, the wired formats used by wired interface 116 and wired interface 118 are the same or similar, although the invention is not so limited.

By providing a wireless link between wired interfaces 116 and 118, an embodiment of the present invention permits a user to connect content source 102 and content sink 104 in a manner that eliminates the use of bulky and expensive wiring. By facilitating cable replacement, an embodiment of the present invention also significantly simplifies the process of setting up a system including one or more content sources and sinks. Furthermore, because wireless transmitter 108 is configured to receive signals from a standard wired interface and wireless receiver 110 is configured to output signals to a standard wired interface, these components are easily integrated with existing systems designed for operation with wired connections.

As will be readily appreciated by a person skilled in the art, although wireless transmitter 108 is shown as an internal component of content source 102 it can also be implemented as an external add-on component with respect to content source 102. In the former case, wired interface 116 comprises an internal interface of content source 102, while in the latter case, wired interface 116 provides an external interface to content source 102 to which wireless transmitter 108 is attached. Likewise, wireless receiver 110 can either be implemented as an internal component of content sink 104 or, alternatively, as an external add-on component with respect to content sink 104. In the former case, wired interface 118 comprises an internal interface of content sink 104, while in the latter case, wired interface 118 provides an external interface to content sink 104 to which wireless receiver 110 is attached.

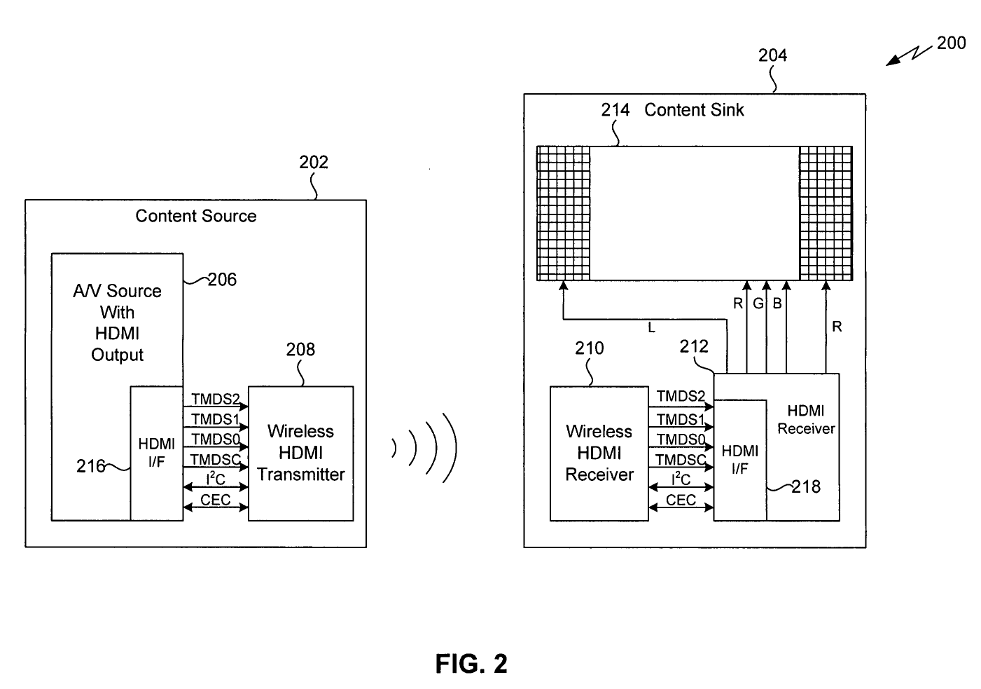

As noted above, an example embodiment of the present invention can be used to replace HDMI cables between a content source and sink. This is illustrated by system 200 of FIG. 2. As shown in FIG. 2, system 200 includes a content source 202 and a content sink 204. Content source 202 includes an A/V source with HDMI output 206 and a wireless HDMI transmitter 208, while content sink 204 includes a wireless HDMI receiver 210, an HDMI receiver 212, and an A/V presentation system 214.

Within content source 202, A/V source 206 generates A/V signals and outputs them in an HDMI format via HDMI interface 216. Wireless HDMI transmitter 208 receives the signals output from A/V source 206 and converts them into wireless signals modulated for transmission over the air. Within content sink 204, wireless HDMI receiver 210 receives the wireless signals and converts them into standard HDMI signals. The converted signals are received by HDMI receiver 212 via an HDMI interface 218. HDMI receiver 212 processes the received signals and outputs them in a suitable format to A/V presentation system 214 for presentation to a user. For example, as shown in FIG. 2, HDMI receiver 212 outputs video signals (R, G, B) and audio signals (L, R) to A/V presentation system 214.

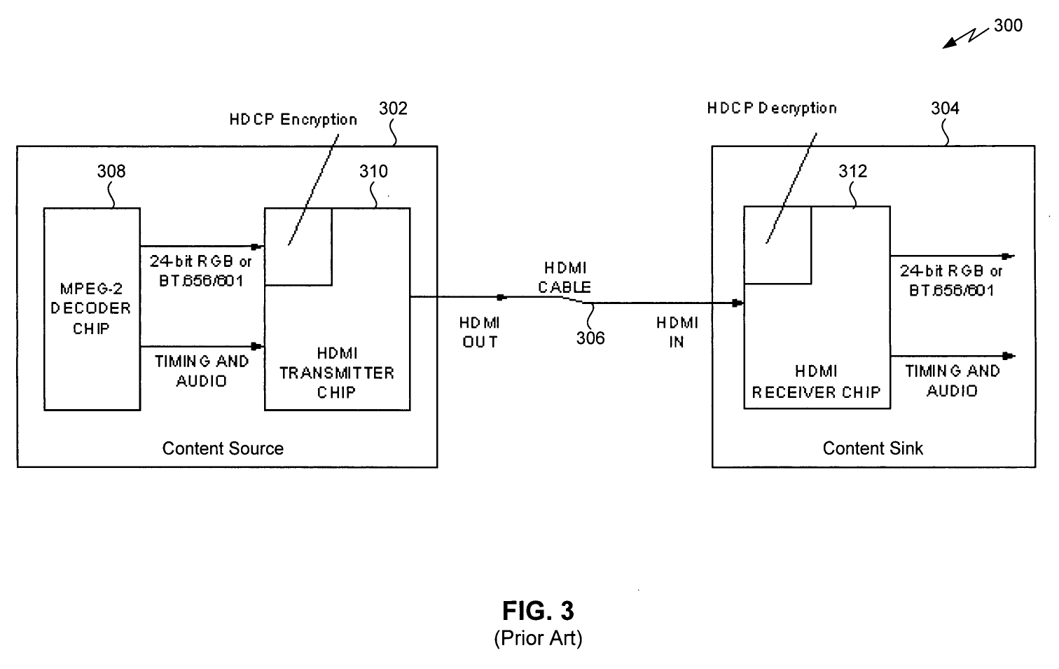

By way of further illustration, FIG. 3 depicts a prior art system 300 in which HDMI signals are conveyed between a content source 302 and a content sink 304 using expensive and bulky HDMI cable 306. Content source 302 includes an MPEG-2 decoder chip 308 and an HDMI transmitter chip 310. MPEG-2 decoder chip 308 produces a 24-bit RGB or BT.656/601 encoded video signal and a timing and audio signal. HDMI transmitter chip 310 processes the signals from decoder chip 308, including performing HDCP encryption on the encoded video signal, and generates an HDMI OUT signal for transmission via HDMI cable 306. Content sink 304 includes an HDMI receiver chip 312 that receives the transmitted signal (now denoted HDMI IN) via HDMI cable 306 and processes it to recover the 24-bit RGB or BT.656/601 encoded video signal and the timing and audio signal.

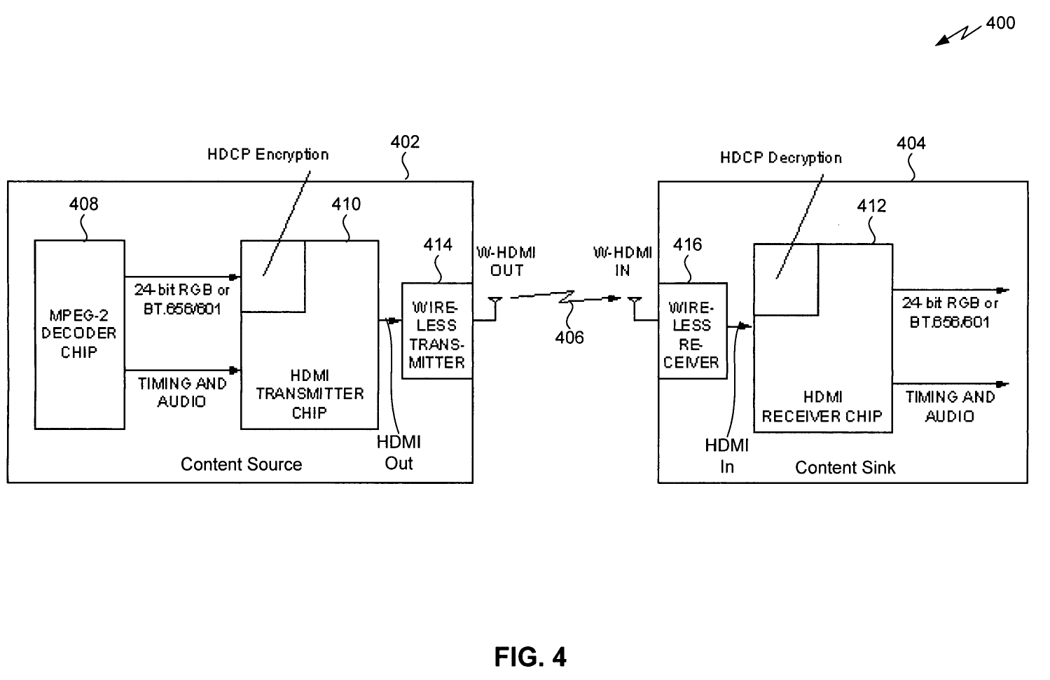

In contrast, FIG. 4 illustrates a system 400 in accordance with an embodiment of the present invention that provides for the wireless transmission of HDMI signals. As shown in FIG. 4, system 400 includes a content source 402 and a content sink 404. Like content source 302 of FIG. 3, content source 402 includes an MPEG-2 decoder chip 408 and an HDMI transmitter chip 410 that operate to produce an HDMI OUT signal. This signal, however, is received by a wireless transmitter 414 which converts it into a signal 406 for wireless transmission (denoted W-HDMI OUT) and wirelessly transmits it over the air. A wireless receiver 416 within content sink 404 receives the wireless HDMI signal (now denoted W-HDMI IN) and converts the received signal into a format expected by HDMI receiver chip 412 given wired transmission, denoted HDMI IN. HDMI receiver chip 412 processes HDMI IN to recover the 24-bit RGB or BT.656/601 encoded video signal and the timing and audio signal in essentially the same manner as HDMI receiver chip 312 of FIG. 3.

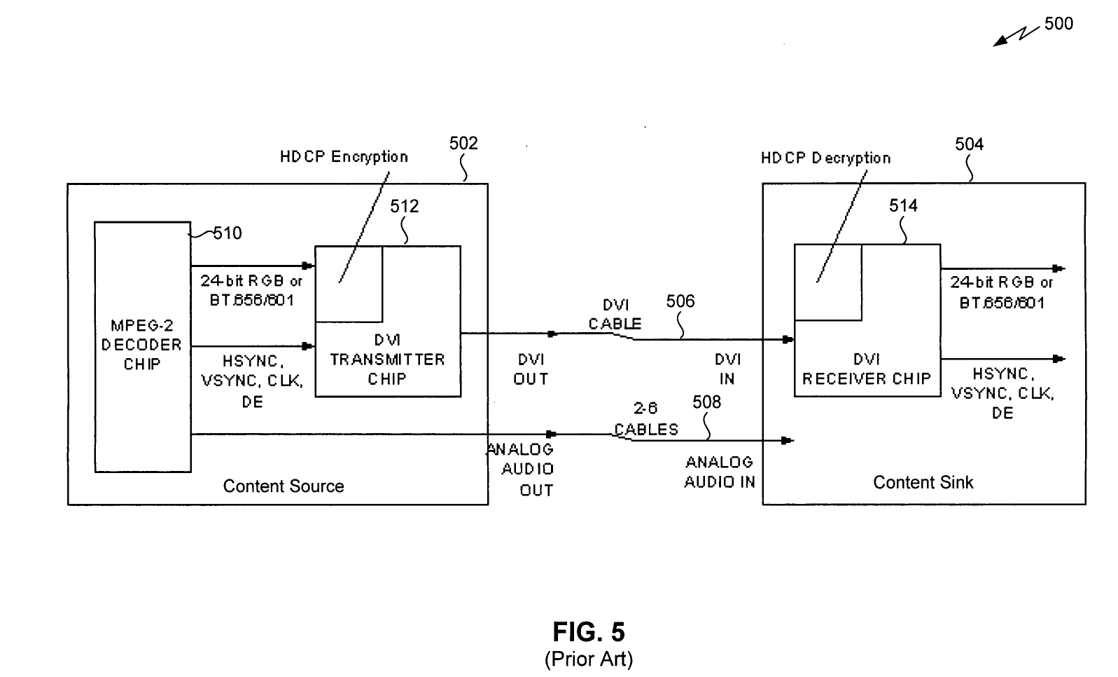

The present invention is equally applicable to the wireless transmission of signals formatted in accordance with wired formats other than HDMI. For example, the present invention can be applied to wirelessly transmit DVI and analog audio signals between a content source and content sink. By way of illustration, FIG. 5 depicts a prior art system 500 in which DVI signals and analog audio signals are conveyed between a content source 502 and a content sink 504 using a DVI cable 506 and 2-6 audio cables 508, respectively.

As shown in FIG. 5, content source 502 includes an MPEG-2 decoder chip 510 and a DVI transmitter chip 512. MPEG-2 decoder chip 510 produces a 24-bit RGB or BT.656/601 encoded video signal, the standard DVI HSYNC, VSYNC, CLK and DE signals, and an audio output signal designated ANALOG AUDIO OUT. DVI transmitter chip 512 processes the encoded video signal (including performing HDCP encryption on the video signal) and the HSYNC, VSYNC, CLK and DE signals to generate a DVI OUT signal for transmission via DVI cable 506. ANALOG AUDIO OUT is transmitted via analog cables 508. Content sink 504 includes a DVI receiver chip 514 that receives the DVI OUT signal, now denoted DVI IN, via DVI cable 506 and processes it to recover the 24-bit RGB or BT.656/601 encoded video signal and the HSYNC, VSYNC, CLK and DE signals. The transmitted ANALOG AUDIO OUT signal, now denoted ANALOG AUDIO IN, is received by content sink 504 over audio cables 508.

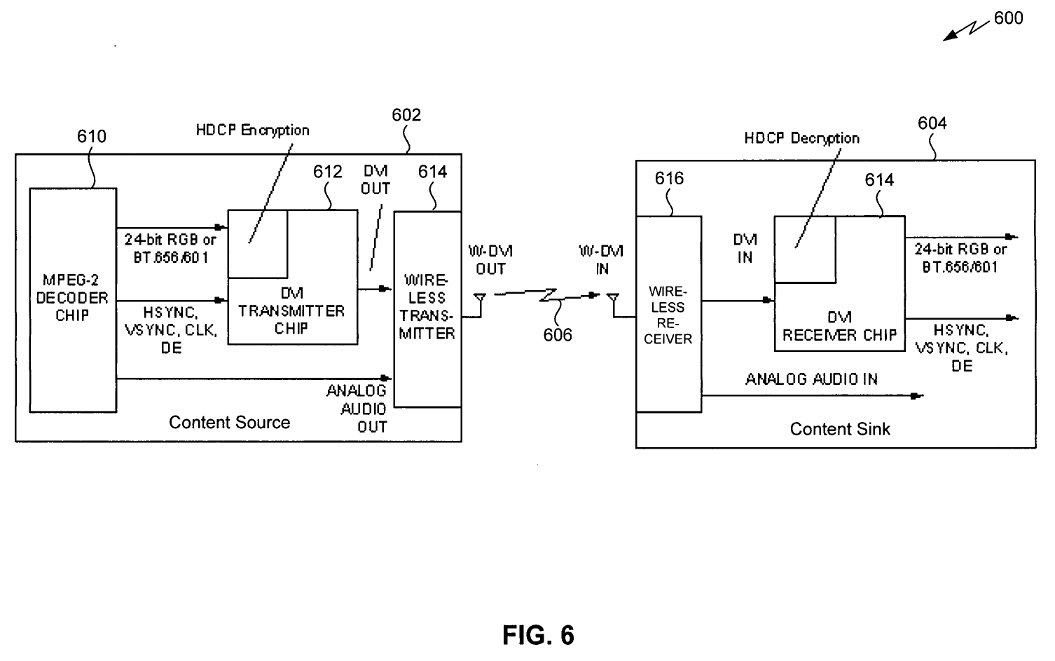

In contrast, FIG. 6 illustrates a system 600 in accordance with an embodiment of the present invention that provides for the wireless transmission of DVI and analog audio signals. As shown in FIG. 6, system 600 includes a content source 602 and a content sink 604. Like content source 502 of FIG. 5, content source 602 includes an MPEG-2 decoder chip 610 that operates, along with a DVI transmitter chip 612, to produce a DVI OUT signal and that also operates to produce an ANALOG AUDIO OUT signal. These signals, however, are received by a wireless transmitter 614 that converts them into a signal 606 for wireless transmission (denoted W-DVI OUT) and wirelessly transmits it over the air. A wireless receiver 616 within content sink 604 receives the wireless DVI signal (now denoted W-DVI IN) and converts the received signal into a signal having a format expected by DVI receiver chip 614 given wired transmission, denoted DVI IN, as well as into a recovered analog audio signal denoted ANALOG AUDIO IN. DVI receiver chip 614 processes DVI IN to recover the 24-bit RGB or BT.656/601 encoded video signal and the HSYNC, VSYN, CLK and DE signals in a like manner to DVI receiver chip 514 of FIG. 5.

Note that the present invention is not limited to the foregoing exemplary embodiments, and encompasses the transmission of other types of content traditionally transferred from a source to a sink over a wired medium. Additionally, as will be described in more detail herein, an embodiment of the present can advantageously be implemented to enable wireless communication between multiple content sources and multiple content sinks.

For example, as will be described in more detail herein, the present invention broadly encompasses a system consisting of N media transmitters, wherein a media transmitter includes at least one content/media source and a transmit (TX) wireless media adapter, and 1 media receiver, wherein a media receiver includes at least one content/media sink and a receive (RX) wireless media adapter. The media transmitters communicate to the media receiver over one radio channel for the purposes of sending video, audio, and control information and the media transmitter and media receiver exchange signal quality information, capability information, security information and other control information using a separate radio channel.

The present invention also broadly encompasses a system consisting of 1 media transmitter and N media receivers in which the media transmitter communicates to the media receivers over one radio channel for the purposes of sending video, audio, and control information and in which the media transmitter and media receivers convey signal quality information, capability information, security information and other control information using a separate radio channel. The invention also encompasses a system as above wherein the N media receivers share the backchannel by transmitting information and waiting for a response.

B. Transmission of Uncompressed or Losslessly Compressed Content in Accordance with an Embodiment of the Present Invention

In accordance with an embodiment of the present invention, uncompressed or losslessly compressed high-definition content, such as video or Surround Sound, is transmitted wirelessly between one or more high-definition content sources and one or more high-definition content sinks. Thus, for example, with continued reference to system 100 of FIG. 1, content source 102 may be configured in accordance with an embodiment of the present invention to wirelessly transmit uncompressed or losslessly compressed high-definition content to content sink 104.

Compression, which is also known as “packing,” refers to the creation of a smaller file from a larger file or group of files. Compression may also be defined as storing data in a format that requires less space than a standard storage format associated with that data. “Lossless compression” refers to a compression process in which no data is lost in a technical sense. Therefore, the compression process is reversible. In contrast, “lossy compression” is compression during which some data is lost. This process is irreversible.

One common lossless compression technique is “run length encoding,” in which long runs of the same data value are compressed by transmitting a prearranged code for “string of ones” or “string of zeros” followed by a number for the length of the string. Another lossless scheme is similar to Morse Code, wherein the most frequently occurring letters have the shortest codes. Huffman or entropy coding computes the probability that certain data values will occur and then assigns short codes to those with the highest probability and longer codes to the ones that don't show up very often. Everyday examples of programs that use lossless compression include the Stuffit™ program for Macintosh computers, developed and published by Allume Systems, Inc. of Watsonville, Calif., and the WinZip® program for Windows-based computers, developed and published by WinZip Computing, Inc. of Mansfield, Conn.

Lossy video compression systems use lossless techniques when necessary or feasible, but also derive substantial savings by discarding selected data. To achieve this, an image is processed or “transformed” into two groups of data. One group contains what is deemed essential information while the other group contains what is deemed unessential information. Only the group of essential information needs to be kept and transmitted. Examples of lossy video compression include MPEG-2 and MPEG-4.

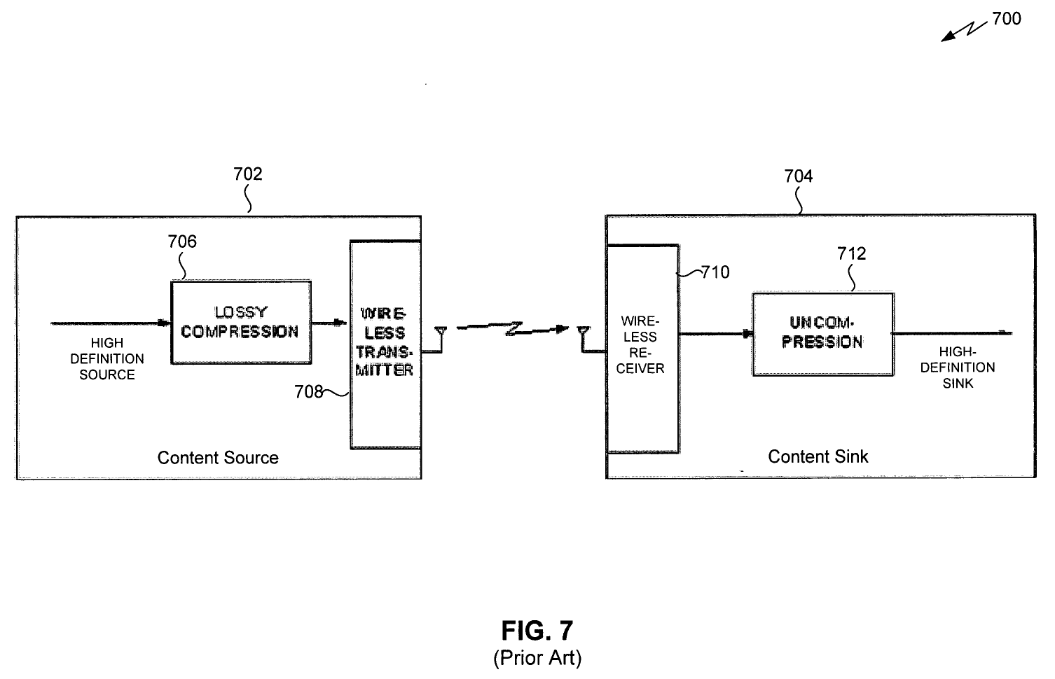

By way of illustration, FIG. 7 illustrates a prior art system 700 in which lossy compressed high-definition content is transferred wirelessly from a content source 702 to a content sink 704. As shown in FIG. 7, content source 702 includes lossy compression logic 706, which receives high-definition content and compresses it in accordance with a lossy compression technique, and a wireless transmitter 708 that transmits the compressed content in the form of a wireless signal to content sink 704. Content sink 704 includes a wireless receiver 710, which receives the wireless signal and recovers the compressed content therefrom, and uncompression logic 712, which uncompresses the compressed content. The prior art also encompassed the passing of uncompressed content over a wired connection.

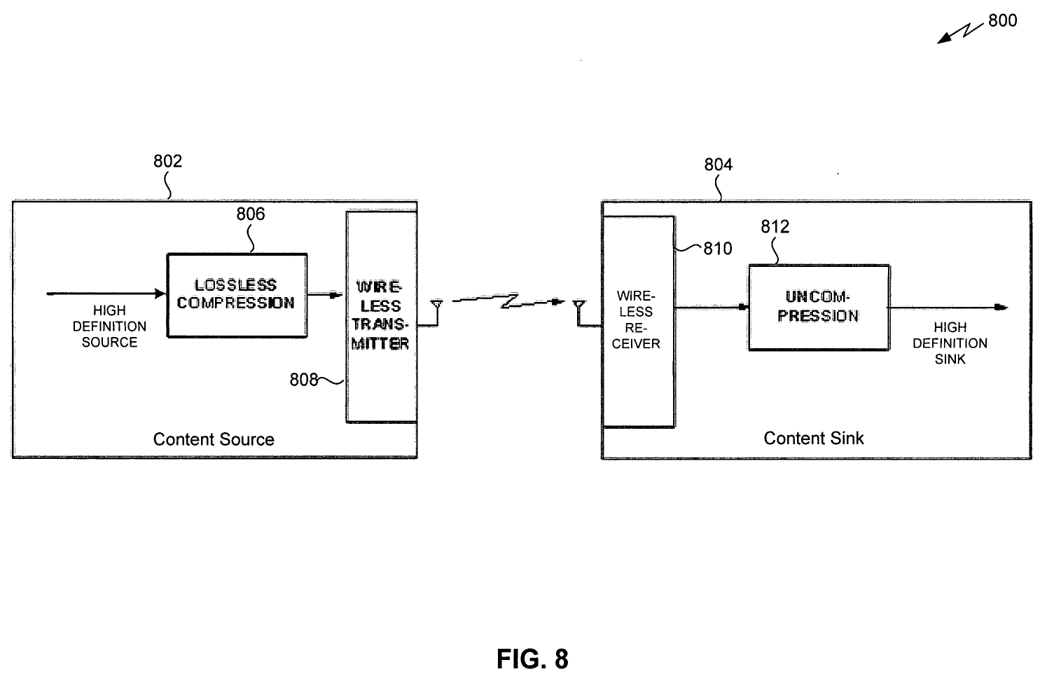

In contrast, rather than employing lossy compression to allow transmission over simple wireless systems, an embodiment of the present invention shown in FIG. 8 employs lossless compression combined with a more sophisticated wireless system that will be described in more detail herein. In particular, FIG. 8 depicts a system 800 that includes a content source 802 and a content sink 804. As shown in FIG. 8, content source 802 includes lossless compression logic 806, which receives high-deinition content and compresses it in accordance with a lossless compression technique, and a wireless transmitter 808 that transmits the compressed content in the form of a wireless signal to content sink 804. Content sink 804 includes a wireless receiver 810, which receives the wireless signal and recovers the compressed content therefrom, and uncompression logic 812, which uncompresses the compressed content.

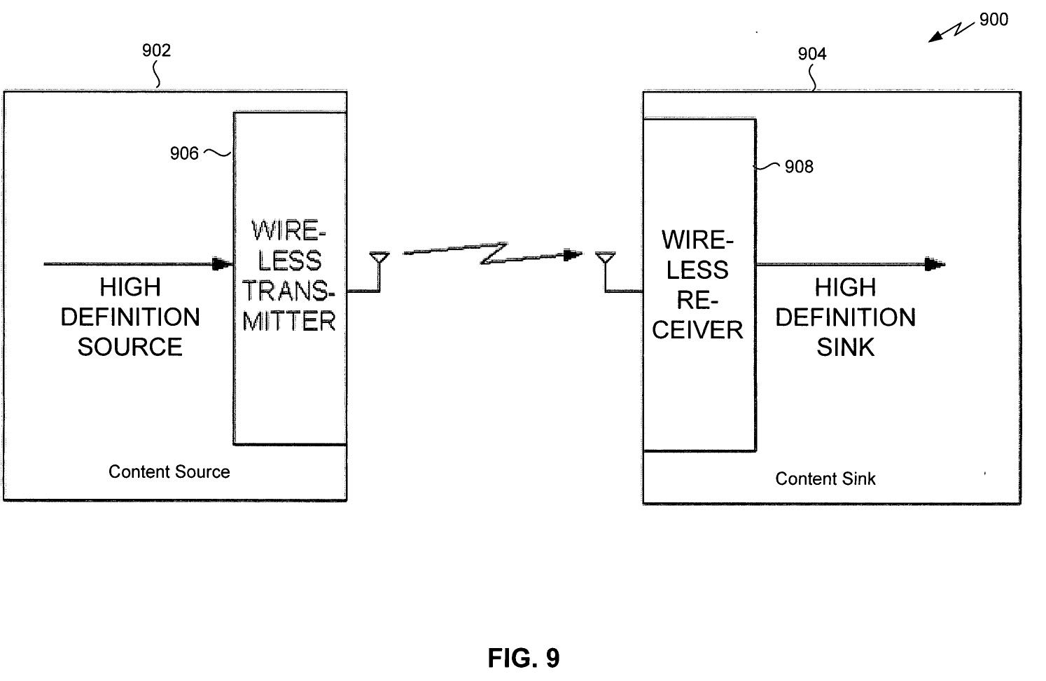

In further contrast to the prior art system depicted in FIG. 7, an embodiment of the present invention shown in FIG. 9 employs no compression and a more sophisticated wireless system that will be described in more detail herein. In particular, FIG. 9 depicts a system 900 that includes a content source 902 and a content sink 904. As shown in FIG. 9, content source 902 includes a wireless transmitter 906 that transmits uncompressed high-definition content in the form of a wireless signal to content sink 904. Content sink 904 includes a wireless receiver 908 that receives the wireless signal and recovers the uncompressed content therefrom.

The embodiments illustrated in FIGS. 8 and 9 are advantageous because a very noisy wireless channel will result in severe performance degradation for lossy compressed content, whereas uncompressed and losslessly compressed content will allow for much higher quality reproduction at the content sink with given wireless channel characteristics (e.g., bit error rate, signal dropout rate, energy-to-noise ratio per bit). Furthermore, compression adds latency and offsets between video and audio, each degrading the perceived quality at the video content sink. Finally, compression requires expensive processing devices that can be eliminated in an embodiment of the present invention that does not use compression or whose complexity can be greatly reduced in an embodiment of the present invention that uses lossless compression.

C. Use of Wired Security Protocols over Wireless Channels in Accordance with an Embodiment of the Present Invention

In accordance with an embodiment of the present invention, security protocols designed for content transfer over a wired medium, such as High-bandwidth Digital Content Protection (HDCP) or Data Transmission Content Protection (DTCP), are used for operation over wireless channels. Thus, for example, with continued reference to system 100 of FIG. 1, content source 102 and content sink 104 may be configured in accordance with an embodiment of the present invention to perform HDCP or DTCP security protocols for wireless content transfer.

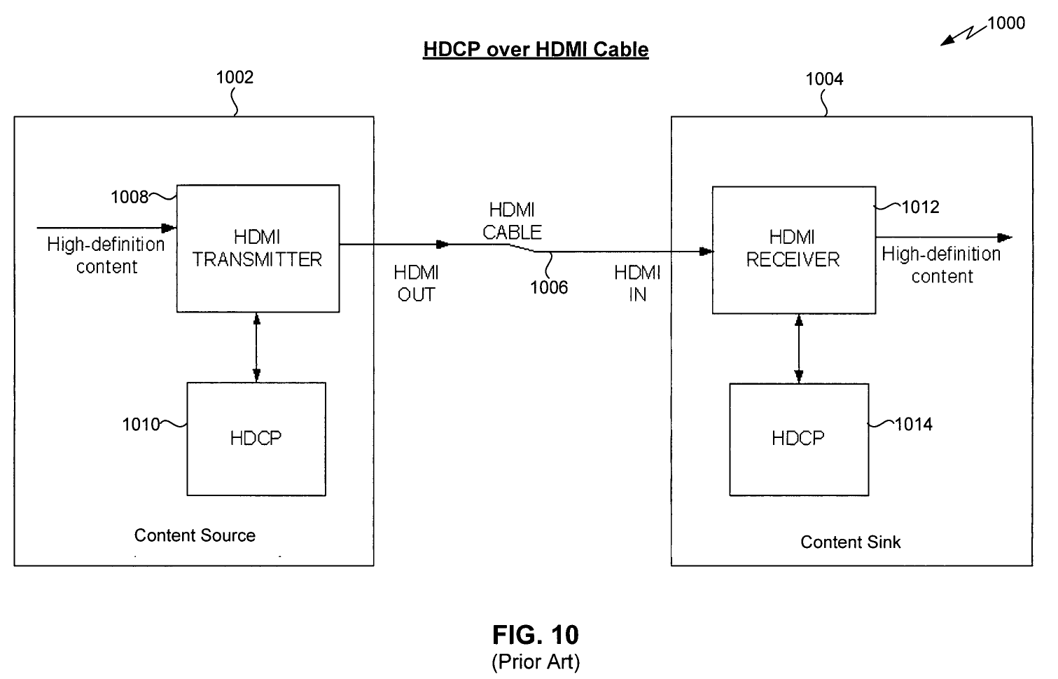

By way of illustration, FIG. 10 illustrates a conventional system 1000 in which HDCP protocol is performed on data transmitted over standard HDMI cable. As shown in FIG. 10, system 1000 includes a content source 1002 and a content sink 1004. Content source includes an HDMI transmitter 1008 that receives high-definition content and processes it to generate an HDMI OUT signal for transmission via HDMI cable 1006. Content sink 1004 includes an HDMI receiver 1012 that receives the transmitted signal (now denoted HDMI IN) via HDMI cable 1006 and processes it to recover the high-definition content. Content source 1002 also includes HDCP logic 1010 that is configured to perform an HDCP authentication process and/or encryption of high-definition content in accordance with the HDCP standard. Likewise, content sink 1004 also includes HDCP logic 1014 that is configured to perform an HDCP authentication process and/or decryption of high-definition content in accordance with the HDCP standard. Any HDCP signals or parameters that must be exchanged between content source 1002 and content sink 1004 are transferred over HDMI cable 1006.

In contrast, an embodiment of the present invention performs HDCP protocol over a wireless link. This may involve performing an HDCP authentication process over the wireless link. In a particular embodiment, a first wireless channel is used to pass high-definition content from the content source to the content sink while a separate frequency band (i.e., backchannel) is used to exchange HDCP parameters in a bi-directional manner between the content source and content sink.

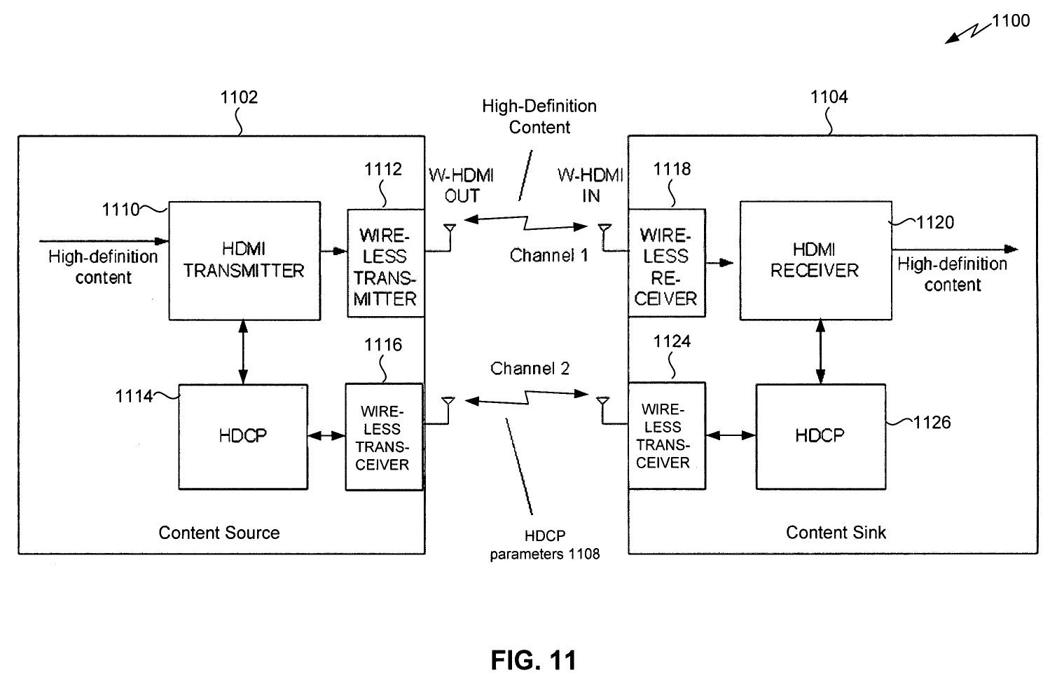

FIG. 11 illustrates such a system. As shown in FIG. 11, system 1100 includes a content source 1102 and a content sink 1104. Content source 1102 includes an HDMI transmitter 1110, HDCP logic 1114, a wireless transmitter 1112, and a wireless transceiver 1116. Content sink 1104 includes a wireless receiver 118, an HDMI receiver 1120, HDCP logic 1126, and a wireless transceiver 1124.

HDMI transmitter 1110 within content source 1102 receives high-definition content and processes it to generate a signal for wired transfer. This signal is received by wireless transmitter 1112 which converts it into a signal for wireless transmission, denoted W-HDMI OUT, and wirelessly transmits it over the air via a first wireless channel, denoted channel 1. Wireless receiver 1118 within content sink 1104 receives the wireless signal, now denoted W-HDMI IN, and converts the received signal into a format expected by HDMI receiver 1120 given wired transmission. HDMI receiver 1120 receives the converted signal and operates to recover high-definition content therefrom.

Within content source 1102, HDCP logic 1114 operates to perform an HDCP authentication process and encryption of high-definition content in accordance with the HDCP standard. Likewise, within content sink 1104, HDCP logic 1126 operates to perform an HDCP authentication process and decryption of high-definition content in accordance with the HDCP standard. Any HDCP signals or parameters 1108 that must be exchanged between content source 1102 and content sink 1104 are wirelessly passed between wireless transceiver 1116 and wireless transceiver 1124 in a bi-directional manner over a second wireless channel (i.e., the backchannel), denoted channel 2 in FIG. 11.

In an alternative embodiment, HDCP parameters that must be communicated from content source 1102 to content sink 1104 are transmitted on channel 1 along with high-definition content, while HDCP parameters that must be communicated from content sink 1104 to content source 1102 are all passed exclusively over the backchannel. In accordance with such an embodiment, wireless transceiver 1116 in content source 1102 might be replaced by a wireless receiver and wireless transceiver 1124 in content sink 1104 might be replaced by a wireless transmitter as only uni-directional transfer of these signals would be required over the backchannel.

Historically speaking, security protocols created for wired connections have not been applied to wireless channels. Instead, entirely new security protocols have been developed. These alternative protocols often require the stripping off of content protection, thereby potentially exposing unencrypted content. Furthermore, these new security protocols typically require a long and difficult approval process to be performed. In addition, new hardware and software must be developed to support the new security protocols. An embodiment of the present invention such as that described immediately above advantageously utilizes security protocols already approved for wired transmissions by content providers (e.g., MPAA). By extending these protocols to wireless transmissions, an embodiment of the present invention greatly simplifies the approval process by content providers. Furthermore this approach allows the use of existing source and sink processors, extended with a wireless connection, for secure content transfer.

D. Use of Two Wireless Channels for Communication Between a Content Source/Sink Pair in Accordance with an Embodiment of the Present Invention

In accordance with an embodiment of the present invention, a first wireless frequency band, or channel, is dedicated to the passing of high-definition content between a single, adaptively chosen, content source/sink pair and a second frequency band, or channel, different from that used for the passing of high-definition content, is used to bi-directionally pass media access control (MAC) information and multimedia signaling information between the pair. Such multimedia signaling information may include Display Data Channel (DDC) and Consumer Electronics Control (CEC) channel information. The first channel may also be referred to herein as “the downstream link” while the second channel may also be referred to herein as “the backchannel”.

This approach is particularly useful when a source/sink pair is in an area adequately RF-isolated from other source/sink pairs. For example, the source/sink pairs may be sufficiently separated spatially so that pairs do not interfere with one another, may be isolated from one another due to RF propagation obstacles such as walls, or may be isolated from one another due to directional RF propagation achieved using antennas with directionality (i.e., antennas that are not omni-directional).

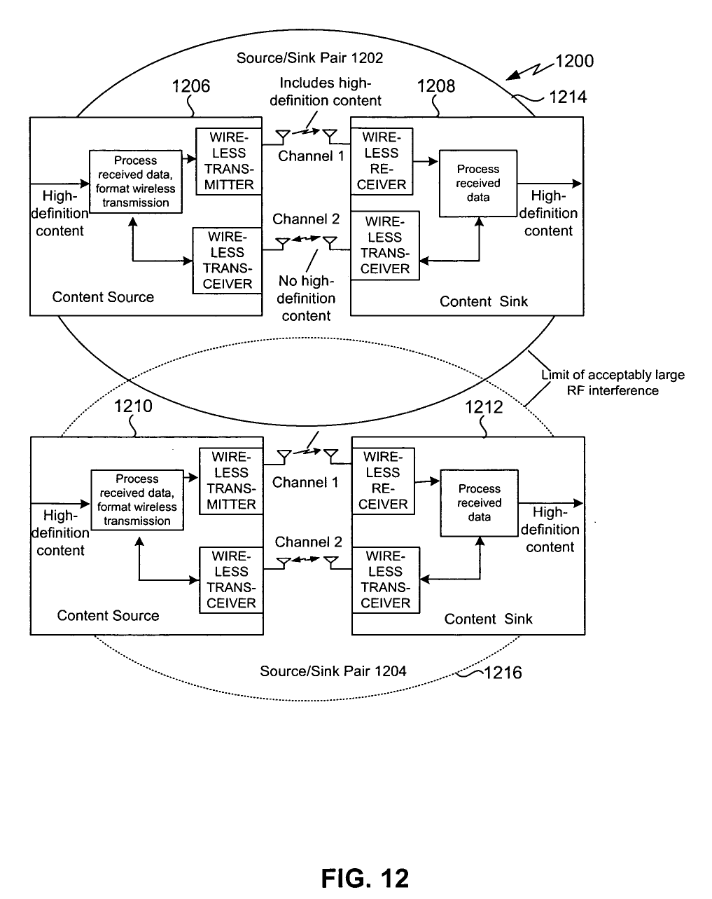

FIG. 12 illustrates an embodiment of the present invention in which two source/sink pairs each utilize a first wireless channel for the transmission of high-definition content and a second wireless channel for the bi-directional transfer of MAC information and multimedia signaling as described above.

In particular, as shown in FIG. 12, a system 1200 in accordance with an embodiment of the present invention includes a first adaptively-chosen content source/sink pair 1202 and a second adaptively-chosen content source/sink pair 1204. For each pair, there is an area beyond which large RF interference will not significantly impact performance. For source/sink pair 1202, the outside limit of this area is indicated by reference numeral 1214, while for source/sink pair 1204, the outside limit is indicated by reference numeral 1216.

Content source/sink pair 1202 includes a content source 1206 and a content sink 1208. Content source/sink pair 1204 includes a content source 1210 and a content sink 1212. Each of content sources 1206 and 1210 receive and process high-definition content, format it for wireless transmission, and transmit it over a first channel (“channel 1”) using a wireless transmitter. Each of content sinks 1208 and 1212 receives and processes the data transmitted over channel 1, recovering the high-definition content therefrom.

Furthermore, each of content sources 1206 and 1210 and content sinks 1208 and 1212 include a wireless transceiver for the bi-directional transfer of media access control (MAC) information and multimedia signaling between the pair over a second channel (“channel 2”). As noted above, such multimedia signaling may include Display Data Channel (DDC) and Consumer Electronics Control (CEC) channel information.

In contrast to the above embodiment, conventional wireless systems that are used or proposed for the passing of high-definition content (such as 802.11 and UWB systems) employ a complex in-band MAC layer to arbitrate channel usage between one or more content sources and one or more content sinks. This MAC layer adds overhead, thereby reducing throughput. In addition, MAC layer signaling requires a much lower data rate than that needed for high-definition content transfer and therefore, during intervals over which MAC layer signaling is passed, the channel usage is small relative to what could actually be passed. The same conventional proposals also perform multimedia signaling, such as DDC or CEC signaling, in-band. Again, passing this information requires a relatively low data rate and thus inefficiently uses spectral resources.

An approach in accordance with an embodiment of the present invention allows significant throughput improvements between a source/sink pair since a wide frequency band is dedicated for the transfer of high-definition content from the source to the sink whereas a small frequency band is used for MAC and multimedia signaling.

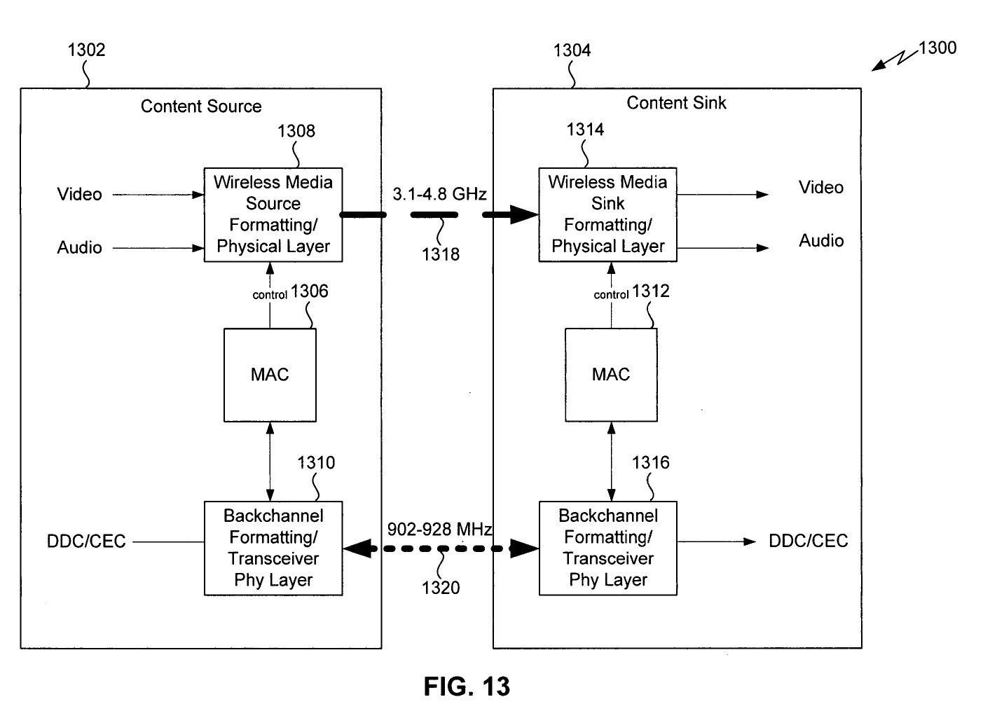

FIG. 13 illustrates in more detail a system 1300 in accordance with an embodiment of the present invention that utilizes a first wireless channel for passing high-definition content and a second wireless channel for MAC and multimedia signaling. As shown in FIG. 13, system 1300 includes a content source 1302 and a content sink 1304. Content source 1302 includes a MAC 1306, logic 1308, and logic 1310. Logic 1308 performs source formatting and physical layer functions for transmitting video and audio content over a wireless media channel 1318 under the control of MAC 1306. Logic 1310 performs backchannel formatting and transceiver physical layer functions for communicating MAC information and multimedia signaling (such as DDC/CEC signaling) over a backchannel 1310. Information relevant to backchannel protocols is communicated between MAC 1306 and logic 1310.

As further shown in FIG. 13, content sink 1304 includes a MAC 1312, logic 1314 and logic 1316. Logic 1314 performs sink formatting and physical layer functions for receiving video and audio content over wireless media channel 1318 under the control of MAC 1312. Logic 1316 performs backchannel formatting and transceiver physical layer functions for communicating MAC information and multimedia signaling (such as DDC/CEC signaling) over backchannel 1310. Information relevant to backchannel protocols is communicated between MAC 1312 and logic 1316.

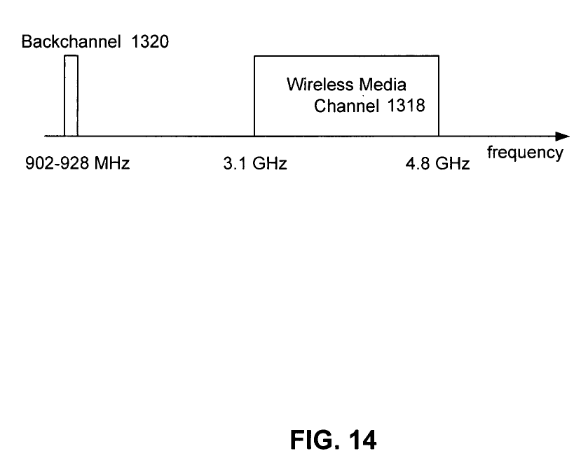

In one embodiment of the present invention, wireless media channel 1318 occupies a bandwidth approximately in the range of 3.1 GHz to 4.8 GHz, while backchannel 1320 occupies a bandwidth approximately in the range of 902-928 MHz. This bandwidth allocation is graphically depicted in FIG. 14.

As will be discussed in more detail herein, a wireless interface in accordance with an embodiment of the present invention utilizes orthogonal frequency division multiplexing (OFDM) for transmitting signals between a content source and a content sink. In one such implementation, OFDM null tones and/or windowing may be used to ensure that the use of a wireless protocol in accordance with an embodiment of the present invention does not interfere with wireless systems such as 802.11j that operate at or near 4.9 GHz.

In an alternate embodiment, a bandwidth approximately in the range of 6-10.6 GHz is used for wireless transmission of high-definition content. This is advantageous in that it avoids interference from users with communications systems designed for operation in other bands. No high-volume systems have currently been proposed for operation in this band. In an embodiment of the present invention that utilizes frequency hopping (as will be described herein), this allows an increase in peak power by more than a factor of two while still meeting FCC transmit power requirements.

In another embodiment of the present invention, a wireless media delivery system that uses OFDM for transmitting signals between a wireless transmitter media adapter and a wireless receiver media adapter can provide streaming audio information to multiple audio speakers simultaneously. In accordance with this embodiment, a media sink includes one or more audio speakers. To continuously provide audio signals to each speaker, the media delivery system can assign a range of OFDM tones to each speaker. Audio information directed to a specific speaker is transported over the assigned range of frequencies. In this way, an embodiment of the present invention can provide streaming analog audio information from a media source to a media sink having multiple audio speakers to implement a surround sound audio scheme.

E. Auto-Detection and Auto-Connection between a Content Source and Content Sink in Accordance with an Embodiment of the Present Invention

In accordance with an aspect of the present invention, an auto-detect and auto-pairing/auto-connect process is carried out to pair a media content sink to a media content source. The auto-detect and auto-connect process can be carried out over a separate RF channel from the RF channel used for wireless content transmission. The process determines from a set of possible content sources and content sinks a pair for which the wireless content transmission channel should be dedicated for a particular time interval. In contrast, prior art systems utilize separate wired connections between each transmitter and receiver or use a complicated MAC for wireless channel contention. The auto-detect and auto-connect process provided by an aspect of the present invention advantageously eliminates the overhead of such a complex MAC, eliminates cables, and eliminates manual user connection of wireless sources/sinks.

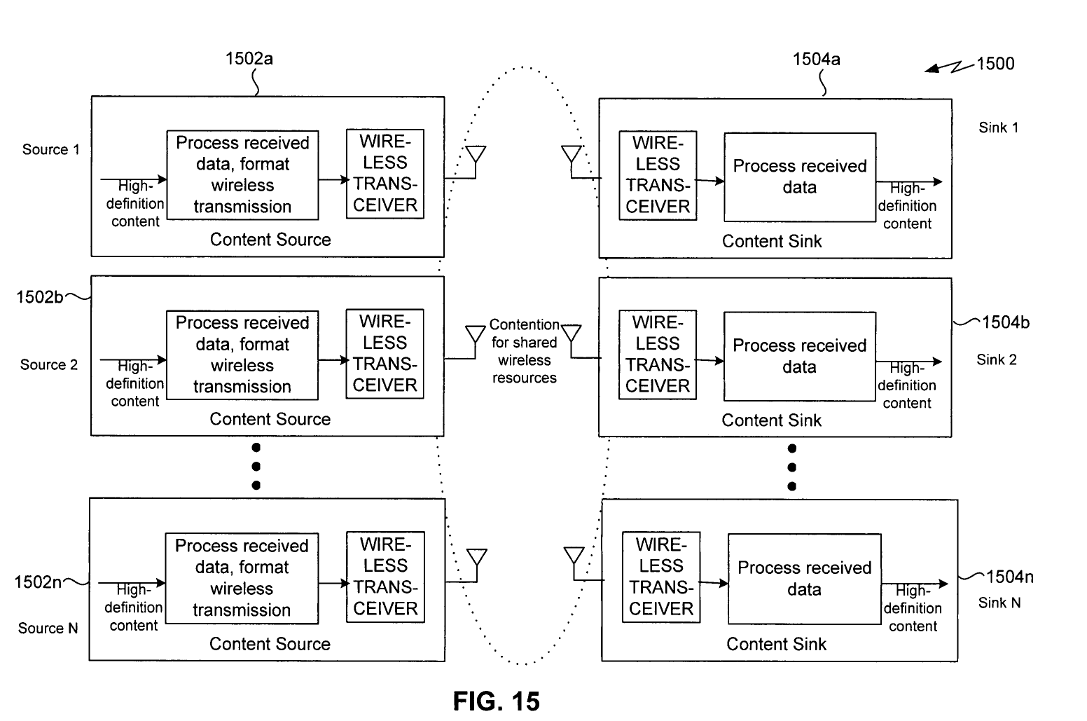

FIG. 15 depicts a system 1500 in accordance with the present invention that includes a plurality of content sources 1502a-1502n and a plurality of content sinks 1504a-1504n in contention for shared wireless resources. As will be described in more detail herein, each of the content sources 1502a-1502n and contents sinks 1504a-1504n is configured to perform an auto-detect and auto-connect process that enables sharing of the wireless resources.

In one aspect of the present invention, different networks of content source-content sink pairs can coexist such that a first network comprising a first set of content source-content sink pairs and a second network comprising a second set of content source-content sink pairs do not interfere with one another. Specifically, communication (e.g., content transmissions or overhead signaling transmissions) between a content source and a content sink of different networks can be prevented or not allowed.

For example, a first network (i.e., “Network A”) can include the content source 1502a and the content sink 1504a and a second network (i.e., “Network B”) can include the content source 1502b and the content sink 1504b. The content source 1502a and the content sink 1504a can paired. Likewise, the content source 1502b and the content sink 1504b can be paired. An aspect of the present invention can ensure that content or overhead signaling transmissions are not shared between the content source 1502a and the content sink 1504b. Similarly, an aspect of the present invention can ensure that content or overhead signaling transmissions are not shared between the content source 1502b and the content sink 1504a.

To prevent the sharing of any content or overhead signaling transmission between devices that exist in different networks, a network identification parameter (i.e., “Network ID”), for example, can be contained within any message exchanged between content sources and content sinks that exist within the same network. The Network ID can uniquely identify a network as well as the members within a network. As a result, messages received by a device on a first network can be screened, reviewed or filtered by the device to determine if the message is intended for devices on the first network. If the message, based on the included Network ID, is intended for devices on the first network, then the message can be further processed. Alternatively, if the message is not intended for devices on the first network, then the message can be ignored.

For example, the content source 1502a can transmit an overhead signaling message intended for the content sink 1504a. To do so, the content source attaches the Network ID parameter for Network A to the broadcasted message. If Network A and Network B operate in close proximity, then it is possible for both the content sink 1504a and the content sink 1504b to receive the message transmitted by the content source 1502a. The content sink 1504b, upon receipt of the message, can determine that the message is intended for devices within Network A. Consequently, the content sink 1504b can simply ignore the message or cease further processing of the message. The content sink 1504a, upon receipt of the message, can likewise determine that the message is intended for devices within Network A. Consequently, the content sink 1504a can determine to fully receive and process the message.

A Network ID or Network ID field within any communicated message can also include other information unique to a certain network. For example, the Network ID can be used to specify or determine a frequency hopping sequence. Further, the Network ID can be used, for example, to convey a message encryption key to enable secure communication between devices within a particular network or between a specific content source-content sink pair.

In accordance with an aspect of the present invention, a “provisioning” process enables devices that are to be on the same network to be pre-identified as such. That is, provisioning enables the setting of the same Network ID parameter across the transmitter wireless media adapters and receiver wireless media adapters intended to be on the same network. This provisioning processing, for example, can be established during manufacturing. Alternatively, provisioning can be established or executed by an end-user of one or more networks.

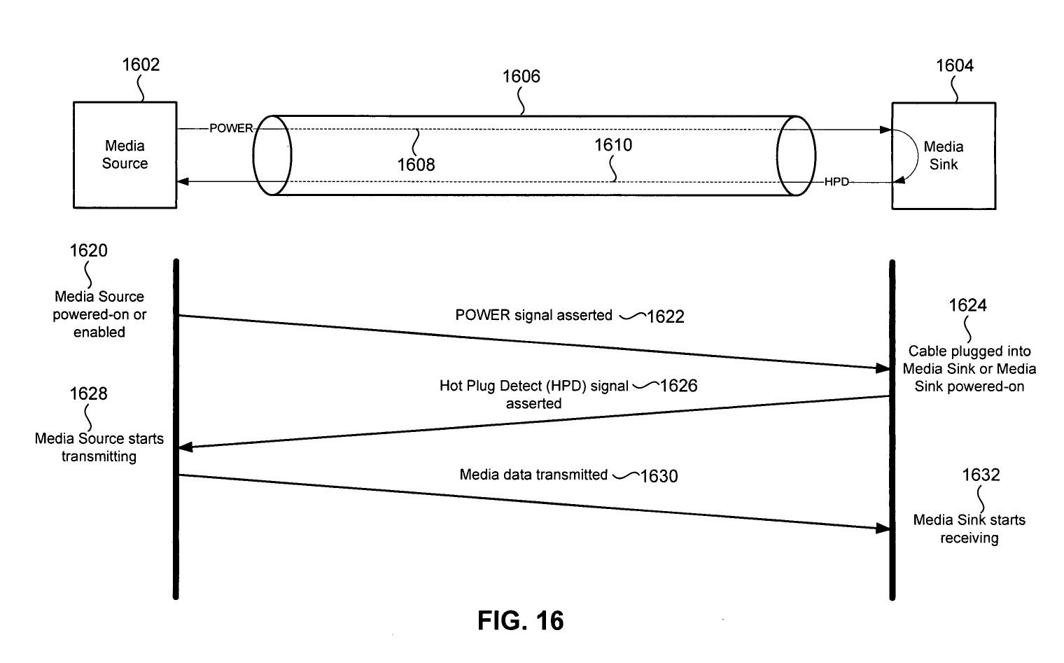

To facilitate explanation of an aspect of the auto-detect and auto-connect process provided by the present invention, a prior art method for performing the transfer of high-definition content will first be described. Prior art HDMI and DVI systems with wired connections employ what is known as a hot plug detect (HPD) signal to initiate high-definition content transfer. This process will be described in detail with reference to FIG. 16, which is a diagram that illustrates the communication of signals between a prior art media source 1602 and a prior art media sink 1604 over a wired connection or cable 1606.

In this process, after media source 1602 is powered-on or enabled as shown at step 1620, it asserts a power signal 1608 across wired connection 1606 as shown at step 1622. Power signal 1608 typically has a certain predefined voltage level, such as 5V. After cable 1606 is plugged into media sink 1604 and media sink 1604 is powered on as shown at step 1624, media sink 1604 enters a state in which it is ready for content reception. For example, media sink 1604 enters a state in which its Enhanced Extended Display Identification Data (E-EDID) is ready for reading. Once it has entered such a state and detects power signal 1608 asserted by media source 1602, media sink 1604 asserts a hot plug detect (HPD) signal 1610 across wired connection 1606 as shown at step 1626. Upon receiving HPD signal 1610, media source 1602 then begins transmitting high-definition content as shown at step 1628. The high-definition content is transmitted over wired connection 1606 as shown at step 1630 and received by media sink 1604 as shown at step 1632.

Pairing the prior art media source 1602 to the prior art media sink 1604 entails physically connecting the prior art media source 1602 to the prior art media sink 1604 using the wired connection 1606 and powering each device. Further, the wired connection 1606 provides a resource unique to the prior art media source 1602 and to the prior art media sink 1604 for the transfer of high-definition content. In contrast, pairing the content source 1502a and the content sink 1504a (and subsequently enabling the transfer of high-definition content) is more challenging since the content source 1502a and the content sink 1504a are not physically connected to one another. As previously mentioned, there may be several content sources (e.g., content sources 1502a-1502n) and content sinks (e.g., content sinks 1504a-n) that need to share or “contend” for a common and limited set of wireless resources. Further, a content sink may also need to chose a particular content source out of a set of possible content sources to pair with to receive high-definition content.

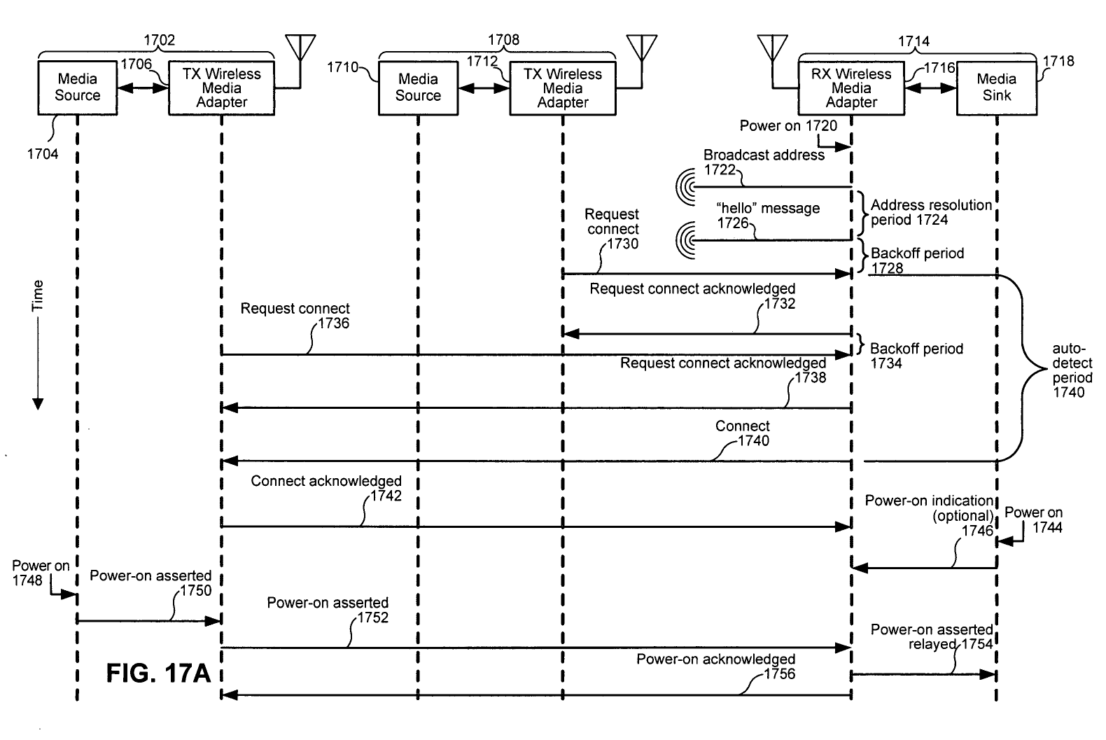

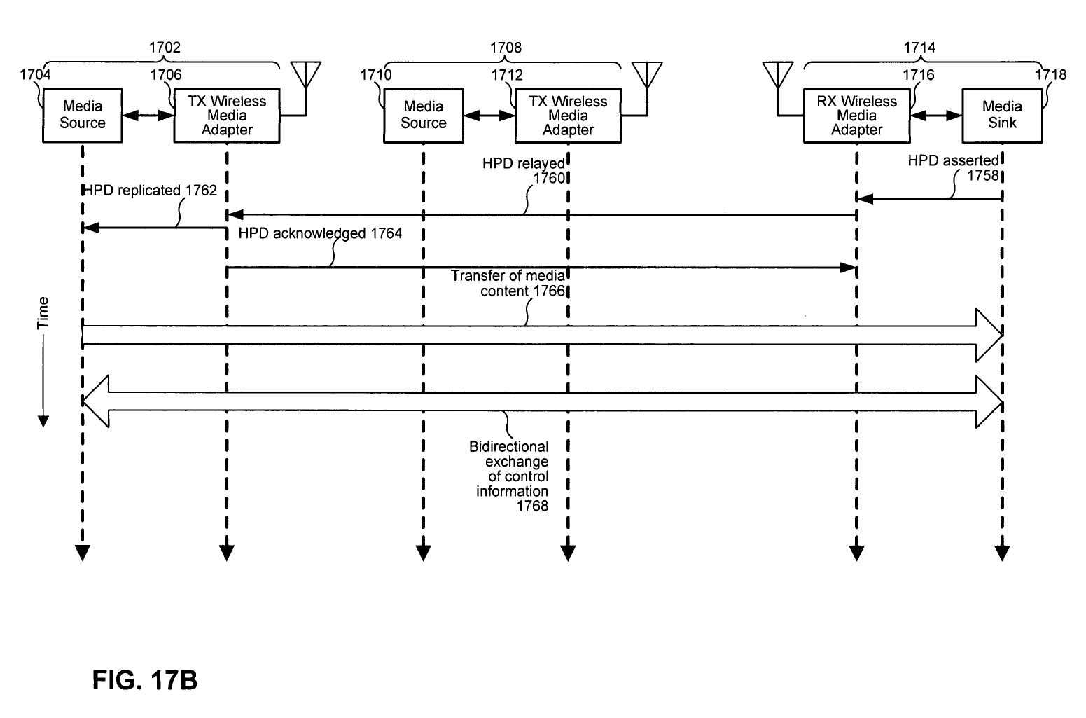

FIGS. 17A and 17B illustrate an auto-detect and auto-connect process in accordance with an aspect of the present invention. Specifically, FIGS. 17A and 17B demonstrate a process by which multiple content sources and/or multiple content sinks contend for limited wireless resources. Further, FIGS. 17A and 17B demonstrate how a particular content sink detects a set of possible content sources from which to receive content and how the content sink subsequently selects a content source for pairing.

As shown in FIGS. 17A and 17B, a first media transmitter 1702 is modeled as including a media source 1704 and a transmitter (TX) wireless media adapter 1706. A second media transmitter 1708 is modeled as including a media source 1710 and a TX wireless media adapter 1712. A media receiver 1714 is modeled as including a receiver (RX) wireless media adapter 1716 and a media sink 1718.

The present invention is not limited to the following operational description associated with the depiction of the auto-detect and auto-connect process in FIGS. 17A and 17B. Rather, it will be apparent to persons skilled in the relevant art(s) from the teachings herein that other operational control flows are within the scope and spirit of the present invention.

The TX wireless media adapter 1706 performs all physical (PHY) and MAC layer wireless functionality involved with the transfer of media content from the media source 1704 and may be internal or external to the media source 1704 depending upon the implementation. Similarly, the TX wireless media adapter 1712 performs all physical (PHY) and MAC layer wireless functionality involved with the transfer of media content from the media source 1710 and may be internal or external to the media source 1710 depending upon the implementation. Likewise, the RX wireless media adapter 1716 performs all PHY layer and MAC layer wireless functionality involved with the transfer of media content to the media sink 1718 and may be internal or external to media sink 1718 depending upon the implementation.

The auto-detect and auto-connect process logic may be considered part of the MAC layers of the TX wireless media adapters 1706 and 1712 and the RX wireless media adapter 1716. The PHY layer logic of the TX wireless media adapters 1706 and 1712 and the RX wireless media adapter 1716 can handle wireless transmissions necessary for carrying out the features of the auto-detect and auto-connect protocols provided by an aspect of the present invention.

An implementation of the present invention enables a single wireless channel to be used for transferring media content (e.g., high-definition content, composite content, or analog content) and for exchanging MAC information or overhead multimedia signaling. An implementation of the present invention can alternatively provide a first wireless channel (i.e., a wireless media channel) for the transfer of media content and a second wireless channel (i.e., a backchannel) for the exchange of MAC information and multimedia overhead signaling. For the purposes of the following discussion, it is assumed that the TX wireless media adapters 1706 and 1712 and the RX wireless media adapter 1716 use both a wireless media channel and a backchannel, as described more fully in the foregoing discussion relating to FIGS. 13 and 14.

The TX wireless media adapters 1706 and 1712 and the RX wireless media adapter 1716 can implement the auto-detect and auto-connect protocol in accordance with an aspect of the present invention independent of the power state of the media sources 1704 and 1710 and the media sink 1718, respectively. The power state of the media sources 1704 and 1710 and the media sink 1718 is determined or indicated by the presence or absence of a power signal, Hot Plug Detect signal or other indicator from each media device to its corresponding wireless media adapter. Therefore, the TX wireless media adapters 1706 and 1712 can be configured to respond to the RX wireless media adapter 1716 as soon as the TX wireless media adapters 1706 and 1712 are powered-on or otherwise enabled. Similarly, the RX wireless media adapter 1716 can be configured to begin or initiate the auto-detect and auto-connect process as soon as it is powered-on or otherwise enabled.

Alternatively, implementation of the auto-detect and auto-connect process in accordance with an aspect of the present invention can be dependent upon the power state of the media devices. The presence of a power signal from the media sources 1704 and 1710 to the TX wireless media adapters 1706 and 1712, respectively, indicates that each source is ready and able to transmit content. Therefore, the TX wireless media adapters 1706 and 1712 can be configured to respond to the RX wireless media adapter 1716 only if provided a power signal from the media sources 1704 and 1710, respectively. Similarly, the RX wireless media adapter 1716 can be configured to begin or initiate the auto-detect and auto-connect process only after receiving a Hot Plug Detect signal or any other power signal or indicator from the media sink 1718. The RX wireless media adapter 1716 can also be configured to begin or initiate the auto-detect and auto-connect process only after receiving a HPD signal from the media sink 1718. Under either scenario, the auto-detect and auto-connect process of an aspect of the present invention can ensure that a pairing or connection between a TX wireless media adapter and a RX wireless media adapter is established before any media content or media signaling information is wirelessly relayed between a media source and a media sink.

An auto-detect process in accordance with an aspect of the present invention fosters point-to-point communication by allowing a unique address to be assigned to each wireless media adapter. Further, an auto-detect process in accordance with an aspect of the present invention enables a TX wireless media adapter and a RX wireless media adapter to exchange address information and capability information, such as a supported frame format. Capability information can also include capability information of associated media devices. An auto-connect process in accordance with an aspect of the present invention subsequently enables a RX wireless media adapter to chooses a media source from which it will receive content. That is, an auto-connect process in accordance with an aspect of the present invention completes the pairing of a media source and a media sink to enable the transfer of wireless media content and exchange of associated overhead media signaling.

As shown in FIG. 17A, the RX wireless media adapter 1716 is powered-on or otherwise enabled at step 1720. In accordance with one aspect of the present invention, the RX wireless media adapter 1716 is immediately ready to begin or initiate the auto-detect process regardless of the power state of the media sink 1718. Accordingly, the RX wireless media adapter 1716 attempts to assign itself a unique communication address at step 1722. Specifically, at step 1722, the RX wireless media adapter 1716 chooses an address (e.g., a first attempted assigned address) and wirelessly transmits the address over the backchannel. The address is broadcasted as an address resolution broadcast message to determine if any other wireless media adapter is currently assigned the same address. The broadcasted message can be sent periodically over an address resolution period 1724.

If another wireless media adapter receives the broadcasted message and is currently assigned the same address, then the wireless media adapter will respond to the broadcast address resolution message. By responding to the broadcast address resolution message, a wireless media adapter informs the RX wireless media adapter 1716 that its first attempted assigned address is already in use or has previously been assigned. Consequently, the RX wireless media adapter 1716 can choose another address and can restart the address resolution process.

The selection of an address and the subsequent transmission of a corresponding broadcast address resolution message can be repeated until the RX wireless media adapter 1716 chooses an address that is not currently in use. The RX wireless media adapter 1716 can determine that a selected address is not in use when no other wireless media adapter responds to the address resolution broadcast message. Specifically, the RX wireless media adapter 1716 can assign itself an attempted address if no other wireless media adapter responds to the broadcasted message within the address resolution period 1724. Together, steps 1720, 1722 and 1724 represent an address resolution process in accordance with an aspect of the present invention.

The assigned address can be stored in a persistent memory of the RX wireless media adapter 1716. As a result, the assigned address can be used as the initial address for use in a new address resolution process in the event the RX wireless media adapter 1716 is powered-off and then powered-on (i.e., experiences a power cycle event).

In many instances, an address resolution broadcast message transmitted by the RX wireless media adapter 1716 may not be received by each wireless media adapter within the same network. That is, impediments such as, for example, walls or windows can prevent a wireless media adapter from properly receiving and deciphering a broadcast message from the RX wireless media adapter 1716. To aid the address resolution process, each wireless media adapter that properly receives the broadcasted message from the RX wireless media adapter 1716 can be configured to forward the broadcast message. Similarly, each wireless media adapter that properly receives a response from another wireless media adapter during the address resolution period 1724 can forward the response message to the RX wireless media adapter 1716. In this way, each wireless media adapter behaves as a relay to ensure that each wireless media adapter properly receives a broadcasted message from the RX wireless media adapter 1716 and that the RX wireless media adapter 1716 properly receives any associated response to its broadcast.

In accordance with an aspect of the present invention, each wireless media adapter can track and store all currently used addresses. Therefore, when a wireless media adapter has knowledge that an address within the broadcasted message from the RX wireless media adapter 1716 is currently in use, the wireless media adapter can properly inform the RX wireless media adapter.

The address resolution process described above in relation to the RX wireless media adapter 1716 can also be employed by the TX wireless media adapters 1706 and 1712. In this way, each wireless media adapter within a given network or family can assign itself a unique address. For simplicity, it is assumed in FIGS. 17A and 17B that the TX wireless media adapters 1706 and 1712 are powered-on and have already assigned themselves unique addresses. The address resolution process of an aspect of the present invention can be modified to ensure that a unique address is assigned to each wireless media adapter in a network based on adapter type (i.e., either TX or RX).

The address format used by the wireless media adapters can be the logical address format described in Version 1.1 of the HDMI Specification at pages CEC-14, the entirety of which is incorporated by reference as if fully set forth herein.

After the RX wireless media adapter 1716 has assigned itself a unique address, the RX wireless media adapter 1716 begins the process of discovering operable TX wireless media adapters (i.e., the TX wireless media adapters 1706 and 1712). As shown in step 1726, the RX wireless media adapter 1716 periodically broadcasts a “hello” message. The “hello” broadcast message can include capability information of the RX wireless media adapter 1706 and the associated media sink 1718 and can also include the address of the RX wireless media adapter 1706. The “hello” broadcast message, for example, can be performed using the CEC frame format with destination logical address field set to 0b1111, as described in Version 1.1 of the HDMI Specification at pages CEC-10. The TX wireless media adapters 1706 and 1712 receive the “hello” broadcast message (or “discovery” message). Accordingly, the TX wireless media adapters 1706 and 1712 can determine the capabilities and address of the RX wireless media adapter 1716 upon receipt of the “hello” message.

Each TX wireless media adapter 1706 and 1712 can respond to the “hello” message. To prevent the TX wireless media adapters 1706 and 1712 from responding to the “hello” message at the same time, a contention resolution process for the backchannel can be implemented. Specifically, each of the TX wireless media adapters 1706 and 1712 can be initialized with a random number used to determine a time when each of the TX wireless media adapters 1706 and 1712 can respond to the “hello” message. The time determined by each of the TX wireless media adapters 1706 and 1712 specifies how long each adapter will wait before attempting to respond to the “hello” broadcast message. The wait times can be measured from receipt of the “hello” message by the TX wireless media adapters 1706 and 1712, respectively. The random number used to calculate the time can be set, for example, by the manufacturer of the TX wireless media adapters 1706 and 1712. This calculated time period can be referred to as a “backoff” period.

In general, any wireless media adapter responding to any broadcast message can determine a “backoff” period and can wait for the “backoff” period to expire before attempting to respond to the broadcast message. A contention resolution protocol that uses a “backoff” period can decrease the likelihood of simultaneous transmission on a shared channel.

Furthermore, after determining a “backoff” period and prior to its expiration, each wireless media adapter can listen for any transmissions from any other wireless media adapter. If a transmission is heard, then each wireless media adapter within its respective “backoff” period can determine that the backchannel is in use. Consequently, each wireless media adapter will wait until the backchannel is freed before responding. Once the channel is freed, each wireless media adapter can recalculate a new “backoff” period. If the “backoff” period of a wireless media adapter expires and no transmissions from any other media adapter is received or heard during the “backoff” period, then the wireless media adapter can conclude that the channel is available for use. As a result, the channel is available to support a transmission from the wireless media adapter.

At step 1728, the “backoff” period of the TX wireless media adapter 1712 expires without the TX wireless media adapter 1706 occupying the backchannel. As a result, the TX wireless media adapter 1712 responds to the “hello” message of the RX wireless media adapter 1716 with a “request connect” message at step 1730. The “request connect” message can include the capability information of the TX wireless media adapter 1712 as well as its unique address. Further, the “request connect” message can include the capability information of the associated media source 1710 as well as the current power state of the media source 1710.

After receiving the “request connect” message from the TX wireless media adapter 1712, the RX wireless media adapter 1716 can acknowledge the receipt of the “request connect” message. Specifically, at step 1732 the RX wireless media adapter 1716 can reply with a “request connect acknowledged” message.

A TX wireless media adapter captures the backchannel if it successfully responds to the “hello” frame. In doing so, a set of transmissions between the RX and TX wireless media adapters can be triggered allowing for address and capability information to be exchanged. The set of transmissions can be more extensive than the “request connect” message transmitted at step 1730 and the “request connect acknowledged” message transmitted at step 1732. In many instances, the more extensive set of transmissions may be needed to ensure the full exchange of requisite capability and address information. Further, only the TX wireless media adapter that captures the backchannel can transmit over the channel until it “frees” the channel.

At step 1734, the “backoff” period of the TX wireless media adapter 1706 expires without the TX wireless media adapter 1712 occupying the backchannel. As a result, the TX wireless media adapter 1706 responds to a “hello” message of the RX wireless media adapter 1716 with a “request connect” message at step 1736. The “request connect” message can include the capability information of the TX wireless media adapter 1706 as well as its unique address. Further, the “request connect” message can include the capability information of the associated media source 1704 as well as the current power state of the media source 1704. After receiving the “request connect” message from the TX wireless media adapter 1706, the RX wireless media adapter 1716 can acknowledge the receipt of the “request connect” message. Specifically, at step 1738 the RX wireless media adapter 1716 can reply with a “request connect acknowledged” message.

As shown in FIG. 17A, the “backoff” period 1734 can be a recalculated “backoff” period due the prior set of transmissions between the TX wireless media adapter 1712 and the RX wireless media adapter 1716. Specifically, the “backoff period” of the TX wireless media adapter 1706 is re-calculated after the “request connect acknowledged” message transmitted by the RX wireless media adapter 1716. Alternatively, the “backoff period” of the TX wireless media adapter 1706 can be based on a message transmitted by the TX wireless media adapter 1712 notifying the TX wireless media adapter 1706 that the backchannel is free. Further, the “backoff period” of the TX wireless media adapter 1706 can be based on the most recent periodic “hello” message broadcasted by the RX wireless media adapter 1716. The “backoff period” can also be based on the last bidirectional exchange of address or capability information between the TX wireless media adapter 1712 and the RX wireless media adapter 1716.

The RX wireless media adapter 1716 will continue to receive “request connect” messages from other TX wireless media adapters until a certain time denoted the “auto-detect period” 1740 expires. As shown in FIG. 17A, the “auto-detect period” 1740 is measured with respect to a time when the first “request connect” message was received at step 1730. Alternatively, the “auto-detect period” 1740 can be measured from a time when the first “hello” message was sent at step 1726. The “auto-detect period” 1740 can expire prior to each TX wireless media adapter having the opportunity to capture the backchannel. For example, the “auto-detect period” 1740 can be set to approximately 100 millisecond such that an auto-connect process can begin even if some of the TX wireless media adapters have not successfully responded to a “hello” message from the RX wireless media adapter 1716. Alternatively, an “auto-detect period” can not be specified such that the every TX wireless media adapter can communicate with the RX wireless media adapter 1716 prior to the initiation of an auto-connect process.

In accordance with an aspect of the present invention, each message or message frame transmitted over the backchannel can request or require acknowledgement of receipt. For example, a TX wireless media adapter, when attempting to capture the backchannel can request that its response to the “hello” message be acknowledged. Therefore, if a particular frame or message is not acknowledged, the TX wireless media adapter can retry or retransmit its response after a set number of frames or after a set waiting time. If a fixed number of retries are each unsuccessful, a TX wireless media adapter can determine that its attempt to capture the channel has failed. Consequently, the TX wireless media adapter can restart the contention process (e.g., recalculate a “backoff” period) to attempt to capture the channel until the auto-detect period has expired. Transmission of communication messages and appropriate acknowledgments can be implemented, for example, using a CEC-specified acknowledgement procedure

At the conclusion of the “auto-detect period” 1740, the RX wireless media adapter 1716 can use a deterministic process to choose one of the identified media sources 1704 or 1710 (i.e., via the TX wireless media adapters 1706 or 1712) for auto-connecting or pairing. The RX wireless media adapter 1716 can maintain a stored list of TX wireless media adapters in persistent memory. The stored list can include capability information and address information. Further, the list can be arranged according to address value (i.e., a sequential listing of TX wireless media adapters according to an associated address). The media source can be selected based on factors such as, for example, the address associated with each media source 1704 and 1710, the capabilities of each media source 1704 and 1710, and whether the media source 1704 or 1710 is powered-on. For example, the chosen media source can be the media source with the lowest assigned address. The media source can also be chosen based on a previous connection established by the RX wireless media adapter 1716 prior to the RX wireless media adapter experiencing a power cycle event. That is, the RX wireless media adapter 1716 can chose to re-connect with a media source that the RX wireless media adapter 1716 was previously connected to immediately prior to being powered-off.

Once a media source is selected, the RX wireless media adapter 1716 sends the chosen media source an auto-connect control message. This is illustrated by the “connect” message at step 1740. The “connect” message is an auto-connect message transmitted by the RX wireless media adapter 1716 to the TX wireless media adapter 1706.

Upon receipt of the “connect” message, the TX wireless media adapter 1706 can transmit a “connect acknowledged” message at step 1742. After transmitting the “connect acknowledged” message at step 1742, the TX wireless media adapter 1706 can relay any media control signals from a powered-on media source 1704 to the RX wireless media adapter 1716. In accordance with an aspect of the present invention, the RX wireless media adapter 1716 can issue a “connect” message to a TX wireless media adapter regardless of the power state of the associated media sink 1718 and the associated media source 1704. Alternatively, the RX wireless media adapter 1716 can be configured to issue a “connect” message only after the media sink 1718 has been powered-on. Further, the RX wireless media adapter 1716 can be configured to issue a “connect” message only after the media sink 1718 has been powered-on, the media source 1704 has been powered-on, and the TX wireless media adapter 1706 has indicated that the media source 1704 has been powered-on.

At step 1744, the media sink 1718 is powered-on. In response, at step 1746, the RX wireless media adapter 1716 determines that the media sink 1718 is powered or otherwise enabled. Accordingly, the RX wireless media adapter 1716 is informed that the media sink 1718 is powered-on.

At step 1748, the media source 1704 is powered-on. In response, at step 1750 a powered-on signal is asserted by the media source 1704 and received by the TX wireless media adapter 1706. Accordingly, the TX wireless media adapter 1706 is informed that the media source 1704 is powered-on.

At step 1752, the TX wireless media adapter 1706 informs the RX wireless media adapter 1716 that the media source 1704 is now powered-on. At step 1754, the RX wireless media adapter 1716 relays the power-state of the media source 1704 to the media sink 1718. The RX wireless media adapter 1716 can relay the power state of the media source 1704 to the media since 1718 by replicating the asserted power signal from media source 1704. At step 1756, the TX wireless media adapter 1716 acknowledges receipt of the information on the power state of the media source 1704 provided by the TX wireless media adapter 1706.

FIG. 17B illustrates the remaining operational steps of the auto-detect and auto-connect process. At step 1758, the media sink 1718 asserts a HPD signal. The media sink 1718 can assert the HPD signal at any time after being powered-on. In response, the RX wireless media adapter 1716 relays the HPD signal at step 1760 as a “hot-plug detect” message to the TX wireless media adapter 1706. At step 1762, the TX wireless media adapter 1706 provides a replicated HPD signal to the media source 1704. At step 1764, the TX wireless media adapter 1706 acknowledges receipt of the “hot-plug detect” message and indicates that a replicated HPD signal has been provided to the media source 1704.

At this point, the media source 1704 begins transmitting media content or begins the HDCP authentication process if appropriate. Step 1766 generally shows the transfer of media content from the media source 1704 to the TX wireless media adapter 1706, the wireless transfer of the media content from the TX wireless media adapter 1706 to the RX wireless media adapter 1716 over a forward audio/video channel, and the transfer of the media content from the RX wireless media adapter 1716 to the media sink 1718. Step 1766 generally illustrates the bidirectional exchange of control information (e.g., DDC or CEC information) between the media source 1704 and media sink 1718 via the TX wireless media adapter 1706 and the RX wireless media adapter 1716.

In accordance with an aspect of the present invention, steps 1750 through 1764 do not need to be implemented when the media source 1704 and the media sink 1706 do not need to assert a HPD signal prior to the transfer of media content. Specifically, steps 1750 through 1764 can be performed when the media source 1704 and the media sink 1718 are either HDMI or DVI media devices. Alternatively, steps 1750 through 1764 do not need to be performed when media source 1704 and the media sink 1718 are either component or analog (e.g., S-Video) media devices. For example, when the media source 1704 and the media sink 1718 are S-Video media devices, the forward wireless audio/video channel is enabled immediately after the TX wireless media adapter 1704 and the RX wireless media adapter 1716 are connected at step 1742. Consequently, media content can be transferred from the media source 1704 to the media sink 1718 after both devices are powered-on.

In many circumstances, the RX wireless media adapter 1716 may fail to receive any response to the “hello” message broadcasted at step 1726. Alternatively, the RX wireless media adapter 1716 may fail to find any unconnected or unpaired media sources. Under these circumstances, the RX wireless media adapter 1716 can re-broadcast the “hello” message (either through a periodic or a periodic process) until one or more responses are received or until an unpaired media source is located. The RX wireless media adapter 1716 can re-broadcast the “hello” message at a rate low enough not to interfere with other similar/companion content sources/sinks within its transmission range.

In accordance with an aspect of the present invention, the connection between the TX wireless media adapter 1706 and the RX wireless media adapter 1716 can be maintained when the media sink 1704 and/or media source 1718 loses power. Under this scenario, the TX wireless media adapter 1706 and the RX wireless media adapter 1718 can enter a standby mode. During standby, the backchannel can remain active while the forward wireless audio/video channel is disabled to lower power consumption.

The TX wireless media adapter 1706 and the RX wireless media adapter 1718 can also enter the standby state if no media content is detected or received from the media source 1704 for a specified period of time. The TX wireless media adapter 1706 and the RX wireless media adapter 1718 can leave the standby state once audio or video data is detected from the media source 1704. Alternatively, the TX wireless media adapter 1706 and the RX wireless media adapter 1718 can enter and leave the standby mode by snooping or overhearing control messages carried over any established control channels (eg., the CEC bus.)

Alternatively, the connection between the TX wireless media adapter 1706 and the RX wireless media adapter 1716 can be abandoned when the media sink 1704 and/or media source 1718 loses power. As will be appreciated by persons skilled in the art, various mechanisms can be employed by the TX wireless media adapter 1706 and/or RX wireless media adapter 1716 to detect such an event. For example, the RX wireless media adapter 1716 can monitor the power of any signal transferred from the TX wireless media adapter 1706 to the RX wireless media adapter 1718. If the detected signal power drops below a predetermined threshold, then the RX wireless media adapter 1716 can determine that a connection has been lost. Alternately, the backchannel can be used to carry periodic beacons between the TX wireless media adapter 1706 and RX wireless media adapter 1716. Therefore, when a beacon is not detected, the corresponding wireless media adapter can conclude that the associated media device has lost power.

According to an aspect of the present invention, the RX wireless media adapter 1716 can be configured to re-initiate the auto-detect process when the media source 1704 or the TX wireless media adapter 1706 loses power. Alternatively, the RX wireless media adapter 1716 can re-initiate the auto-connect process and can connect with a TX wireless media adapter based on information determined during a previous auto-detect process. In this way, the RX wireless media adapter 1716 can connect to a TX wireless media adapter already discovered or cataloged by the RX wireless media adapter 1716.

In accordance with an aspect of the present invention, the RX wireless media adapter 1716 can re-initiate the auto-detect process when the RX wireless media adapter 1716 loses power and is powered-on (i.e., experiences a power cycle). Alternatively, the RX wireless media adapter 1716 can re-connect with a TX wireless media adapter/media source that the RX wireless media adapter 1716 was previously connected to immediately prior to the power cycle event.

The TX wireless media adapter 1706 can also be configured cease wireless media content transmission when the RX wireless media adapter 1716 or the media sink 1718 loses power. The TX wireless media adapter 1716 can further be configured to cease transmissions until a “hello” message or a “connect message” from a RX wireless media adapter is received.

In accordance with an aspect of the present invention, a paired (auto-connected) connection can be maintained until broken or disrupted by the TX wireless media adapter 1706 or the RX wireless media adapter 1716. For example, each RX wireless media adapter can include a user interface such as, for example, a button, that a consumer or end-user can use to switch between TX wireless media adapters. Each time the button is pressed, the RX wireless media adapter can disconnect from the currently-paired TX wireless media adapter and connect with a new or different TX wireless media adapter. To connect with a new TX wireless media adapter, the RX wireless media adapter 1716 can re-initiate the auto-detect process. Alternatively, the RX wireless media adapter 1716 can re-initiate the auto-connect process and can connect with a TX wireless media adapter based on information determined during a previous auto-detect process. In this way, the RX wireless media adapter 1716 can connect to a TX wireless media adapter already discovered or cataloged by the RX wireless media adapter. For example, the RX wireless media adapter 1716 can connect to the next TX wireless media adapter listed in the stored list or table of cataloged or detected TX wireless media adapters.

In accordance with an aspect of the present invention, a RX wireless media adapter can snoop the backchannel (e.g., the CEC channel) and change an existing connection or pairing based on information transmitted across the channel. Further, a RX wireless media adapter can change a connection based on information or commands received on an alternate wired or wireless channel, including but not limited to an infrared (IR), 802.11 or Zensys communication channel.

The foregoing automatic pairing/connecting mechanisms provided by an aspect of the present invention can be implemented using a semiconductor circuit without a software programmable processor. That is, both the RX and TX wireless media adapters in accordance with an aspect of the present invention can use a fixed state machine (processor) which reads control data vectors from a memory. In turn, the pre-defined fields of the control vectors (i.e., bit fields) can directly drive the control signals in the semiconductor circuit so as to implement the above automatic pairing/connecting mechanisms of an aspect of the present invention.

In accordance with an aspect of the present invention, a manual rather than automatic mechanism is used to wirelessly pair/connect a content source and a content sink. For example, external control data can be received by a RX wireless media adapter. The external control data can indicate the logical and physical identifiers of a TX wireless media adapter with which to pair/connect. If the specified TX wireless media adapter is already paired/connected, then the RX wireless media adapter can be configured to break the existing pairing/connection by wirelessly sending un-pairing/disconnecting control data with the specified logical/physical identifiers to the selected TX wireless media adapter. The RX wireless media adapter can subsequently pair/connect to the selected TX wireless media adapter by wirelessly sending pairing/connecting control data with the specified logical/physical identifiers to the selected TX wireless media adapter.

F. Not Allowing Retransmissions of High-Definition Content from a Content Source to a Content Sink in Accordance with an Embodiment of the Present Invention

In accordance with an embodiment of the present invention, retransmission of high-definition content from a content source to a content sink is not permitted. Thus, for example, with continued reference to system 100 of FIG. 1, content source 102 and content sink 104 are configured in accordance with an embodiment of the present invention such that content source 102 does not perform retransmissions of high-definition content already transmitted to content sink 104.

Existing and known proposed wireless methods for the transfer of high-definition content include the ability to perform retransmissions. Examples of such methods include 802.11 and the proposed 802.15.3a standard. Not allowing retransmissions in accordance with an embodiment of the present invention is advantageous since additional significant complexity would be required in the content source and content sink to support retransmissions, such as buffers and processing logic. Furthermore, retransmissions also add latency which degrades perceived content quality at the content sink. Additionally, retransmissions reduce throughput due to the need for acknowledgement/negative acknowledgements and the need to send some packets of data more than once. In streaming systems with latency restrictions, retransmitted data may not be usable by receiver.

G. Use of Fixed Block Sizes and Fixed Computational Parameters in Accordance with an Embodiment of the Present Invention

In a wireless communication system designed for high-definition content transfer in accordance with an embodiment of the present invention, fixed block sizes and fixed computational parameters are used on all transmit and receive processing blocks. Thus, for example, with continued reference to system 100 of FIG. 1, content source 102 and content sink 104 are configured in accordance with an embodiment of the present invention such that fixed block sizes and fixed computational parameters are used on all transmit and receive processing blocks transmitted between content source 102 and content sink 104. Prior art systems include blocks of variable size and with variable parameters. The inventive approach allows processing implementation complexity reduction.

H. Error Control Coding in Accordance with an Embodiment of the Present Invention

An embodiment of the present invention uses an error control code for wireless communication between a content source and a content sink that performs within 1 dB of the best possible code at error rates required for processing uncompressed or losslessly compressed high-definition content (e.g., 10⁻⁹ pixel error rate for HDMI). This improves security by restricting the area over which a transmitted signal can be detected and/or exploited by a non-authorized user. This also improves the density of transmitter/receiver pairs that can use a dedicated wireless channel (i.e., to maximize frequency reuse).

For example, a low-density parity check (LDPC) code may be used as the error control code to achieve the benefits described above. In a particular embodiment, an LDPC code having a length L=4096 and a rate R=0.8 is used. This code performs 5 dB better, assuming a required 10⁻⁹ bit error rate, as compared with a convolutional code having a constraint length K=7 with Viterbi decoding and assuming R=0.75 as proposed for supporting the highest data rate, 480 Mbps, in 802.15.3a. Assuming systems with everything the same except for the code and transmit power level, the R=0.8, L=4096 code will allow operation with power 5.2 dB smaller than a system with a R=0.75, K=7, convolutional code and designed using the maximum FCC allowed transmit power in the 3.1-4.8 GHz band. This is illustrated in the link budget analysis set forth in Table 1 below. A link budget analysis is a common tool employed by engineers to assess performance.

TABLE 1
Link Budget Analysis

| | | | Similar system | |
|---|---|---|---|---|
| | 802.15.3a | | but with LDPC | |
| Parameter | Value | Unit | Value | Unit |
| Throughput (Rb) | 480 | Mbps | 480 | Mbps |
| Average Transmit Power | −10.3 | dBm | −15.5 | dBm |
| Tx antenna gain (Gt) | 0.0 | dB | 0.0 | dB |
| Geometric center frequency Fc | 3.9 | GHz | 3.9 | GHz |
| Path loss at 1 meter | 44.2 | dB | 44.2 | dB |
| (L1 = 20Log(4PI*Fc/c)) | | | | |
| Path loss at 5 meters | 14.0 | | 14.0 | |
| Rx antenna gain (Gr) | 0.0 | dBi | 0.0 | dBi |
| Rx power at 5 m | −68.5 | dBm | −73.7 | dBm |
| (Pr = Pt + Gt + Gr − L1 − L2) | | | | |
| Average noise power per bit | −87.2 | dBm | −87.2 | dBm |
| (N = −174 + 10*log(Rb)) | | | | |
| Rx Noise Figure Referred to | 6.6 | dB | 6.6 | dB |
| the Antenna Terminal (Nf) | | | | |
| Average eff. noise power per | −80.6 | dBm | −80.6 | dBm |
| bit (Pn = N + Nf) | | | | |
| Implementation Loss(I) | 3.4 | dB | 3.4 | dB |
| No of Bands | 3 | | 3 | |
| 3 dB Bandwidth per band | 0.41 | GHz | 0.41 | GHz |
| E_{B}/N₀ at 5 m | 8.67 | dB | 3.48 | dB |
| BER at 5 m | 1.00E−09 | | 1.00E−09 | |

I. Use of Frequency Hopping in Accordance with an Embodiment of the Present Invention

In accordance with an embodiment of the present invention, frequency hopping is employed for wireless communication between a content source and a content sink over FCC channels on which power restrictions apply (e.g., ultrawideband: 3.1-10.6 GHz). This thereby allows an increase in peak transmitter power over FCC specified average power by an amount proportional to the inverse of the hopping rate.

Frequency hopping refers to dynamically switching frequencies in a pattern known or adaptively determined by the content source and content sink. For example, the pattern may comprise an orthogonal Latin square sequence, sweeping across all possible center frequencies, choosing frequencies according to a pseudo-noise pattern known to both transmitter and receiver, having the transmitter choose a frequency and having the receiver determine this frequency, or having the receiver use the backchannel to identify frequencies. Employing frequency hopping in accordance with this embodiment also provides diversity gains.

In a further embodiment, the above-described approaches are extended using multiple antennas at the content source and/or at the content sink to allow simultaneous carrying of several point to point links. For example, in an embodiment, the content source and/or content sink includes a Multiple-Input Multiple-Output (MIMO) antenna system to allow simultaneous carrying of several point to point links.

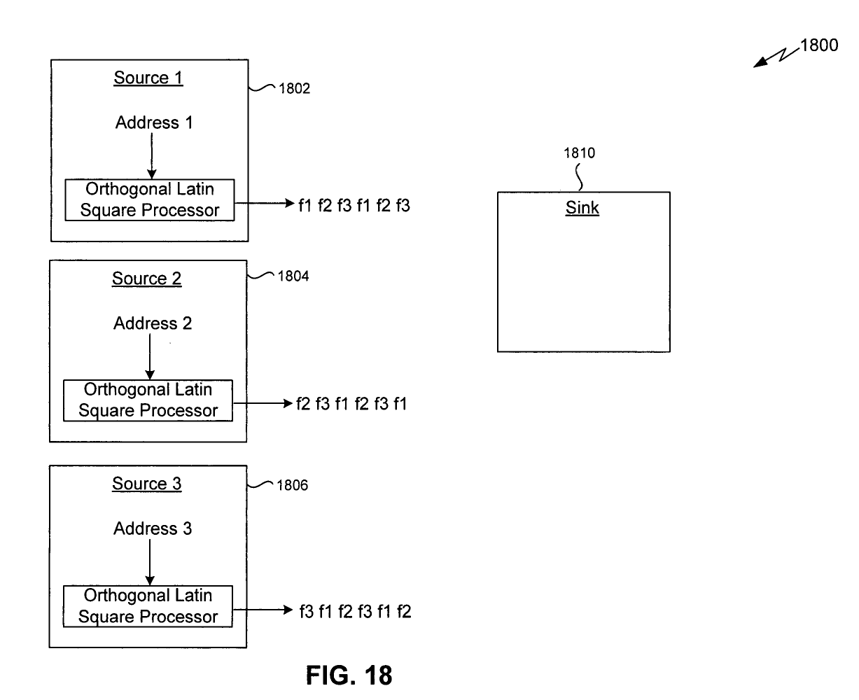

In a still further embodiment, the above-described approaches are extended using multiple orthogonal frequency hopping systems to allow several point-to-point links to operate simultaneously over band. For example, FIG. 18 depicts a system 1800 that employs multiple orthogonal frequency hopping in accordance with an embodiment of the present invention. As shown in FIG. 18, system 1800 includes three content sources 1802, 1804 and 1806 that share a frequency band for communicating with a content sink 1810. In an embodiment, these sources each frequency hop across three channels within the band denoted f₁, f₂, and f₃, respectively, in accordance with a deterministic pattern, while not simultaneously radiating on the same frequency. In an embodiment, the deterministic pattern is based on an address associated with each content source and on synchronization provided from content sink 1810. A well-known approach for implementing such a system is to use the source address to uniquely identify a row of an orthogonal Latin square, which is then read out to determine the frequency that should be used during a particular time interval.

In yet another embodiment, the above-described approaches are extended by employing receive and/or transmit diversity, such as time diversity, spatial diversity, polarization diversity, or frequency diversity, for RF communication between the content source and the content sink. For example, a commonly used transmit diversity approach given spatial diversity with two transmit antennas is Alamouti encoding, in which pairs of complex data symbols, [s₀,s₁], are processed to yield [s₀,-s₁*] s₁*] to be transmitted by one antenna and [s₁,s₀*] to be transmitted by the second antenna, wherein * denotes the conjugation operation. Given spatial diversity with two or more receive antennas, the Alamouti-encoded transmitted signals are processed jointly to generate estimates of [s₀,s₁]. There are many algorithms the receiver can employ to calculate these estimates. For example, maximum likelihood (ML) decoding may be employed.

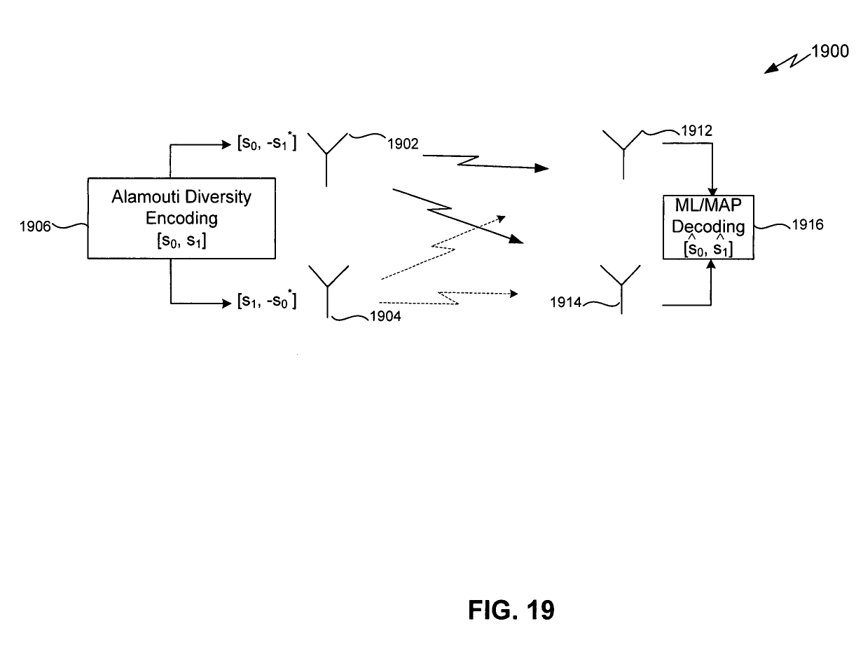

FIG. 19 depicts an example embodiment of the present invention in which transmit and receive diversity is used for RF communication between a content source and a content sink. As shown in FIG. 19, a content source includes logic 1906 for performing Alamouti diversity encoding on complex data symbols [s₀,s₁] to yield [s₀,-s₁*], which is transmitted by a first antenna 1902, and [s₁,s₀*], which is transmitted by a second antenna 1904. A content sink includes two antennas 1912 and 1914 for receiving the transmitted signals and ML/MAP decoding logic 1916 that processes the received signals to generate estimates of [s₀,s₁], denoted [ŝ₀,ŝ₁].

J. Adaptive Adjustment of Communication Parameters in Accordance with an Embodiment of the Present Invention

As described above in reference to at least FIGS. 13 and 14, an embodiment of the present utilizes a backchannel, which operates over a frequency range separate from that used to carry high-definition content, for communicating MAC information and multimedia signaling between a content source and a content sink. In accordance with a further embodiment of the present invention, the backchannel also carries information that is used by the content source and/or content sink to adaptively adjust communications parameters used to make high-definition content transfer more reliable and/or more efficient.

For example, in an embodiment of the present invention, a content sink monitors received signal quality and transmits data conveying this quality over the backchannel. The received signal quality may be measured, for example, in terms of a signal-to-noise ratio (SNR). Based on the signal quality data, the transmitter portion of the content source determines the modulation and coding parameters. For instance, in an embodiment that implements orthogonal frequency division multiplexing (OFDM) for communication between the content source and the content sink, if a particular OFDM sub-carrier has a large SNR, then a higher-order modulation format such as 16-QAM or 64-QAM can reliably be used on this sub-carrier. A sub-carrier with higher-order modulation conveys more information than that conveyed by a sub-carrier modulated with BPSK or QPSK. Thus, introducing higher-order modulation allows throughput improvement.

K. Transmission of Hot Plug Detect (HPD) Signal Information in Accordance with an Embodiment of the Present Invention

In accordance with an embodiment of the present invention, information pertaining to a Hot Plug Detect (HPD) signal generated by a content sink is wirelessly transmitted to a content source. The content source may use this information, for example, to determine whether or not it is feasible to establish a connection with the content sink, or, if a connection has already been established between the source and the sink, whether they should be disconnected.

In accordance with one such embodiment, an RX wireless media adapter associated within a content sink periodically samples an HPD signal generated by the content sink and a current state (on/off) is detected therefrom. Control data indicating the state of the HPD signal is then generated and wirelessly transmitted to a connected TX wireless media adapter associated with a content source. The TX wireless media adapter decodes the control information and the HPD signal is recreated according to whether the current state is on or off.

In an alternate embodiment, an RX wireless media adapter associated with a content sink periodically samples an HPD signal generated by the content sink and a determination is made as to whether the current state (on/off) has changed. Only if the state of the HPD signal has changed, then control data indicating the that the state has changed is generated and wirelessly transmitted to a connected TX wireless media adapter associated with a content source. The TX wireless media adapter decodes the control information and the HPD signal is recreated according to whether the current state is on or off.

L. Performance of Transition Minimized Differential Signaling (TMDS) Decoding and Encoding in Accordance with an Embodiment of the Present Invention

An embodiment of the present invention performs Transition Minimized Differential Signaling (TMDS) decoding and encoding operations in order to implement a wireless HDMI interface between a content source and content sink. For example, a TX wireless media adapter in accordance with this implementation accepts a TMDS encoded signal, performs TMDS decoding to extract media transport streams including video data periods, data island periods, and control periods, reformats the data and extracts clock data, and then wirelessly transfers the reformatted data and information conveying clock speed and other control information. An RX wireless media adapter in accordance with this implementation receives the reformatted data and clock speed information, processes the clock information to generate a source clock, reconstititutes the data and separates it into video data period, data island period, and control information, and then performs TMDS encoding using the clock and recovered data.

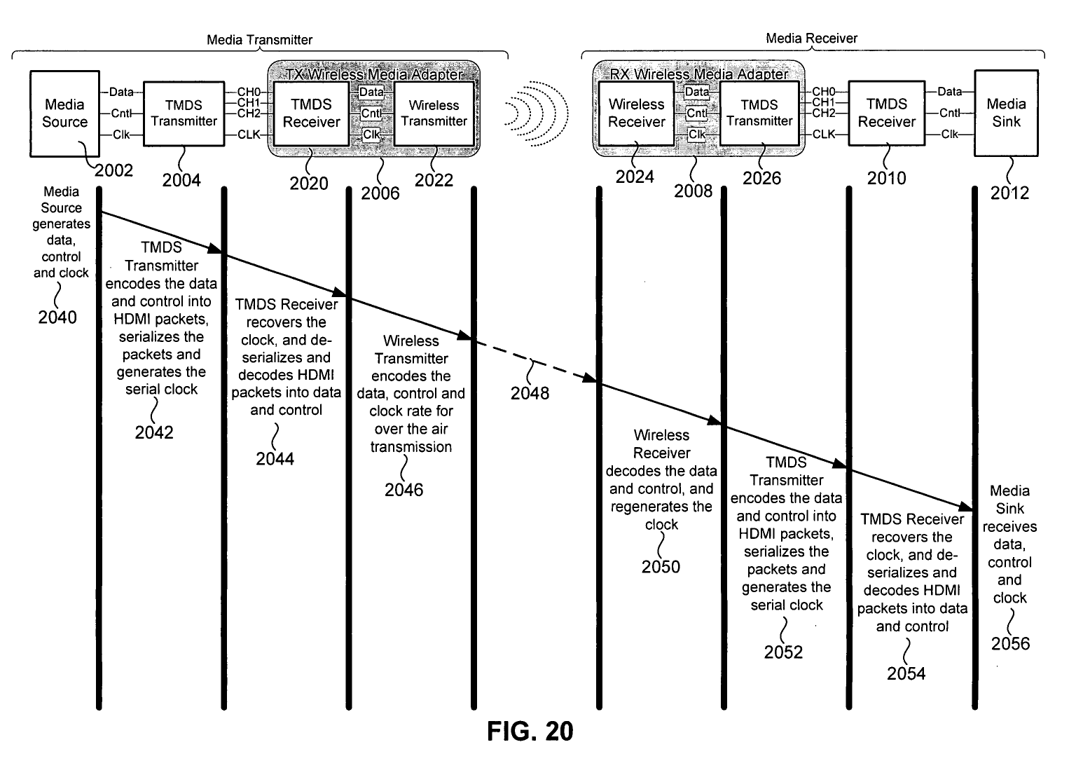

This process will now be described in more detail with reference to the diagram of FIG. 20. In FIG. 20, a media transmitter is modeled as a media source 2002, a TMDS transmitter 2004, and a TX wireless media adapter 2006, wherein TX wireless media adapter 2006 includes a TMDS receiver 2020 and a wireless transmitter 2022. Similarly, a media receiver is modeled as a media sink 2012, a TMDS receiver 2010, and an RX wireless media adapter 2008, wherein RX wireless media adapter 2008 includes a wireless receiver 2024 and a TMDS transmitter 2026.

As shown in FIG. 20, the process begins at step 2040, in which media source 2002 generates data, control signals and a clock. At step 2042, TMDS transmitter 2004 encodes the data and control signals into HDMI packets, serializes the packets and generates a serial clock. At step 2044, TMDS receiver 2020 within TX wireless media adapter 2006 recovers the clock and decodes the HDMI packets back into data and control signals. At step 2046, wireless transmitter 2022 encodes the data and control signals as well as information relating to the clock rate for transmission over the air. At step 2048, the encoded information is transmitted over the air.

At step 2050, wireless receiver 2024 within RX wireless media adapter 2008 receives the transmitted information and decodes it into the data and control signals and regenerates the clock therefrom. At step 2052, TMDS transmitter 2026 encodes the data and control signals back into HDMI packets, serializes the packets and generates a serial clock. At step 2054, TMDS receiver 2010 recovers the clock, and de-serializes and decodes the HDMI packets into data and control signals. At step 2056, media sink 2012 receives the data, control signals and clock from TMDS receiver 2010.

As will be appreciated by persons skilled in the relevant art, although the foregoing process is described in terms of a media source/TMDS transmitter that generates HDMI packets and a TMDS receiver/media sink that receives HDMI packets, the process is also generally applicable to a media source/TMDS transmitter than generates DVI packets and a TMDS receiver/media sink that receives DVI packets.

M. Performance of I²C Decoding and Encoding Operations in Accordance with an Embodiment of the Present Invention

An embodiment of the present invention performs Inter-Integrated Circuit (I²C) decoding and encoding operations in order to implement a wireless HDMI interface between a content source and content sink. The I²C decoding and encoding operations are performed as necessary to support the reception, decoding and transmission of the Display Data Channel (DDC) channel. For example, a TX wireless media adapter in accordance with this implementation accepts an I²C encoded signal, decodes the I²C encoded signal to data, reformats the data, and wirelessly transfers the reformatted data. An RX wireless media adapter in accordance with this implementation receives the wirelessly transferred reformatted data, reconstitutes the data, and performs I²C encoding using the recovered data.

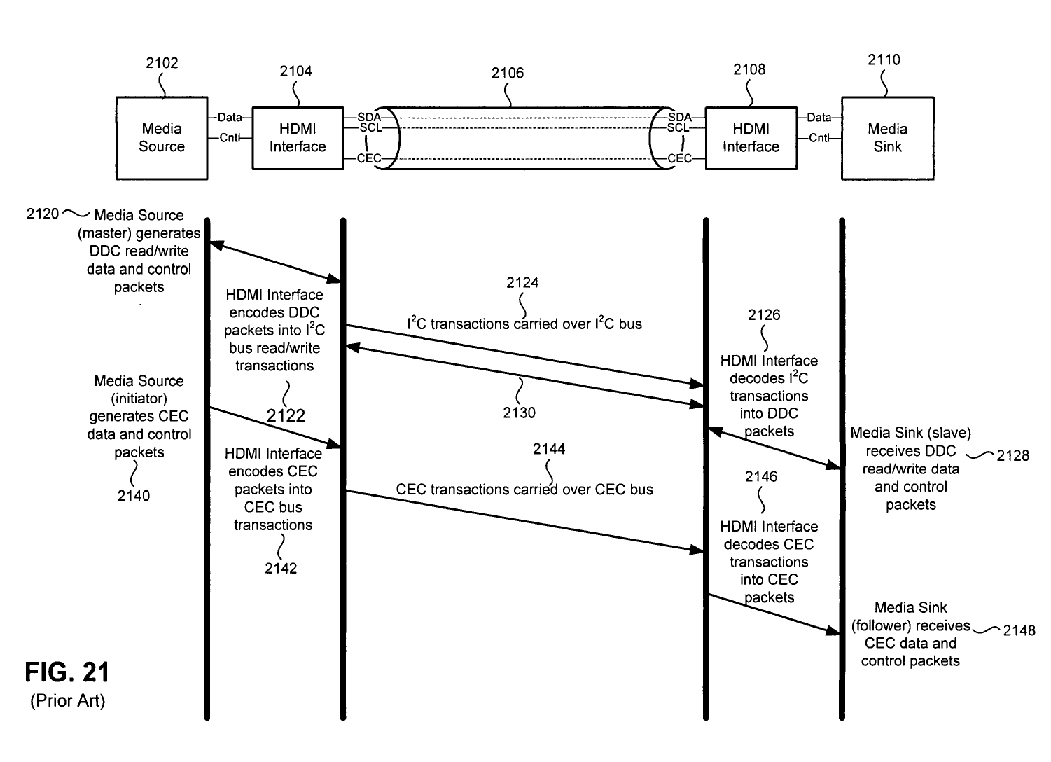

By way of illustration, FIG. 21 shows the process by which a prior art system implements a DDC channel between a media source 2102 and a media sink 2110 connected via a cable 2106. As shown in FIG. 21, media source 2102 is connected to cable 2106 via a first HDMI interface 2104 and media sink 2110 is connected to cable 2106 via a second HDMI interface 2108.

The process begins at step 2120, in which media source 2102 generates DDC read/write data and control packets. For the purposes of this process, media source 2102 is acting as the master of the DDC channel and media sink 2110 is acting as a slave. At step 2122, HDMI interface 2104 encodes the DDC packets into I²C bus read/write transactions. At step 2124, the I²C transactions are carried over the I²C bus. At step 2126, HDMI interface 2108 receives and decodes the I²C transactions into DDC packets. At step 2128, media sink 2110 receives the DDC read/write data and control packets. At this point, media sink 2110 may return responsive information over the DDC channel that will initiate additional transactions over the I²C bus as indicated by bi-directional arrow 2130.

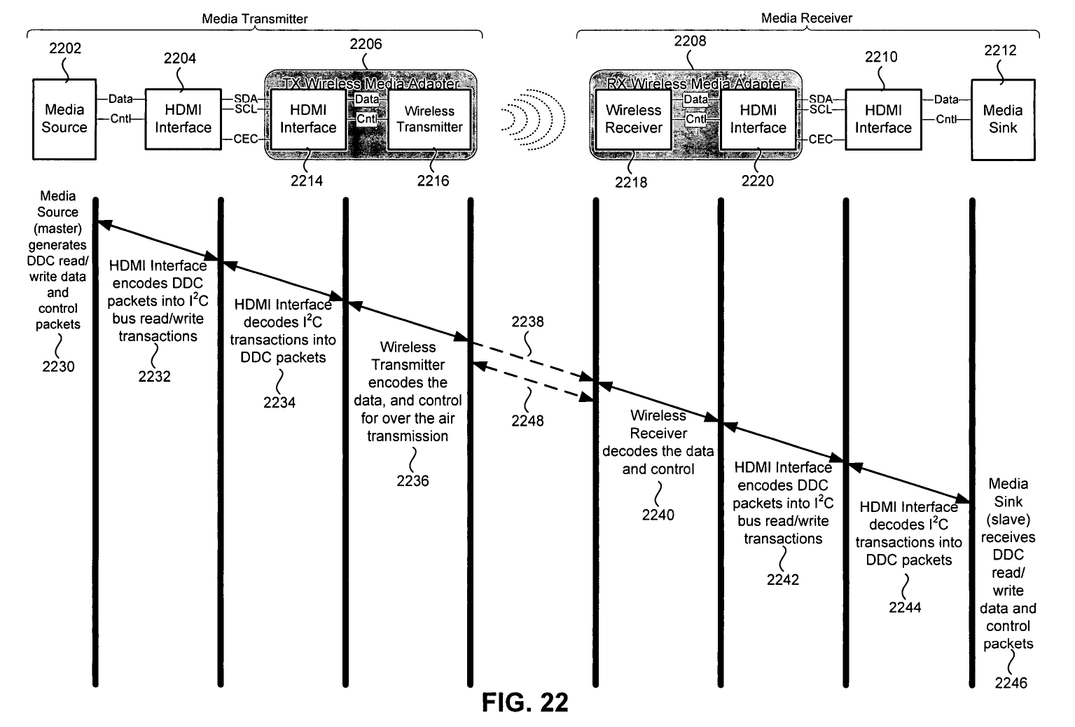

In contrast, FIG. 22 shows a process by which a DDC channel is implemented between a content source and a content sink connected via a wireless HDMI interface in accordance with an embodiment of the present invention. In FIG. 22, a media transmitter is modeled as a media source 2202 connected to a TX wireless media adapter 2206 by an HDMI interface 2204, wherein TX wireless media adapter 2206 includes an HDMI interface 2214 and a wireless transmitter 2216. Similarly, a media receiver is modeled as a media sink 2212 connected to an RX wireless media adapter 2208 by an HDMI interface 2210, wherein RX wireless media adapter 2208 includes a wireless receiver 2218 and an HDMI interface 2220.

The process of FIG. 22 begins at step 2230 in which media source 2202 generates DDC read/write data and control packets. For the purposes of this process, media source 2202 is acting as the master of the DDC channel and media sink 2212 is acting as a slave. At step 2232, HDMI interface 2204 encodes the DDC packets into I²C bus read/write transactions. At step 2234, HDMI interface 2214 within TX wireless media adapter 2206 decodes the I²C transactions back into DDC packets. At step 2236, wireless transmitter 2216 within TX wireless media adapter 2206 encodes the data and control packets for over the air transmission. At step 2238, the encoded data and control packets are transmitted over the air.

At step 2240, wireless receiver 2218 within RX wireless media adapter 2208 receives and decodes the encoded data and control packets. At step 2242, HDMI interface 2220 within RX wireless media adapter 2208 encodes the DDC packets into I²C bus read/write transactions. At step 2244, HDMI interface 2210 decodes the I²C transactions into DDC packets. At step 2246, media sink 2212 receives the DDC read/write data and control packets. At this point, media sink 2212 may return responsive information over the DDC channel that will initiate additional transmissions over the air as indicated by bi-directional arrow 2248.

As will be appreciated by persons skilled in the relevant art, although the foregoing process is described in terms of a media source and a media sink having an HDMI interface, the foregoing process is also generally applicable to media sources and media sinks having a DVI interface as well.

N. Performance of CEC Decoding and Encoding Operations in Accordance with an Embodiment of the Present Invention

An embodiment of the present invention performs Consumer Electronics Control (CEC) decoding and encoding operations in order to implement a wireless HDMI interface between a content source and content sink. For example, a TX wireless media adapter in accordance with this implementation accepts a CEC encoded signal, decodes the CEC encoded signal to data, reformats the data, and wirelessly transfers the reformatted data. An RX wireless media adapter in accordance with this implementation receives the wirelessly transferred reformatted data, reconstitutes the data, and performs CEC encoding using the recovered data.

By way of illustration, FIG. 21 shows the process by which a prior art system implements a CEC channel between a media source 2102 and a media sink 2110 connected via a cable 2106. As shown in FIG. 21, media source 2102 is connected to cable 2106 via a first HDMI interface 2104 and media sink 2110 is connected to cable 2106 via a second HDMI interface 2108.

The process begins at step 2140, in which media source 2102 generates CEC data and control packets. For the purposes of this process, media source 2102 is acting as the initiator on the CEC channel and media sink 2110 is acting as a follower. At step 2142, HDMI interface 2104 encodes the CEC packets into CEC bus transactions. At step 2144, the CEC transactions are carried over the CEC bus. At step 2146, HDMI interface 2108 receives and decodes the CEC transactions into CEC packets. At step 2148, media sink 2110 receives the CEC data and control packets.

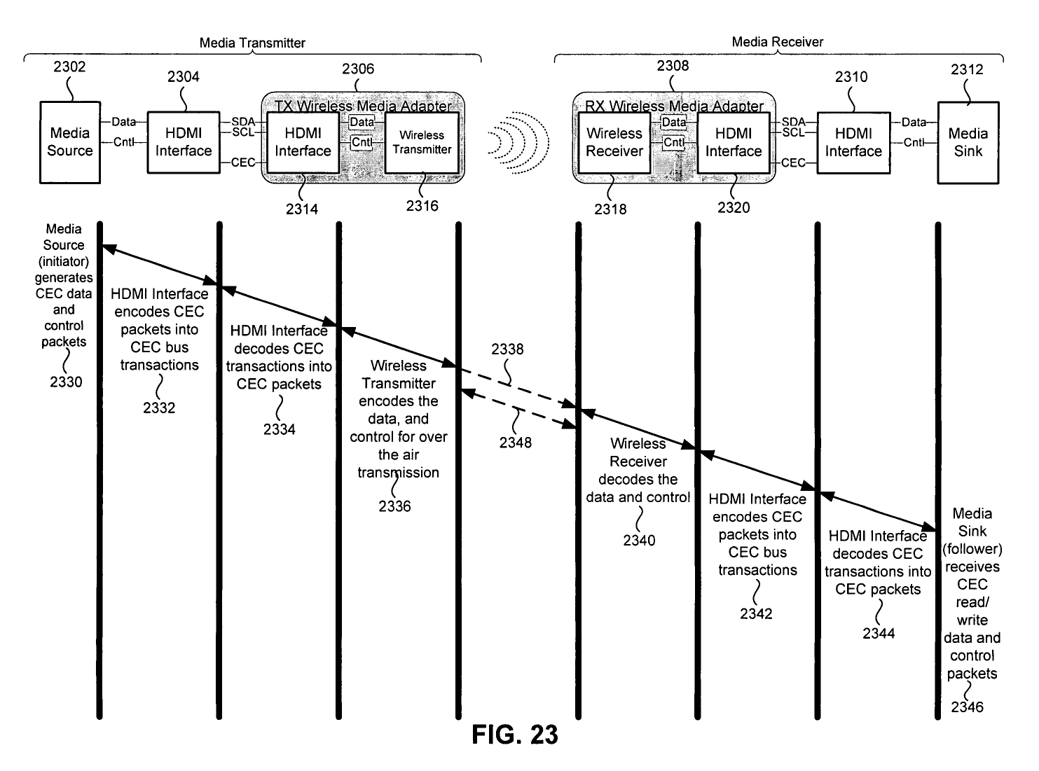

In contrast, FIG. 23 shows a process by which a CEC channel is implemented between a content source and a content sink connected via a wireless HDMI interface in accordance with an embodiment of the present invention. In FIG. 23, a media transmitter is modeled as a media source 2302 connected to a TX wireless media adapter 2306 by an HDMI interface 2304, wherein TX wireless media adapter 2306 includes an HDMI interface 2314 and a wireless transmitter 2316. Similarly, a media receiver is modeled as a media sink 2312 connected to an RX wireless media adapter 2308 by an HDMI interface 2310, wherein RX wireless media adapter 2308 includes a wireless receiver 2318 and an HDMI interface 2320.

The process of FIG. 23 begins at step 2330 in which media source 2302 generates CEC data and control packets. For the purposes of this process, media source 2302 is acting as the initiator on the CEC channel and media sink 2312 is acting as a follower. At step 2332, HDMI interface 2304 encodes the CEC packets into CEC bus transactions. At step 2334, HDMI interface 2314 within TX wireless media adapter 2306 decodes the CEC transactions back into CEC packets. At step 2336, wireless transmitter 2316 within TX wireless media adapter 2306 encodes the data and control packets for over the air transmission. At step 2338, the encoded data and control packets are transmitted over the air.

At step 2340, wireless receiver 2318 within RX wireless media adapter 2308 receives and decodes the encoded data and control packets. At step 2342, HDMI interface 2320 within RX wireless media adapter 2308 encodes the CEC packets into CEC bus transactions. At step 2344, HDMI interface 2310 decodes the CEC transactions into CEC packets. At step 2346, media sink 2312 receives the CEC read/write data and control packets. At this point, media sink 2312 may return responsive information over the CEC channel that will initiate additional transmissions over the air as indicated by bidirectional arrow 2348.

O. Wireless Transfer of Clock Information in Accordance with an Embodiment of the Present Invention

An embodiment of the present invention wirelessly transfers clock information in order to implement a wireless HDMI interface between a content source and content sink. For example, in accordance with such an embodiment, a TX wireless media adapter periodically samples a clock signal generated by a media source and the frequency of the clock is thereby determined. The TX wireless media adapter then periodically sends control data indicating the clock frequency over a wireless link to a RX wireless media adapter. The RX wireless media adapter receives the control data and extracts the clock information. The RX wireless media adapter then uses the clock frequency as specified by the control data to recreate the clock and provide it to a media sink.

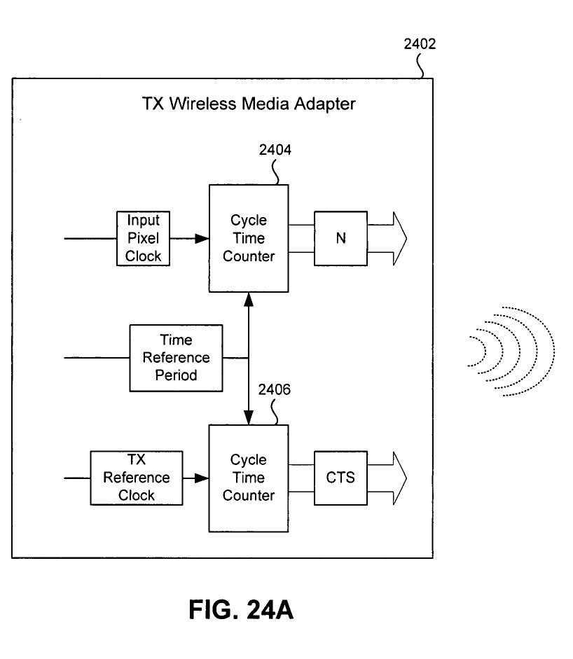

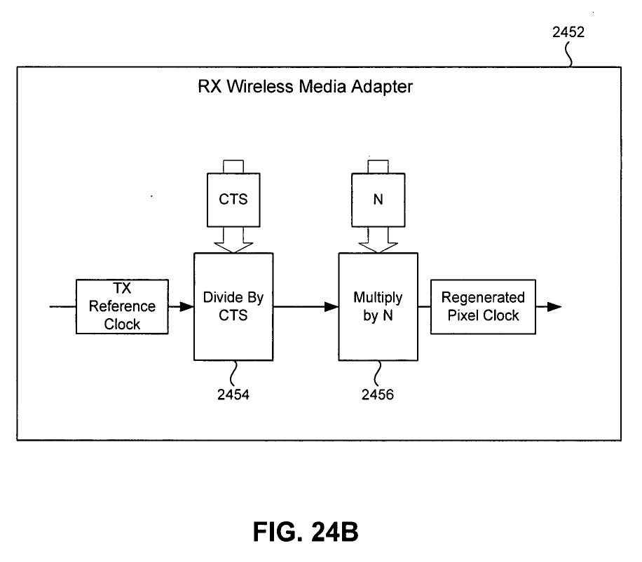

FIG. 24A depicts a TX wireless media adapter 2402 in accordance with such an embodiment. As shown in FIG. 24A, TX wireless media adapter 2402 includes a first cycle time counter 2404 and a second cycle time counter 2406. First cycle time counter 2404 receives as input an input pixel clock and a time reference period. The input pixel clock is provided from a media source or is otherwise derived from information provided from the media source, and the time reference period is chosen to be an integer number of pixel clocks. For example, in an embodiment, the time reference period is equal to a Horizontal Blanking Interval (HBI), a horizontal line period, or the like. Based on the input pixel clock and the time reference period, cycle time counter 2404 derives and outputs a value N which is defined as the number of pixel clocks per time reference period. Using a time reference period that is an integer number of pixel clocks ensures that N is a constant integer for any video format.

Second cycle time counter 2406 receives as input the time reference period discussed above and a transmitter (TX) reference clock for TX wireless media adapter 2402. Based on the time reference period and the TX reference clock, second cycle time counter 2406 derives and outputs a value CTS which is defined as the number of TX reference clocks per time reference period. The values of N and CTS are updated at the end of every time reference period and transmitted by TX wireless media adapter over the air to an RX wireless media adapter in the form of video clock regeneration packets.

FIG. 24B illustrates an RX wireless media adapter 2452 in further accordance with this embodiment. As shown in FIG. 24B, RX wireless media adapter 2452 includes “divide by CTS” logic 2454 and “multiply by N” logic 2456. RX wireless media adapter 2452 wirelessly receives video clock regeneration packets from TX wireless media adapter 2402 and recovers the N and CTS values therefrom. “Divide by CTS” logic 2454 receives as input a receiver (RX) reference clock for RX wireless media adapter 2452 and the CTS value. The frequency of the RX reference clock is ideally the same as that of the TX reference clock for TX wireless media adapter 2402, although in practice it may vary from the RX reference clock by a few parts per million (ppm).

Based on the RX reference clock and the CTS value, “divide by CTS” logic 2454 outputs a value which is determined by dividing the RX reference clock by CTS. This output is then multiplied by N in logic 2456 to provide a regenerated pixel clock which is provided to a media sink. In accordance with this embodiment, the shorter the time reference period, the better the tracking between actual pixel clock frequency and the regenerated pixel clock frequency.

P. Example PHY Layer Implementation in Accordance with an Embodiment of the Present Invention

In accordance with an embodiment of the present invention, a 1.5 Gbps wireless link providing BER=10⁻⁹ is daunting but achievable if unnecessary communications elements such as the complicated and inefficient 802.15.3a MAC are eliminated and more powerful physical layer techniques such as low-density parity check (LDPC) codes are employed.

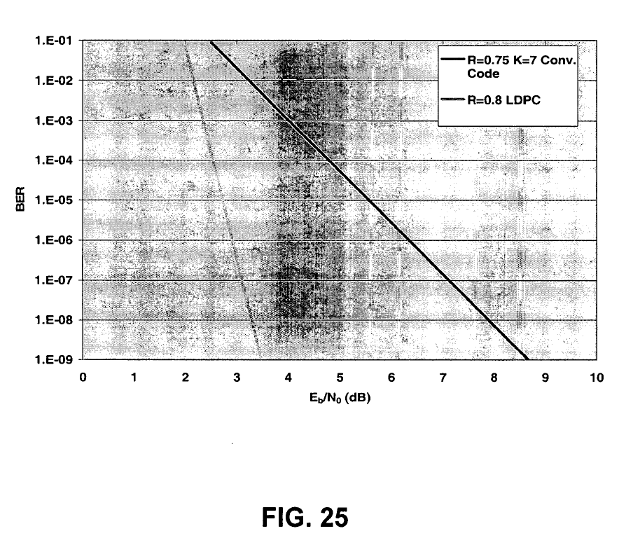

The 802.15.3a standards body settled for an extremely weak forward error correction (FEC) code, a convolutional code with constraint length, K=7, rejecting other more powerful approaches such as that used by LDPC that would allow much better performance. Consider for example, a high-rate K=7 convolutional code versus a high-rate length 4096 LDPC. Specifically assume R=0.75 for the convolutional code and R=0.8 for the LDPC. FIG. 25 shows that while the performance difference at 802.15.3a targeted error rates is only about a dB, at the low BERs needed for uncompressed video, LDPCs provide more than a 5 dB performance gain. Note that in FIG. 25, E_{b}/N₀ denotes the energy per bit to spectral noise density, which is the signal to noise ratio for a digital communication system.

In addition, since an embodiment of the present invention provides a point-to-point link that uses a wide bandwidth for only the forward video channel, no MAC overhead is needed. This approach provides an additional benefit as compared to 802.15.3a in that radio frequency (RF) receiver components required by 802.15.3a, such as a transmit/receive switch, can be eliminated to minimize the receiver sensitivity (i.e., noise figure). For instance, while an 802.15.3a system noise figure (NF) around 6.6 dB is expected, an embodiment of the present invention reduces the NF by more than a dB by including only those RF components needed to implement the wireless protocol.

To meet FCC regulations while simultaneously best utilizing state-of-the-art RF and mixed-signal components, an embodiment of the present invention employs a PHY layer solution including Orthogonal Frequency Division Multiplexing (OFDM) techniques and that alternates between 2 channels, each with a bandwidth of roughly 0.875 GHz, and located between approximately 3.06-3.93 GHz and 3.94-4.82 GHz, respectively. Table 2 shows details of one example approach—for instance, 256 OFDM tones will be transmitted on each channel, 192 will carry data while the remaining will adaptively be used for functions like frequency offset and sampling time tracking or simply left blank (i.e., nulled) to optimize performance and/or relax radio frequency (RF) processing requirements.

TABLE 2
Exemplary PHY implementation in Accordance
with an Embodiment of the Present Invention

| | |
|---|---|
| Information Data Rate | 1.5 Gbps |
| Forward Error Correction | Low Density Parity Check |
| Code Rate | 0.8 |
| Channel Symbol Rate | 1.875 Gbps |
| Modulation/Constellation | OFDM with QPSK (16QAM optional) |
| FFT Size | 256 |
| Tone Spacing | 3.4 MHz |
| Data Tones | 192 |
| Cyclic Prefix | 53 ns |
| Symbol Length | 330 ns |

A common tool employed by communications engineers to assess performance is a link budget analysis. Table 3 shows a link budget assuming 802.15.3a and a wireless HDMI solution in accordance with an embodiment of the present invention. The link budget calculates the maximum FCC allowed average transmit power. In addition, it assumes omni-directional transmit and receive antennas yielding 0 dBi antenna gains. Performance is characterized at 5 m assuming 3 dB of RF propagation loss due to obstructions such as cabinets and walls. Also included is some interference—this could be from UWB systems or RF sources such as microwave ovens, Wi-Fi® systems operating at 2.4 or 5 GHz, or cell phones. The results can be used to relate BER and E_{b}/N₀. For example, with negligible interference (in this case, an interference-to-noise ratio of 0.001 or −100 dB), the 802.15.3a BER is 10⁻⁶ whereas even at a data rate 3 times that of 802.15.3a, an embodiment of the present invention achieves better than a 10⁻⁹ BER.

TABLE 3
Link Budget for 802.15.3a vs. Wireless HDMI
Embodiment of the Present Invention

| | | | Wireless | |
|---|---|---|---|---|
| | 802.15.3a | | HDMI Embodiment | |
| Parameter | Value | Unit | Value | Unit |
| Maximum Throughput (Rb) | 480 | Mbps | 1500 | Mbps |
| Actual Throughput | 200 | Mbps | 1500 | Mbps |
| Average Transmit Power (Pt) | −10.3 | dBm | −9.1 | dBm |
| Tx antenna gain (Gt) | 0.0 | dBi | 0.0 | dBi |
| Geometric center frequency | 3.9 | GHz | 4.0 | GHz |
| (Fc) | | | | |
| Path loss at 5 meters (L) | 58.2 | dB | 58.4 | dB |
| Rx antenna gain (Gr) | 0.0 | dBi | 0.0 | dBi |
| Rx power at 5 m | −68.5 | dBm | −67.5 | dBm |
| (Pr = Pt + Gt + Gr − L) | | | | |
| Average thermal noise power | −87.2 | dBm | −82.2 | dBm |
| per bit (N = −174 + | | | | |
| 10*log(Rb)) | | | | |
| Interference to noise ratio | −100.0 | dB | | |
| Average interference power | −187.2 | dBm | −192.0 | dBm |
| per bit (I) | | | | |
| Average effective Noise (Nₑ) | −87.2 | dBm | −82.2 | dBm |
| Rx Noise Figure Referred to | 6.6 | dB | 5.5 | dB |
| the Antenna Terminal (Nf) | | | | |
| Average eff. noise power | −80.6 | dBm | −76.7 | dBm |
| per bit (Pn = Nₑ + Nf) | | | | |
| Implementation Loss(I) | 2.7 | dB | 2.7 | dB |
| No of Bands | 3 | | 2 | |
| 3 dB Bandwidth per band | 0.4 | GHz | 0.8 | GHz |
| Additional loss due to RF | 3.0 | dB | 3.0 | dB |
| obstacles | | | | |
| E_{b}/N₀ | 6.33 | dB | 3.51 | dB |
| Bit Error Rate at 5 m | 1.02E−06 | | 6.96E−10 | |

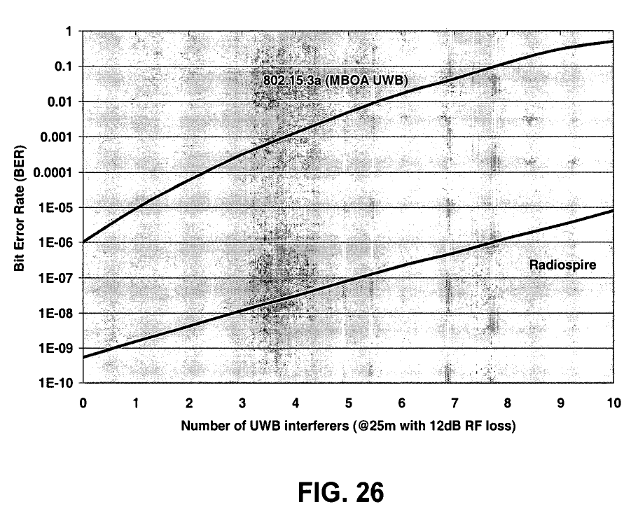

The link budget also can be used to evaluate the performance as a function of interference. For instance, if we assume that there are 802.15.3a interferers at a distance of 25 m from the receiver (with path to receiver including 12 dB of RF loss), FIG. 26 shows the link budget calculated BER as a function of the number of interferers. The link budget shows that a single interferer results in severe 802.15.3a performance degradation beyond the quality needed to support MPEG-2, whereas even with 10 interferers, bit errors are imperceptible with a wireless HDMI solution in accordance with an embodiment of the present invention.

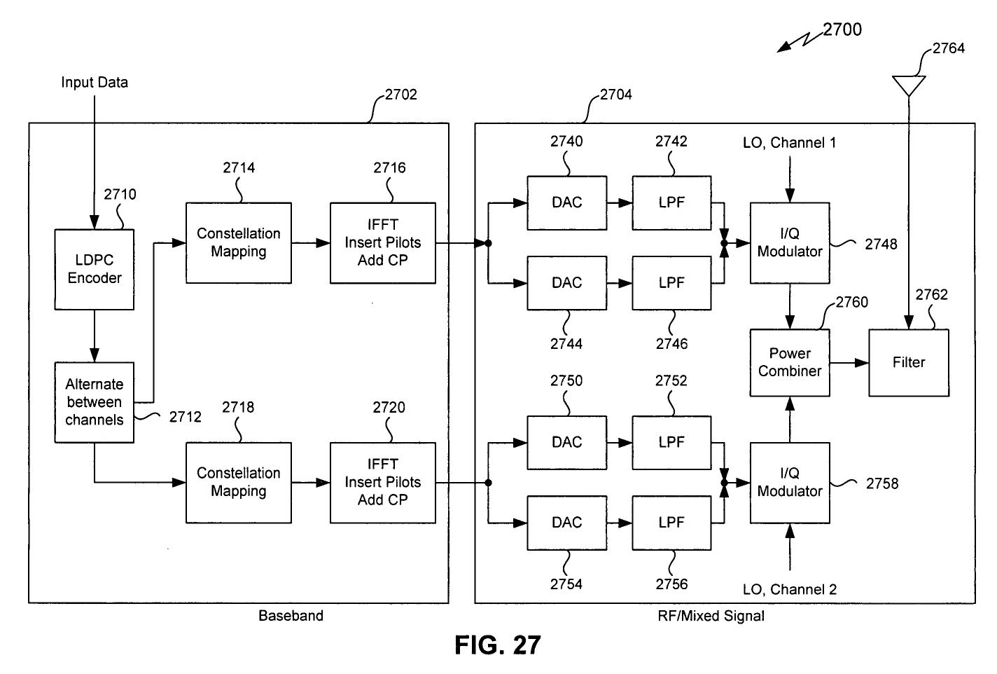

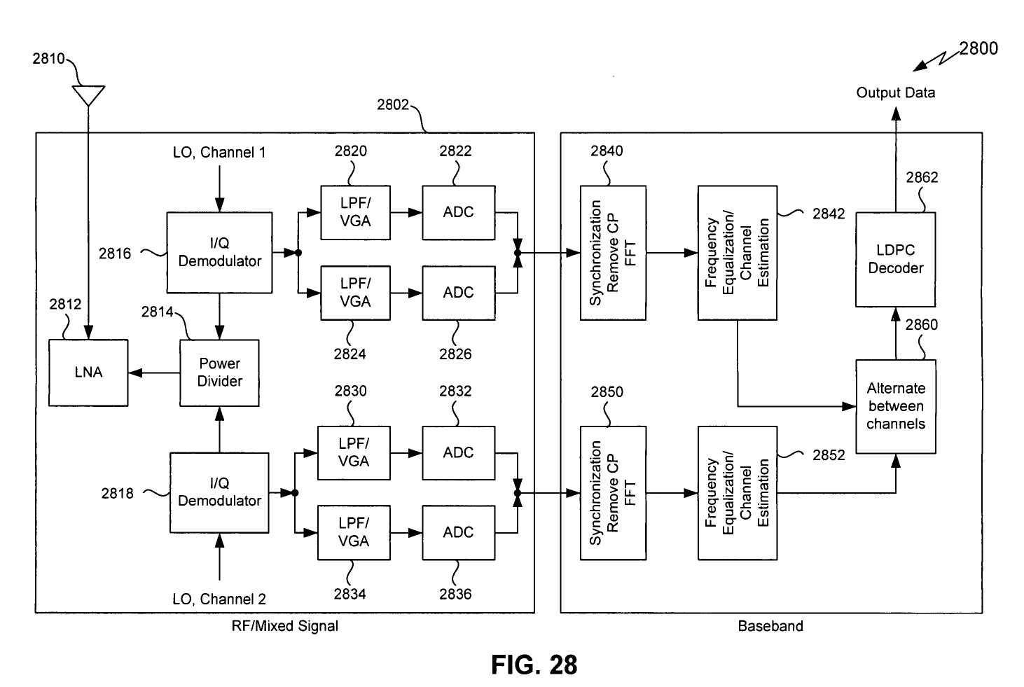

FIGS. 27 and 28 show block diagrams of a wireless HDMI transmitter 2700 and receiver 2800, respectively, in accordance with an embodiment of the present invention. Each of the transmitter 2700 and receiver 2800 employs direct conversion to minimize cost and maximize performance.

As shown in FIG. 27, transmitter 2700 includes baseband processing logic 2702 and RF/mixed-signal logic 2704. Baseband processing logic 2702 includes an LDPC encoder 2710 that encodes input data in accordance with an LDPC encoding technique and logic 2712 that alternately sends the encoded data along one of two signal processing paths for transmission over two different RF channels. Each transmit path includes a constellation mapper 2714, 2718 that receives the LDPC encoded data and forms either QPSK or 16QAM symbols therefrom, and OFDM processing logic 2716, 2720 that includes an inverse fast Fourier transform (IFFT) and generates complex IFFT output.

The complex IFFT output from OFDM processing logic 2716 is fed to parallel digital-to-analog converters (DACs) 2740 and 2744 within RF/mixed-signal logic 2604. The DAC output is then filtered by low pass filters (LPFs) 2742 and 2746 respectively to suppress distortion introduced by the DAC and fed to an I/Q modulator 2748, which modulates the signals in accordance with a first local oscillator (LO) for transmission over a first RF channel, denoted channel 1. In a like manner, the complex IFFT output from OFDM processing logic 2720 is fed to parallel DACs 2750 and 2754, the output of which is then filtered by LPFs 2752 and 2756 respectively and fed to an I/Q modulator 2758, which modulates the signals in accordance with a second LO for transmission over a second RF channel, denoted channel 2. The DACs 2740, 2744, 2750 and 2754 operate at roughly 875 Msps with roughly 6 bits/sample.

The output from I/Q modulators 2748 and 2758 are combined by a power combiner 2760 and then filtered by a filter 2762 to reduce unwanted harmonics and noise from the up-conversion process. The resulting RF signal is transmitted via antenna 2764. Note that a power amplifier (PA) may not be required due to the low FCC transmit power requirements and the use of a small amount of clipping at the DAC. Further, to reduce the transmitter complexity, an embodiment of the present invention uses structured LDPC codes enabling efficient encoding.

As shown in FIG. 28, receiver 2800 consists of RF/mixed-signal logic 2802 and baseband processing logic 2804. RF/mixed-signal logic 2802 includes an antenna 2810 that receives a transmitted RF signal, a low noise amplifier (LNA) 2812 that amplifies the received signal, and a power divider 2814 that splits the amplified signal for transmission down two different signal processing paths. Each signal processing path consists of an I/Q demodulator 2816, 2818 that extracts in-phase (I) and quadrature (Q) components of the amplified signal for processing along two subsequent parallel signal chains. I/Q demodulator 2816 is driven by a first LO to extract signals transmitted over RF channel 1 while I/Q demodulator is driven by a second LO to extract signals transmitted over RF channel 2.

Each signal chain for processing I components includes a low-pass filter (LPF) and variable gain amplifier (VGA) 2820, 2830 that filter and amplify the I data, respectively, followed by an analog-to-digital converter (ADC) 2822, 2832 that converts the analog I signal to a digital signal. Likewise, each signal chain for processing Q components includes an LPF/VGA 2824, 2834 for filtering and amplifying the Q data, respectively, followed by an ADC 2826, 2836 that converts the analog Q signal to a digital signal. Each of ADC 2822, 2826, 2832 and 2836 operate at roughly 875 Gsps and providing a resolution of roughly 6 effective bits.

The I and Q data for channel 1 is then sent to an OFDM processor 2840, 2842 within baseband processing logic 2804, which performs operations such as synchronization, equalization, and channel estimation. Likewise, the I and Q data for channel 2 is then sent to an OFDM processor 2850, 2852 within baseband processing logic 2804 that performs like operations. Logic 2860 alternately feeds the resultant demodulated symbols from OFDM processor 2840, 2842 and OFDM processor 2850, 2852 to an LDPC decoder 2862 that decodes the data to generate the output stream. In an embodiment, the LDPC decoder complexity is reduced by exploiting a fixed wireless HDMI block size and code rate.

In accordance with an embodiment of the present invention, for both the transmitter and receiver, baseband functions including OFDM and LDPC operations will be implemented on one device whereas RF/mixed signal operations will be included on an RF/mixed-signal chip. Note, a separate backchannel carrying HDMI information is also employed.

Q. Placement of Training Information in Accordance with an Embodiment of the Present Invention

As will be discussed in more detail below, an embodiment of the present invention performs dynamic and opportunistic placement of training information to allow effective impairment estimation and power level setting for wireless high-definition content transfer.

As discussed elsewhere herein, a successful source-to-sink transfer of uncompressed or lossless compressed high-definition content requires a BER of 10⁻or lower coupled with Gbps and higher data rates. Achieving such low BERs requires accurate estimation of wireless channel and radio-frequency(RF)/mixed-signal impairments and compensation for their effect. Channel impairments include frequency selective fading and attenuation due to RF obstacles whereas RF impairments include transmitter and receiver local oscillator frequency offsets and I/Q imbalances. Mixed-signal impairments include sampling clock errors and timing offsets.

In the large bandwidths required to support Gbps and higher data rates, practical RF and mixed-signal components have a relatively small dynamic range. To effectively operate in this limited dynamic range, transmitter and receiver signal power levels must be carefully monitored and controlled. For instance, a receiver analog gain control (AGC) loop employing a receive signal strength indicator (RSSI) and variable gain amplifier (VGA) is needed to ensure that the signal power level entering the analog-to-digital converter (ADC) is within the dynamic range defined by the ADC effective number of bits and associated spurious free dynamic range (SFDR). In addition, the transmit power must be estimated and dynamically adjusted since transmitters that operate in the unlicensed ultrawideband frequency range between 3.1-10.6 GHz must have transmit power less than a specified FCC defined mask. In some cases, it may be desirable to transmit as close as possible to this mask to maximize the reliably supported range between the transmitter and receiver. In other cases, it may be preferable to transmit only as much power as is necessary to meet BER requirements at a given transmitter-to-receiver range. This case might arise in scenarios where it is required to minimize the interference a wireless HDMI system in accordance with an embodiment of the present invention causes to other systems sharing the UWB band or operating in close spectral proximity (e.g., the ISM band at 2.4 GHz).

One common and effective method to achieve the impairment estimation tasks discussed above is for the transmitter to send training data known to both the transmitter and receiver. Methods to partially compensate for RF and mixed-signal impairments and support channel estimation using training data are well known. Generally, the fidelity of estimation methods using training data improves with the length of the training sequence. The power levels associated with the training data can also be measured to maintain a desired transmit power level and set internal transmitter and receiver power levels to best utilize available dynamic range.

The challenge for achieving a wireless system for delivering high definition content is to find opportunities to insert training to allow effective impairment estimation and compensation. An embodiment of the present invention exploits the reduced information rate of data transmitted during horizontal blanking intervals (HBI) and vertical blanking intervals (VBI) to generate available bit intervals for the insertion of training information. In video systems, the HBI and VBI are normally exploited for several purposes. For instance, the VBI is used in cathode ray tube (CRT) displays to allow the CRT electron beam to be shut down after it has painted the last line of an image and then restarted at the top left corner to draw the next screen. It takes time for the beam to be refocused and redirected from the bottom right corner (its end point after completing a field of video data) to the top left corner (its starting point for the next field). The HBI is used for the electron beam in a CRT device to move from the end of one horizontal line down and to the left of the screen to begin drawing the next line. During this time, the electron beam is shut off so that no other lines are accidentally created as the beam scans down and left. The VBI and HBI are also sometimes used for the transfer of audio and control data as well as other information such as closed-caption text.

Recognizing the critical importance of training, an embodiment of the present invention dynamically and opportunistically introduces training in the HDMI frame to allow estimation and power level setting updates every HDMI line. Long training lengths can be achieved by reformatting the information contained in the blanking intervals.

A further embodiment of the present invention also uses a continuous, streaming, approach for wireless transfer of high-definition content to avoid the overhead introduced by packet-based approaches such as those based on carrier sense multiple access/collision avoidance (CSMA/CA) (e.g., 802.11, 802.15.3a) and to permit the insertion of an extended training interval before the transfer of content giving an initial high-fidelity impairment estimation and power level setting. Such an extended training interval is not available in standard CSMA/CA systems. In such packet based systems, preambles are typically statically inserted at the beginning of every packet to support training. Data follows the preambles and generally some pilot signals are transmitted along with the data to allow some additional training after the preambles. In such systems, all impairment estimation needs to be performed using the training information contained in a single packet. However, the length of such training is constrained since it introduces overhead reducing system throughput. In addition, such systems do not allow dynamic placement of training sequences, for instance to exploit the reduced information rates during blanking intervals for training purposes.

To improve the BER performance of a TX wireless media adapter, an embodiment of the present invention introduces training data or sequences into an HDMI-formatted signal, which may for example be received from a media source. Specifically, the PHY layer logic of a TX wireless media adapter receives an HDMI-formatted signal and generates a re-formatted HDMI output signal containing training data. The introduced training data are bit sequences known to both the TX wireless media adapter and a corresponding remote RX wireless media adapter.

The HDMI signaling format includes three “period” types. A video data period contains video reproduction information. A data island period can contain audio reproduction information and/or control information. A control period contains only control information. The information rate of a video data period is greater than the information rate of a data island period and the information rate of a control period. Specifically, the information rate of a video data period is approximately twice the information rate of a data island period and approximately four times the information rate of a control period.

The training data introduced by the TX wireless media adapter is used to compensate for channel impairments such as, for example, frequency selective fading and attenuation due to RF obstacles. The training data is also used to compensate for RF impairments including, for example, transmitter and receiver Local Oscillator (LO) frequency offsets and in-phase (I) channel/quadrature-phase (Q) channel imbalances. Further, the training data is used to compensate for mixed-signal impairments such as, for example, sampling clock errors and timing offsets. The power levels associated with the training data can also be measured to maintain a desired transmit power level. These power levels can also be used to set internal transmitter and receiver power levels to fully exploit the available dynamic range of the transmitter and/or receiver.

Typically, the information rate of the HDMI-formatted signal is greatly reduced during VBI and HBI since video information is not transmitted. Long training sequences are introduced by the TX wireless media adapter by reformatting the information transmitted during the VBI and the HBI. The TX wireless media adapter can introduce training sequences anywhere within the HDMI-formatted signal after reformatting the existing information of the HDMI-formatted signal. The reformatted HDMI signal can be transmitted at an increased rate compared to a transmission rate of the original HDMI signal to approximately maintain the same line rate.

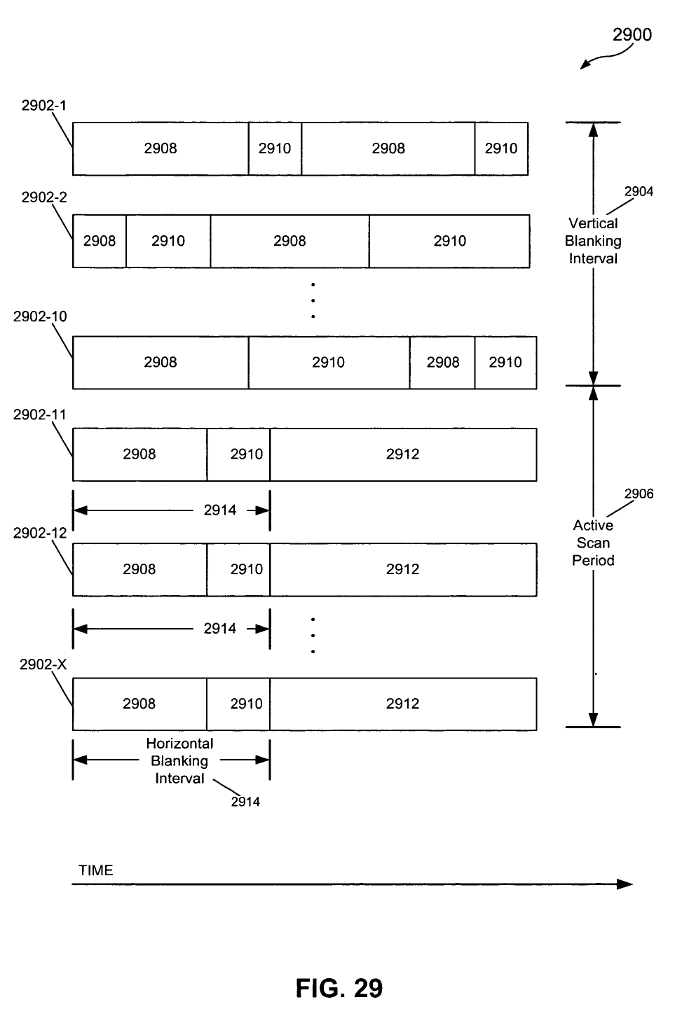

FIG. 29 illustrates the insertion of training sequences within a portion of an HDMI frame 2900 according to the present invention. As shown in FIG. 29, the HDMI frame 2900 includes a number of lines 2902-1 through 2902-X. The lines 2902-1 through 2902-X are transmitted sequentially. The lines 2902-1 through 2902-10 are transmitted during a vertical blanking interval 2904. The lines 2902-11 through 2902-X are transmitted during an active scan period 2906. Lines transmitted during the active scan period 2906 can contain control periods 2908, data island periods 2910, and video data periods 2912. These lines contain active video information within the video data periods 2912. Lines transmitted during the vertical blanking interval 2904 do not contain video data periods 2912. Horizontal blanking intervals 2914 begin each active scan line during the active scan period 2906. Video data periods 2912 are not transmitted during the horizontal blanking intervals 2914.

As previously mentioned, the transmission information rate of the data island periods 2910 is approximately one-half the transmission information rate of the video data periods 2912. Further, the transmission information rate of the control periods 2908 is approximately one-fourth the transmission information rate of the video data periods 2912. To introduce training data with minimal system complexity, PHY logic within a TX wireless media adapter reformats the HDMI frame 2900 and transmits the control periods 2908 and the data island periods 2910 at approximately the transmission information rate of the video data periods 2912. Specifically, the TX wireless media adapter speeds up the transmission information rate of the control periods 2908 such that the control periods 2908 are transmitted in approximately one-quarter of the time typically required to transmit a control period 2908. Similarly, the TX wireless media adapter speeds up the transmission information rate of the data island periods 2910 such that the data island periods 2910 are transmitted in approximately one-half of the time typically required to transmit a data island period 2910. This ability of the TX wireless media adapter to transmit the control periods 2908 and the data island periods 2910 at a faster information rate “frees up” time or bit intervals for the insertion of training data.

To insert training data, the TX wireless media adapter reformats a line or a portion of a line such that the original information is packed into a reformatted data block. That is, the information contained within the control periods 2908, data island periods 2910 or video data periods 2912 of a line or portion of a line are repacked and reformatted into reformatted data blocks. The reformatted data blocks can contain overhead information and header information to differentiate the different types of information contained therein. Further, each line can contain multiple reformatted data blocks. Together, the reformatted data blocks of a line contain the same information as the original control periods 2908, data island periods 2910 or video data periods 2912 of a line. The reformatted data blocks, however, convey this information in less time. The freed up time of each line or portion of a line can therefore accommodate training data.

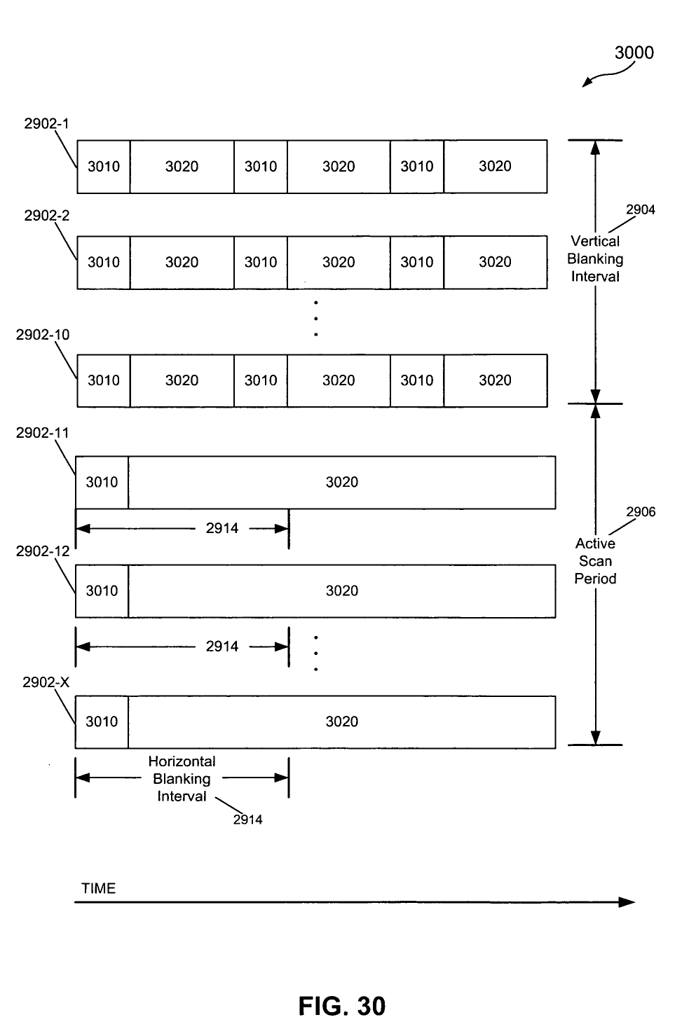

FIG. 30 illustrates the placement of training sequences within a portion of a reformatted HDMI frame 3000 according to the present invention. The reformatted HDMI frame 3000 is based on the HDMI frame 2900 depicted in FIG. 29. As shown in FIG. 30, reformatted data blocks 3020 contain information from control periods 2908, data island periods 2910 or video data periods 2912. The reformatted data blocks 3020 contain overhead or header information to distinguish the type of information contained therein. The reformatted data blocks 3020 within the vertical blanking interval 2904 can contain one or more whole or partial control periods 2908 or data island periods 2910. The reformatted data blocks 3020 within the active scan period 2906 can contain one or more whole or partial control periods 2908, data island periods 2910 or video data periods 2912. Overall, the reformatted data blocks 3020 can include one or more complete periods and/or less than a complete portion of one or more periods. Training blocks 3010 contain training data inserted by the TX wireless media adapter into available bit intervals of each line

The training insertion mechanism of the present invention enables the insertion of training data at any location within the reformatted HDMI frame 3000. Consequently, reformatted data blocks 3020 can be placed at any location within the reformatted HDMI frame 3000 that corresponds to the unformatted portion of the HDMI frame 2900. Further, the unformatted portion of the HDMI frame 2900 can be reformatted into multiple reformatted data blocks 3020. The training insertion mechanism of the present invention can also allow the HDMI frame 2900 to be reformatted in a variety of differently-sized portions (e.g., a portion of a line at a time, one line at a time, several lines at a time, or an entire frame at a time).

In one embodiment of the present invention, the TX wireless media adapter inserts the training blocks 3010 at fixed locations within each line. For example, the TX wireless media adapter can place training blocks 3010 at the same fixed locations within lines 2902-1 through 2902-10. The TX wireless media adapter can also place training blocks 3010 at the same fixed location within the lines 2902-11 through 2902-X. Placing the training blocks 3010 at fixed locations determines the location or placement of reformatted data blocks 3020. Consequently, a level of predictability within the reformatted HDMI frame 3000 can be conveyed. This enables a receiver to more easily locate the training blocks 3010 contained within the reformatted HDMI frame 3000 and guarantees certain performance measures. Further, in one embodiment of the present invention, TX wireless media adapter inserts the training blocks 3010 at fixed locations within the vertical blanking interval 2904 or horizontal blanking interval 2914 of the reformatted HDMI frame 3000.

FIG. 30 shows that long training sequences can be introduced by the training data insertion method of the present invention. Specifically, after accounting for overhead needed to distinguish between period types and training data, the insertion method of the present invention enables approximately one-half of the VBI and HBI to be used for the transmission of training sequences. In this way, the insertion method of the present invention provides a dynamic introduction of both channel estimation and power level setting updates on a line-by-line basis without reducing throughput.

The introduction of training information causes the bit length of a reformatted portion of the reformatted HDMI frame 3000 to be greater than the corresponding unformatted portion of the HDMI frame 2900. To approximately maintain the same line rate between the HDMI frame 2900 and reformatted HDMI frame 3000, the reformatted portion is transmitted at an increased rate. Often, the transmission rate of the reformatted portion will be greater than a transmission rate of the original, unformatted portion. The transmission rate of the reformatted portion can be the transmission information rate of a video period. However, the transmission rate of the reformatted portion may be slightly greater than the transmission information rate of a video period to accommodate for introduced overhead or header information.

The reformatted data blocks 3020 can contain a variety of information including, for example, flags distinguishing the parts of the reformatted HDMI frame 3000 and the type of training information provided. Specifically, the reformatted data blocks 3020 can include overhead information such as, for example, “start of period,” “end of period,” “start of line,” “end of line,” “start of frame,” “end of frame,” “start of training,” “end of training,” and “training type.” Further, the overhead contained within the reformatted data blocks 3020 may include zero-padding or data replication.

The training blocks 3010 can contain preambles used by a corresponding receiver (i.e., an RX wireless media adapter) for improved performance. For example, the training blocks 3010 can contain preambles used by the corresponding receiver for channel estimation, power control, timing synchronization, frequency offset estimation, I/Q imbalance, or automatic gain control.

In another aspect of the present invention, the PHY logic of a TX wireless media adapter provides insertion of an extended training sequence when the TX wireless media adapter first establishes a wireless link with a corresponding remote RX wireless media adapter. The use of an extended training sequence before the transfer of media content provides an initial high-fidelity impairment estimation and power level setting. Such an extended training interval is not available in standard Carrier Sense Multiple-Access/Collision Avoidance (CSMA/CA) schemes such as, for example, IEEE 802.11 or IEEE 802.15.3a.

R. Dongle-Based Implementations in Accordance with Embodiments of the Present Invention

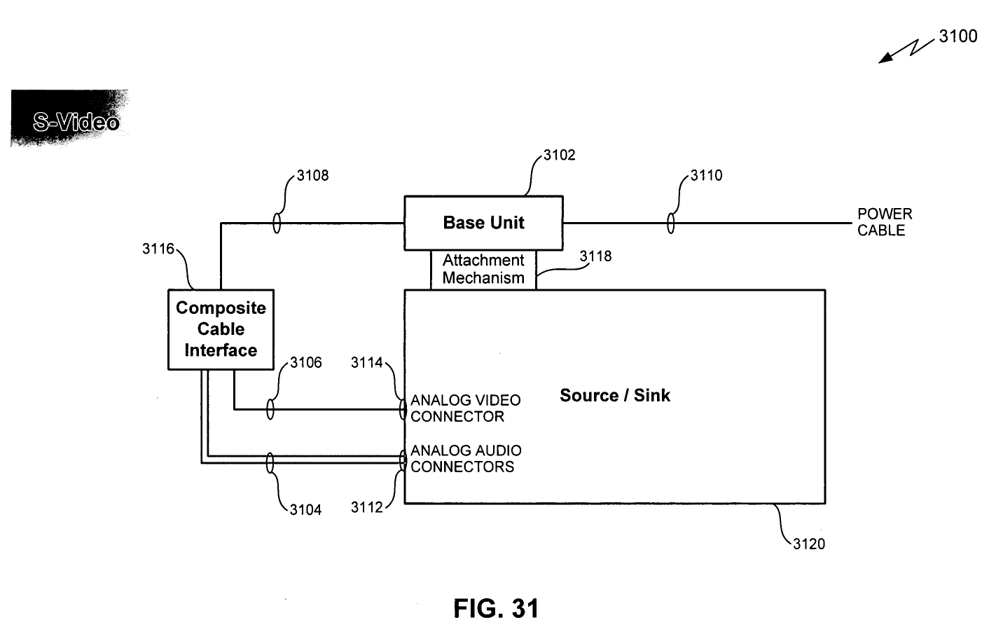

FIG. 31 illustrates a system 3100 in which a transmit (or receive) wireless media adapter of the present invention is implemented as a dongle for the wireless delivery of S-Video content. As shown in FIG. 31, the dongle includes a base unit 3102, an analog video cable 3106 with a corresponding analog video connector 3114, analog audio cables 3104 with corresponding analog audio connectors 3112, and a power cable 3110. A composite cable interface 3116 combines the analog audio cables 3104 and the analog video cable 3106 onto a composite cable 3108. The composite cable 3108 is structured to accommodate the analog audio cables 3104 and the analog video cable 3106 within a single cable.

The composite cable 3108 and the power cable 3110 are coupled to the base unit 3102. The composite cable 3108 and the power cable 3110 can be either permanently attached to the base unit 3102 or can be connected via detachable plugs or jacks. The power cable 3110 supplies power to the base unit 3102. The power cable 3110 can draw power from a wall outlet or, alternatively, can draw power from an existing connection on a media source or media sink. For example, the power cable 3110 can be structured to draw power from the Universal Serial Bus (USB) port provided by a media source or a media sink.

The base unit 3102 contains a media adapter interface to convert analog audio and analog video signals from respective native formats to a composite transmission format (or to convert analog audio and analog video signals from a composite transmission format back to respective native formats if an RX wireless media adapter). The base unit 3102 further includes a wireless transmitter for processing and transmitting a wireless signal containing the reformatted analog audio and analog video signals (or a wireless receiver for receiving and processing a wireless signal containing reformatted analog audio and audio video signals if an RX wireless media adapter). Base unit 3102 may include an LED (not shown) that provides a visual indication of the status of a wireless link between the base unit 3102 and a remote base unit.

The base unit 3102 can include either an internal antenna or an external antenna for transmitting wireless signals (or receiving wireless signals if an RX wireless media adapter). Further, the base unit 3102 can include an attachment mechanism 3118 to enable the base unit 3102 to be attached to a media source/sink 3120.

In an embodiment, the analog video cable 3106 and the corresponding analog video connector 3114 are structured in accordance with the S-Video connectivity interface standard and the analog audio cables 3104 and the corresponding analog audio connectors 3114 are structured according to the RCA line-level connectivity interface standard. However, this description is not intended to be limiting and the analog video cable 3106 and the corresponding analog video connector 3114 can be structured according to a variety of connectivity interface standards including, for example, the YUV, RGB, and CVBS formats. Likewise, the analog audio cable 3104 and the corresponding analog audio connectors 3112 can be structured according to a variety of connectivity interface standards including, for example, the XLR line-level format.

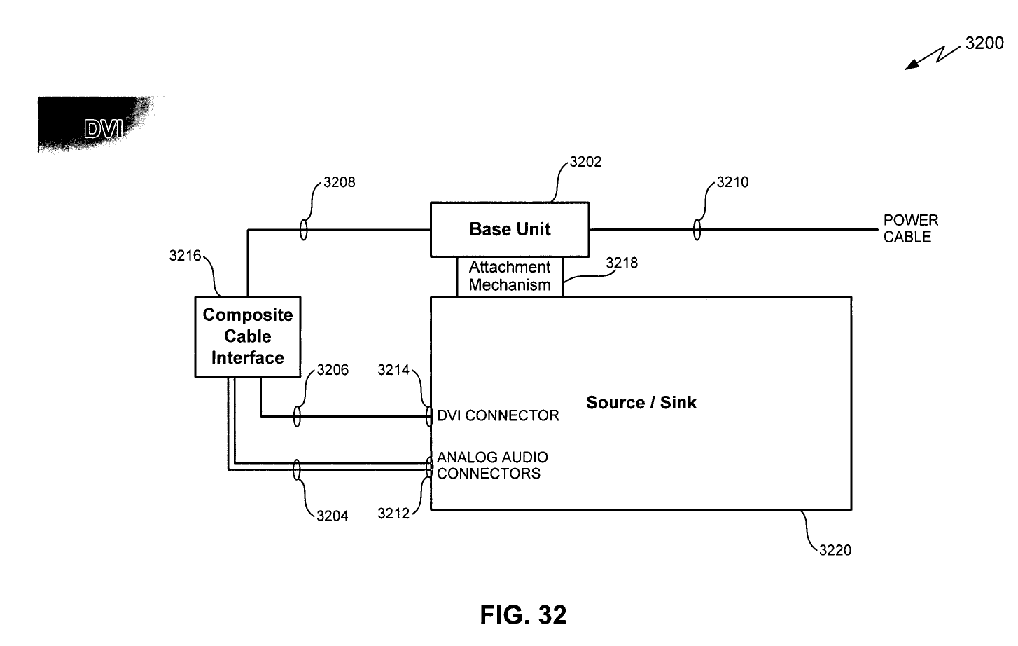

Attachment mechanism 3118 provides a means for attaching base unit 3102 to the media source/sink 3120. In an embodiment, the base unit 3102 is mounted to the media source/sink 3120 by using a pre-existing holder or socket formed on a plastic molding of the media source/sink 3120. Alternatively, the base unit 3102 may include other attachment mechanisms including, for example, tape, Velcro®, or a hook, to attach to media source/sink 3120. Further, the base unit 3102 can include a metal or plastic formation built onto the base unit 3102 that is designed to “mate” with an equivalent connector located on the media source/sink 3120. FIG. 32 illustrates a system 3200 in which a transmit (or receive) wireless media adapter of the present invention is implemented as a dongle for the wireless delivery of DVI content. As shown in FIG. 32, the dongle includes a base unit 3202, a digital video cable 3206 with a corresponding digital video connector 3214, analog audio cables 3204 with corresponding analog audio connectors 3212, and a power cable 3210. A composite cable interface 3216 combines the analog audio cables 3204 and the digital video cable 3206 onto a composite cable 3208. The composite cable 3208 is structured to accommodate the analog audio cables 3204 and the analog video cable 3206 within a single cable.

The composite cable 3208 and the power cable 3210 are coupled to the base unit 3202. The composite cable 3208 and the power cable 3210 can be either permanently attached to the base unit 3202 or can be connected via detachable plugs or jacks. The power cable 3210 supplies power to the base unit 3202. The power cable 3210 can draw power from a wall outlet or, alternatively, can draw power from an existing connection on a media source or media sink. For example, the power cable 3210 can be structured to draw power from the Universal Serial Bus (USB) port provided by a media source or a media sink.

The base unit 3202 contains a media adapter interface to convert analog audio and digital video signals from respective native formats to a composite transmission format (or to convert analog audio and digital video signals from a composite transmission format back to respective native formats if an RX wireless media adapter). The base unit 3202 further includes a wireless transmitter for processing and transmitting a wireless signal containing the reformatted analog audio and digital video signals (or a wireless receiver for receiving and processing a wireless signal containing reformatted analog audio and digital video signals if an RX wireless media adapter). Base unit 3202 may include an LED (not shown) that provides a visual indication of the status of a wireless link between the base unit 3202 and a remote base unit.

The base unit 3202 can include either an internal antenna or an external antenna for transmitting wireless signals (or receiving wireless signals if an RX wireless media adapter). Further, the base unit 3202 can include an attachment mechanism 3218 to enable the base unit 3202 to be attached to a media source/sink 3220.

In an embodiment, the digital video cable 3206 and the corresponding digital video connector 3214 are structured in accordance with the DVI connectivity interface standard. The analog audio cables 3204 and the corresponding analog audio connectors 3214 may be structured according to the RCA line-level connectivity interface standard or a variety of other connectivity interface standards including, for example, the XLR line-level format.

Attachment mechanism 3218 provides a means for attaching base unit 3202 to the media source/sink 3220. In an embodiment, the base unit 3202 is mounted to the media source/sink 3220 by using a pre-existing holder or socket formed on a plastic molding of the media source/sink 3220. Alternatively, the base unit 3202 may include other attachment mechanisms including, for example, tape, Velcro®, or a hook, to attach to media source/sink 3220. Further, the base unit 3202 can include a metal or plastic formation built onto the base unit 3202 that is designed to “mate” with an equivalent connector located on the media source/sink 3220.

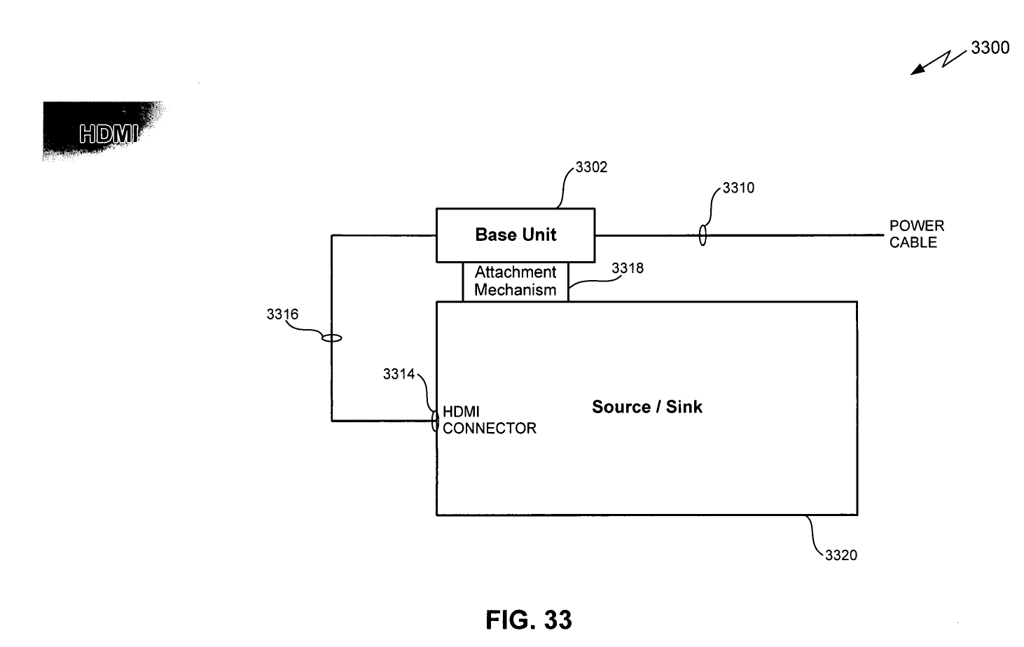

FIG. 33 illustrates a system 3300 in which a transmit (or receive) wireless media adapter of the present invention is implemented as a dongle for the wireless delivery of HDMI content. As shown in FIG. 33, the dongle includes a base unit 3302, a digital cable 3306 with a corresponding digital connector 3314, and a power cable 3310.

The power cable 3310 is coupled to the base unit 3302. The power cable 3310 can be either permanently attached to the base unit 3302 or can be connected via a detachable plug or jack. The power cable 3310 supplies power to the base unit 3302. The power cable 3310 can draw power from a wall outlet or, alternatively, can draw power from an existing connection on a media source or media sink. For example, the power cable 3310 can be structured to draw power from the Universal Serial Bus (USB) port provided by a media source or a media sink.

The base unit 3302 contains a media adapter interface to convert digital audio/video signals from a native format to a transmission format (or to convert digital audio/video signals from a transmission format back to a native formats if an RX wireless media adapter). The base unit 3302 further includes a wireless transmitter for processing and transmitting a wireless signal containing the reformatted digital audio/video signals (or a wireless receiver for receiving and processing a wireless signal containing reformatted digital audio/video signals if an RX wireless media adapter). Base unit 3302 may include an LED (not shown) that provides a visual indication of the status of a wireless link between the base unit 3302 and a remote base unit.

The base unit 3302 can include either an internal antenna or an external antenna for transmitting wireless signals (or receiving wireless signals if an RX wireless media adapter). Further, the base unit 3302 can include an attachment mechanism 3318 to enable the base unit 3302 to be attached to a media source/sink 3320.

In an embodiment, the digital cable 3306 is structured in accordance with the HDMI connectivity interface standard.

Attachment mechanism 3318 provides a means for attaching base unit 3302 to the media source/sink 3320. In an embodiment, the base unit 3302 is mounted to the media source/sink 3320 by using a pre-existing holder or socket formed on a plastic molding of the media source/sink 3320. Alternatively, the base unit 3302 may include other attachment mechanisms including, for example, tape, Velcro®, or a hook, to attach to media source/sink 3320. Further, the base unit 3302 can include a metal or plastic formation built onto the base unit 3302 that is designed to “mate” with an equivalent connector located on the media source/sink 3320.

S. Conclusion

As the “connected home” becomes a reality, consumers are demanding simpler, less-intrusive installation, more flexibility with placement, and lower overall installation costs. Unfortunately, existing solutions are expensive, bulky, and require consumers to know about connections, cables, and technology protocols. Wireless technologies promise to overcome these limitations, but existing and proposed standards fail to support bandwidth-demanding applications such as the wireless replacement of HDMI cables.

For example, to achieve the high data rates and quality needed for in-home video distribution, a particular embodiment of the present invention tailors a wireless solution to the unique requirements of HDMI. A wireless HDMI solution in accordance with an embodiment of the present invention achieves a BER of 10⁻⁹ at 1.5 Gbps while minimizing latency between the transmitter and receiver. This solution is robust, providing high quality performance even in the presence of a large amount of in-band interference.

While various embodiments of the present invention have been described above, it should be understood that they have been presented by way of example only, and not limitation. It will be understood by those skilled in the relevant art(s) that various changes in form and details may be made therein without departing from the spirit and scope of the invention as defined in the appended claims. Accordingly, the breadth and scope of the present invention should not be limited by any of the above-described exemplary embodiments, but should be defined only in accordance with the following claims and their equivalents.

What is claimed is:

1. A wireless media adapter for a media sink, comprising:
a physical (PHY) layer configured to wirelessly receive media content and wirelessly transmit and receive media access control (MAC) information; and
a MAC layer, the MAC layer comprising
auto-detection logic configured to detect one or more remote wireless media adapters from a plurality of remote wireless media adapters, and
auto-connection logic configured to select a first remote wireless media adapter from the one or more detected remote wireless media adapters from which to receive media content.

2. The wireless media adapter of claim 1, wherein the PHY layer further comprises conversion logic for converting the received media content into a format encoded for transmission to the media sink over a wired communication interface.

3. The wireless media adapter of claim 2, wherein the wired communication interface comprises one of:
a High-Definition Media Interface (HDMI);
a Digital Video Interface (DVI);
a composite video (CVSB) interface;
an S-video interface;
an RGB video interface;
a YUV video interface; or
an audio interface.

4. The wireless media adapter of claim 3, wherein the audio interface comprises one of:
an RCA audio interface;
an XLR audio interface;
a 5.1 surround sound audio interface;
a 6.1 surround sound audio interface;
a 7.1 surround sound audio interface; or
a 10.1 surround sound audio interface.

5. The wireless media adapter of claim 1, wherein the auto-detection logic is configured to implement an address resolution process to assign the wireless media adapter a communication address.

6. The wireless media adapter of claim 5, wherein the auto-detect logic sequentially broadcasts one or more address resolution messages, each of the one or more address resolution messages containing an attempted address.

7. The wireless media adapter of claim 6, wherein the attempted address of an initial broadcasted address resolution message is a prior communication address assigned to the wireless media adapter prior to a power cycle event.

8. The wireless media adapter of claim 6, wherein the communication address is set as the attempted address contained in a first address resolution message of the one or more address resolution messages for which no response is received.

9. The wireless media adapter of claim 1, wherein the auto-detection logic is configured to broadcast a “hello” message via the PHY layer.

10. The wireless media adapter of claim 9, wherein the auto-detection logic is configured to broadcast the “hello” message responsive to the assertion of a Hot Plug Detect signal by the media sink.

11. The wireless media adapter of claim 9, wherein the auto-detection logic is further configured to periodically re-broadcast the “hello” message until one or more responses are received.

12. The wireless media adapter of claim 9, wherein the auto-detection logic exchanges capability information with each of the one or more remote media adapters that responds to the “hello” message.

13. The wireless media adapter of claim 12, wherein the auto-detection logic exchanges capability information with each of the one or more remote media adapters that responds to the “hello” message within a specified auto-detect period.

14. The wireless media adapter of claim 12, wherein the auto-connection logic is configured to select the first remote wireless media adapter based on an address associated with each of the one or more detected remote wireless media adapters.

15. The wireless media adapter of claim 12, wherein the auto-connection logic is configured to select the first remote wireless media adapter based on the capability information received from each of the one or more detected remote wireless media adapters.

16. The wireless media adapter of claim 12, wherein the auto-connection logic is configured to select the first remote wireless media adapter based on the first remote wireless media adapter being connected to the wireless media adapter prior to a power cycle event.

17. The wireless media adapter of claim 1, wherein the auto-connection logic is further configured to send an auto-connect message to the first selected remote wireless media adapter to connect to the first selected remote wireless media adapter, the auto-connect message indicating that the first selected remote wireless media adapter can begin wirelessly transmitting media content.

18. The wireless media adapter of claim 17, wherein the auto-connection logic is further configured to disconnect from the first selected remote wireless media adapter based on an external command provided to the wireless media adapter.

19. The wireless media adapter of claim 18, wherein the external command is provided to the wireless media adapter over a wired link.

20. The wireless media adapter of claim 18, further comprising a user interface, wherein the user interface is configured to provide the external command.

21. The wireless media adapter of claim 18, wherein the external command is provided to the wireless media adapter over a wireless link.

22. The wireless media adapter of claim 21, wherein the wireless link comprises one of:
an infrared communication channel;
an Institute of Electrical and Electronics Engineers (IEEE) 802.11 communication channel; or
a Zensys communication channel.

23. The wireless media adapter of claim 18, wherein the auto-connection logic is further configured to select a second remote wireless media adapter from the plurality of remote wireless media adapters from which to receive media content.

24. The wireless media adapter of claim 23, wherein the second remote wireless media adapter is selected based on a stored list of the one or more detected remote wireless media adapters.

25. The wireless media adapter of claim 24, wherein the second remote wireless media adapter is a next sequential entry in the stored list.

26. The wireless media adapter of claim 17, wherein the auto-connection logic is further configured to disconnect from the first selected remote wireless media adapter when the first selected wireless media adapter becomes inoperable and to select a second remote wireless media adapter from the plurality of remote wireless media adapters from which to receive media content.

27. A method for wireless receiving media content for a media sink, comprising:
automatically detecting one or more remote wireless media adapters from a plurality of remote wireless media adapters;
automatically selecting a first remote wireless media adapter from the one or more detected remote wireless media adapters from which to receive media content; and
wirelessly receiving media content from the first selected remote wireless media adapter.

28. The method of claim 27, further comprising converting the wirelessly-received media content into a format encoded for transmission to the media sink over a wired communication interface.

29. The method of claim 28, wherein the wired communication interface comprises one of:
a High-Definition Media Interface (HDMI);
a Digital Video Interface (DVI);
a composite video (CVSB) interface;
an S-video interface;
an RGB video interface;
a YUV video interface; or
an audio interface.

30. The method of claim 29, wherein the audio interface comprises one of:
an RCA audio interface;
an XLR audio interface;
a 5.1 surround sound audio interface;
a 6.1 surround sound audio interface;
a 7.1 surround sound audio interface; or
a 10.1 surround sound audio interface.

31. The method of claim 27, further comprising implementing an address resolution process to assign the wireless media adapter a communication address.

32. The method of claim 31, wherein implementing an address resolution process comprises broadcasting one or more address resolution messages, each of the one or more address resolution messages containing an attempted address.

33. The method of claim 32, wherein broadcasting one or more address resolution messages comprises setting the attempted address of an initial address resolution message to a prior communication address assigned to the wireless media adapter prior to a power cycle event.

34. The method of claim 32, wherein implementing an address resolution process further comprises setting the communication address as the attempted address contained in a first address resolution message of the one or more address resolution messages for which no response is received.

35. The method of claim 27, wherein automatically detecting the one or more remote wireless media adapters comprises broadcasting a “hello” message.

36. The method of claim 35, wherein broadcasting the “hello” message comprises broadcasting the “hello” message responsive to the assertion of a Hot Plug Detect signal by the media sink.

37. The method of claim 35, wherein broadcasting the “hello” message comprises periodically re-broadcasting the “hello” message until one or more responses are received.

38. The method of claim 35, wherein automatically detecting the one or more remote wireless media adapters further comprises exchanging capability information with each of the one or more remote wireless media adapters that responds to the “hello” message.

39. The method of claim 38, wherein automatically detecting the one or more remote wireless media adapters further comprises exchanging capability information with each of the one or more remote wireless media adapters that responds to the “hello” message within a specified auto-detect period.

40. The method of claim 38, wherein automatically selecting the first remote wireless media adapter comprises selecting the first remote wireless media adapter based on an address associated with each of the one or more detected remote wireless media adapters.

41. The method of claim 38, wherein automatically selecting the first remote wireless media adapter comprises selecting the first remote wireless media adapter based on the capability information received from each of the one or more detected remote wireless media adapters.

42. The method of claim 38, wherein automatically selecting the first remote wireless media adapter comprises selecting the first remote wireless media based on the first remote wireless media being connected to the wireless media adapter prior to a power cycle event.

43. The method of claim 27, wherein automatically selecting comprises sending an auto-connect message to the first selected remote wireless media adapter to connect to the first selected remote wireless media adapter, the auto-connect message indicating that the first selected remote wireless media adapter can begin wirelessly transmitting media content.

44. The method of claim 43, further comprising disconnecting from the first selected remote wireless media adapter based on an external command.

45. The method of claim 44, wherein disconnecting from the first selected remote wireless media adapter further comprises selecting a second remote wireless media adapter from the plurality of remote wireless media adapters from which to receive media content.

46. The method of claim 45, wherein selecting the second remote wireless media adapter comprises selecting the second remote wireless media adapter based on a stored list of the one or more detected remote wireless media adapters.

47. The method of claim 46, wherein selecting the second remote wireless media adapter comprises selecting a next sequential entry in the stored list.

48. The method of claim 43, further comprising disconnecting from the first selected remote wireless media adapter when the first remote wireless media adapter becomes inoperable and selecting a second remote wireless media adapter from the plurality of remote wireless media adapters from which to receive media content.

49. A wireless media adapter for a media source, comprising:
a physical (PHY) layer configured to wirelessly transmit media content received from the media source and wirelessly transmit and receive media access control (MAC) information; and
a MAC layer, the MAC layer comprising
auto-detection logic configured to detect a remote wireless media adapter; and
auto-connection logic that establishes a wireless link with the remote wireless media adapter for wirelessly transferring media content thereto.

50. The wireless media adapter of claim 49, wherein the PHY layer further comprises conversion logic for converting the media content received from the media source from a format encoded for transmission over a wired communication interface to a format suitable for wireless transmission.

51. The wireless media adapter of claim 50, wherein the wired communication interface comprises one of:
a High-Definition Media Interface (HDMI);
a Digital Video Interface (DVI);
a composite video (CVSB) interface;
an S-video interface;
an RGB video interface;
a YUV video interface; or
an audio interface.

52. The wireless media adapter of claim 51, wherein the audio interface comprises one of:
an RCA audio interface;
an XLR audio interface;
a 5.1 surround sound audio interface;
a 6.1 surround sound audio interface;
a 7.1 surround sound audio interface; or
a 10.1 surround sound audio interface.

53. The wireless media adapter of claim 49, wherein the auto-detection logic is configured to implement an address resolution process to assign the wireless media adapter an address.

54. The wireless media adapter of claim 49, wherein the auto-detection logic is configured to receive a “hello” message from the remote wireless media adapter via the PHY layer.

55. The wireless media adapter of claim 54, wherein the auto-detection logic is further configured to transmit a response to the “hello” message via the PHY layer after a predetermined backoff period.

56. The wireless media adapter of claim 54, wherein the auto-detection logic is configured to calculate the predetermined backoff period based on a random number associated with the wireless media adapter.

57. The wireless media adapter of claim 55, wherein the auto-detection logic is configured to transmit the response to the “hello” message over a backchannel.

58. The wireless media adapter of claim 57, wherein the auto-detection logic is configured to transmit the response to the “hello” message over the backchannel only when the backchannel is not in use.

59. The wireless media adapter of claim 57, wherein the auto-detection logic is configured to transmit the response to the “hello” message over the backchannel only if an auto-detect period has not expired.

60. The wireless media adapter of claim 55, wherein the response includes capability information.

61. The wireless media adapter of claim 49, wherein the auto-connection logic is configured to initiate the wireless transfer of the media content to the remote wireless adapter responsive to receiving an auto-connect message from the remote wireless media adapter.

62. The wireless media adapter of claim 61, wherein the auto-connect logic is configured to halt the wireless transfer of the media content to the remote wireless media adapter when a media sink associated with the remote wireless media adapter becomes inoperable.

63. The wireless media adapter of claim 62, wherein the auto-connect logic is configured to maintain a connection to the remote wireless media adapter over a backchannel.

64. A method for wireless transmitting media content from a media source, comprising:
automatically detecting a remote wireless media adapter;
automatically establishing a wireless link with the remote wireless media adapter; and
wirelessly transferring media content received from the media source to the remote wireless media adapter over the wireless link.

65. The method of claim 64, further comprising:
converting the media content received from the media source from a format encoded for transmission over a wired communication interface to a format suitable for wireless transmission.

66. The method of claim 65, wherein the wired communication interface comprises one of:
a High-Definition Media Interface (HDMI);
a Digital Video Interface (DVI);
a composite video (CVSB) interface;
an S-video interface;
an RGB video interface;
a YUV video interface; or
an audio interface.

67. The method of claim 66, wherein the audio interface comprises one of:
an RCA audio interface;
an XLR audio interface;
a 5.1 surround sound audio interface;
a 6.1 surround sound audio interface;
a 7.1 surround sound audio interface; or
a 10.1 surround sound audio interface.

68. The method of claim 64, further comprising implementing an address resolution process to assign the wireless media adapter an address.

69. The method of claim 64, wherein automatically detecting a remote wireless media adapter comprises receiving a “hello” message from the remote wireless media adapter.

70. The method of claim 69, wherein automatically detecting a remote wireless media adapter further comprises transmitting a response to the “hello” message after a predetermined backoff period.

71. The method of claim 70, wherein automatically detecting a remote wireless media adapter further comprises calculating the predetermined backoff period based on a random number associated with the wireless media adapter.

72. The method of claim 69, wherein transmitting a response to the “hello” message comprises transmitting a response to the “hello” message over a backchannel.

73. The method of claim 72, wherein transmitting a response to the “hello” message over a backchannel comprises transmitting a response to the “hello” message over a backchannel only when the backchannel is not in use.

74. The method of claim 72, wherein transmitting a response to the “hello” message over a backchannel comprises transmitting a response to the “hello” message over a backchannel only if an auto-detect period has not expired.

75. The method of claim 70, wherein transmitting a response further comprises transmitting capability information.

76. The method of claim 64, wherein automatically establishing a wireless link with the remote wireless media adapter comprises initiating the wireless transfer of the media content to the remote wireless adapter responsive to receiving an auto-connect message from the remote wireless media adapter.

77. The method of claim 76, wherein initiating the wireless transfer of the media content further comprises halting the wireless transfer of the media content when a media sink associated with the remote wireless media adapter becomes inoperable.

78. The method of claim 77, wherein halting the wireless transfer of the media content further comprises maintaining a connection with the remote wireless media device over a backchannel.
